(19) United States
(12) Patent Application Publication
(10) Pub. No.: US 2025/0228378 A1
(43) Pub. Date: Jul. 17, 2025

(54) MAGNETIC PEG-BOARD ACTIVITY PLANNING/SCHEDULING SYSTEM, AND METHOD OF AND SYSTEM NETWORK FOR DYNAMICALLY UPDATING AND MAINTAINING CUSTOMIZED SYSTEMS DEPLOYED TO FAMILIES AND CHILDREN AROUND THE WORLD

(71) Applicant: SAKG, INC., New York, NY (US)

(72) Inventors: Stephanie Korey, New York, NY (US); Christian Poulsen, Brooklyn, NY (US)

(73) Assignee: SAKG, INC., New York, NY (US)

(21) Appl. No.: 18/411,420

(22) Filed: Jan. 12, 2024

(51) Int. Cl. A47F 5/08; G01S 19/01; G06K 7/10; G06K 7/14; G06Q 10/083; G06Q 30/0601

(52) U.S. Cl. CPC A47F 5/0823; G01S 19/01; G06K 7/10445; G06K 7/1404; G06Q 10/083; G06Q 30/0621

(57) ABSTRACT

A magnetic peg-board activity planning/scheduling system for arrangement in a horizontal or vertical display orientation, comprising: a metallic-based pegboard panel assembly including a magnetic-steel sheet, and a peg apertured panel made of thin material through which a plurality of peg apertures are formed in a uniform manner, and being mounted and held together within a framework, wherein a plurality of peg apertures are formed in a uniform manner through the peg apertured panel; and a set of magnetic peg-based indicating tiles, each having a peg structure that is adapted for physically coupling to the peg apertures in the metallic-based pegboard panel and magnetically coupling to the magnetic-steel sheet in a releasable manner to selective changing the placement of the magnetic peg-based indicating tile on the surface of the metallic-based pegboard panel; wherein each magnetic peg-based indicating tile component includes an indicating graphic representative of an activity and/or indicating text representative of a child's name, the day of the week, activity, or status of a task to be performed. Each magnetic peg-based title component is designed to enable a young child to simply and controllably insert the peg structure of the magnetic peg-based indication tile into any intended peg aperture formed in the metallic peg-board panel, so that it is then securely but releasably held in place by the forces of magnetic attraction existing between (i) the magnetic element inside the peg structure of the magnetic peg-based indicating tile component, and (ii) the magnetic-steel sheet mounted within the framework of the magnetic peg-board panel assembly. A cloud-based web-site portal system is also provided for supporting the custom design, purchase and updating/maintenance of magnetic peg-board systems deployed to families around the world so that their activity tile components can be custom-designed and shipped to customer families as the interests, activities and needs of children grow with time so no deployed pegboard system is never will fail to meet the needs of children for whom they were designed, produced and shipped to around the world.

### BACKGROUND OF THE INVENTION

### Field of Invention

The present invention relates to new and improved systems and devices for planning and scheduling activities and routines in the life of a child to add to the harmony and joy of family life, foster family connections, while developing the skills and minds of children.

### Brief Overview of the State of Knowledge in the Art

Childhood psychologists and experts know that schedules and routines are critical for children and help them in many important ways, namely: (1) to feel in control of their environment; (2) to feel safe, secure, and comfortable; (3) to know what is happening now and what comes next; (4) to know how to do an activity or task; and (5) to engage in learning

Children who feel safe, secure, included, and respected are better able to engage in learning and more easily handle schedule changes and unexpected surprises.

Routines also unlock harmony and fun for the whole family. With routines, there are fewer power struggles and improved connection between children and caregivers, and this means days and weeks flow more weekly, allowing families to make the most of the best moments of childhood. Routines help families get ahead of these struggles before the arise. Every family wants to make the most of the first moments of childhood.

Childhood psychologists and experts also know that when children are not prepared for what will come next in the life of a child, they are more likely to resist the event, even if it is something they enjoy, and they feel out of control, and ultimately, express this feeling with a scream, cry, kick, or tantrum.

Parents and caregivers need to set the stage for routine and learning. From babies first months, they are starting to absorb and discover the world. Routine and repetition help create comfort and calm during adjusting to everyday life.

Parents and caregivers need to inspire children and promote their language development. This can be achieved by connecting baby friendly illustrations to the first verbal language of their parents and caregivers, Most family members need help to start to connect the dots between their daily lives and spoken words, sounds and pronunciation.

Parents and caregivers need to foster connections and communication with their children. Parents and caregivers need to help with communication and relationship building, even before a young child learns to speak their first words.

Clearly, parents and caregivers need new and improved tools designed to help plan and schedule activities and events for their children so they can benefit from the structure of routines.

Others have attempted to address some of the above challenges presented when raising young children, but their offerings suffer from several shortcomings and/or drawbacks.

For example, AUSTRALIAN PATENT APPLICATION NO. AU 2007/100061A4 by Elizabeth and Stephen Guest discloses a magnetic pictorial event planner that can communicate to children who cannot yet read what activities or events they will be involved with over a relevant time-period. The event planner consists of several components, each performing a specific task to enable the overall function of the event planner. The event planner comprises a set of magnetic tiles that will adhere to metallic surfaces (e.g. like a refrigerator) and that can be aligned adjoining each other to represent the relevant time-period and activities or events that will be undertaken over the course of the time-period. The three components are time-period, currency indicator (i.e. TODAY or NOW), and activity or event tiles, where time-period consists of one magnetic tile that indicates which period of the time-period is the current period, and the activity or event tiles depict a single feature such as an event, an activity, an occasion, or a holiday.

US Patent Application No. US2005/02685001A1 by Feinstein discloses an activity scheduling device including a display board having seven foldable sections, each section representing one day of the week and the display board representing a full week. As disclosed, the activity scheduling device is designed to teach children the concept of time. Each section of the display board includes subsections, each representing a portion of the period, for example, hours of the day or morning, afternoon, evening or night time. Activity indicators are provided, each indicative of an activity, and an attachment mechanism is provided to attach the indicators to the display board. The activity may take the form of a picture and/or text one or both surfaces of a substrate forming the indicator. In use, the indicators indicative of a specific activity is placed on the appropriate time at which the activity is scheduled. As disclosed, when using the activity scheduling device for small children, a parent/caregiver/teacher would place an indicator indicative of a specific activity on the appropriate date, and at the appropriate time, at which time the activity is scheduled. Older children could place the indicators on the appropriate day and time without adult assistance.

WIPO Patent Application Publication No. WO 2006/130972 by Cormier discloses a device and method for teaching responsible chores to children, comprising a scheduling chart having delineated areas printed on an outer surface thereof, and associated with specific days in a week. The chart has the capability of retaining flat magnetic pieces in the delineated areas. Some of the flat magnetic pieces have a chore to be done printed on a front surface of the flat magnetic piece, and a chore accomplished message on a rear surface thereof. A reward indicator message is contained on a rear surface of one or more flat magnetic pieces to indicate a specific reward. After the flat magnetic piece containing the printed reward is flipped in its associated delineated areas, the reward is visible and is due.

In general, prior art activity scheduling and routine planning boards, available on the market, take a “one size fits all” approach and provide every family the same set of materials to schedule their children's activities and plan out their daily routines.

Clearly, there is a great need in the art for a better and more accessible way of and means for helping children understand their daily lives and the world around them, and to do so using a new and improved activity, event and routine planning and scheduling system and method that avoids the shortcomings and drawbacks of prior art apparatus and methodologies.

### OBJECTS AND SUMMARY OF THE PRESENT INVENTION

Accordingly, a primary object of the present invention is to provide a new and improved magnetic peg-board activity planning/scheduling system, and method of dynamically updating and maintaining the system during the growth of a child to promote child development and harmony and joy in family life, while overcoming the shortcomings and drawbacks of the prior art.

Another object of the present invention is to provide a new and improved magnetic peg-board activity planning/scheduling system, and method of dynamically updating and maintaining the system during the lifetime of a child to promote growth and development in the child, and harmony and joy in the family.

Another object of the present invention is to provide a new and improved magnetic peg-board activity planning/scheduling system that provides children with a sense of routine, control, and visibility into their days.

Another object of the present invention is to provide a new and improved magnetic peg-board activity planning/scheduling system that helps families build routines and unlocks harmony in mornings, evenings, and daytime in between.

Another object of the present invention is to provide a new and improved magnetic peg-board activity planning/scheduling system that helps build a foundation of routine, and predictability, designed to capture day-to-day activities of babies, before toddlerhood, and all that comes with it and grow with children with time.

Another object of the present invention is to provide a new and improved magnetic peg-board activity planning/scheduling system that is beautifully designed, has high quality, and supports customizable activity schedule and routine planning in the life of a child.

Another object of the present invention is to provide a new and improved magnetic peg-board activity planning/scheduling system which can be fabricated in different sizes (e.g small and large) and supports two display orientations for each size (e.g. vertical and horizontal display orientation) so that each family can select the option(s) that are best suited for their child(ren).

Another object of the present invention is to provide a new and improved magnetic peg-board activity planning/scheduling system which is entirely customized for each family.

Another object of the present invention is to provide a new and improved cloud-based system that generates and serves to a client computing system, a web-based graphical user interface (GUI) that supports and enables parents to digitally design and plan what their child(ren)'s routines should be, and then order online a set of Customized Indicating Magnetic Peg-Based Tiles that match the routines that parents have designed for their child(ren), ensuring a custom selection of magnetic peg-based activity tiles for each family, and eliminating the waste that results from sending families activity tiles that they do not need and will not use.

Another object of the present invention is to provide a new and improved magnetic peg-board activity planning/scheduling system, that contains magnetic peg-based activity indicating pieces that a child can easily handle while they are still developing their hand fine motor skills.

Another object of the present invention is to provide such a new and improved magnetic peg-board activity planning/scheduling system, wherein its magnetic peg-based layout/divider tiles are intended to be moved/removed by adults only, and not by the child, by making these tiles more difficult to (re) move using stronger magnets and flatter placement on the activity scheduling and routine planning board construction.

Another object of the present invention is to provide a new and improved magnetic peg-board activity planning/scheduling system that includes educational materials to explain how families can use the board with their child and what the recommendations and benefits are for each age range.

Another object of the present invention is to provide a new and improved magnetic peg-board activity planning/scheduling system, wherein as children grow older and into new activities (e.g. diaper to potty, bottle to breakfast, music class to soccer class), the customers can come back and design and purchase individual activity magnetic tiles for their growing child, thereby allowing a single activity scheduling and routine planning board to grow with children all the way from birth to at least age 6, and beyond.

Another object of the present invention is to provide a new and improved magnetic peg-board activity planning/scheduling system and method of management, wherein primary benefits of the system and method is that the system evolves as children grow Babies: language development, routine familiarity, caregiver connection; Toddlers: language development, routine familiarity, caregiver connection, reducing power struggles with age appropriate choices and replacing those power struggles with connection and learning, early math skills, early time awareness, fine motor skills; preschoolers/kindergarteners: everything described above plus early executive function skills, letter recognition and phonemic awareness.

In view of the above, the present invention further provides a new and improved magnetic peg-board activity planning/scheduling system for arrangement in a horizontal or vertical display orientation, comprising: a metallic-based pegboard panel assembly including a magnetic-steel sheet, and a peg apertured panel made of thin material through which a plurality of peg apertures are formed in a uniform manner, and being mounted and held together within a framework, wherein a plurality of peg apertures are formed in a uniform manner through the peg apertured panel; and a set of magnetic peg-based indicating tiles, each having a peg structure that is adapted for physically coupling to the peg apertures in the metallic-based pegboard panel and magnetically coupling to the magnetic-steel sheet in a releasable manner to selective changing the placement of the magnetic peg-based indicating tile on the surface of the metallic-based pegboard panel; wherein each magnetic peg-based indicating tile component includes an indicating graphic representative of an activity and/or indicating text representative of a child's name, the day of the week, activity, or status of a task to be performed; and wherein each magnetic peg-based title component is designed to enable a young child to simply and controllably insert the peg structure of the magnetic peg-based indication tile into any intended peg aperture formed in the metallic peg-board panel, and then securely but releasably held in place by the forces of magnetic attraction existing between (i) the magnetic element inside the peg structure of the magnetic peg-based indicating tile component, and (ii) the magnetic-steel panel (i.e. sheet) mounted within the framework of the magnetic peg-board panel assembly.

Another object of the present invention is to provide such new and improved magnetic peg-board activity planning/scheduling system, wherein each magnetic peg-based indicating tile component is physically and magnetically mounted through one or more peg apertures formed in the peg apertured panel so as to enable the parent, caregiver and/or child to simply plan and construct child activity routines on the peg-board panel that are always arranged in a uniform and orderly manner, while projecting a sense of order and confidence that structured and orderly routines should naturally bring to the lives of children and their parents.

Another object of the present invention is to provide such a new and improved magnetic peg-board activity planning/scheduling system that seeks to reinforce a sense of calm and confidence in children when using the system and its components during their daily and nightly lives.

Another object of the present invention is to provide such a new and improved magnetic peg-board activity planning/scheduling system, wherein each magnetic peg-based activity-indicating tile component is engineered to allow young children to simply pick up and handle the tile component with ample dexterity to facilitate easy mounting and remounting of the tile component in a particular peg aperture formed in the peg apertured panel, at a desired location along an activity routine being constructed while mounting activity tiles; and also, wherein each magnetic peg-based indicating tile component is physically and magnetically mounted through one or more peg apertures formed in the peg apertured panel so as to enable the parent, caregiver and/or child to simply plan and construct child activity routines on the peg-board panel that are always arranged in a uniform and orderly manner, while projecting a sense of order and confidence that structured and orderly routines should naturally bring to the lives of children and their parents.

Another object of the present invention is to provide such a magnetic peg-board activity planning/scheduling system, wherein the magnetic-steel panel is painted or powder-coated; and wherein the peg apertured panel is made of plastic material; and wherein the magnetic-steel sheet and the peg apertured panel are assembled using a set of spaced-apart standoff screws fastened though the corners and mid-sections of the metallic-based pegboard panel assembly.

Another object of the present invention is to provide such a magnetic peg-board activity planning/scheduling system, wherein the framework includes a pair of metal hanging plate inserts for mounting within the top and rear sides of the framework for vertical and horizontal mounting, respectively.

Another object of the present invention is to provide such a magnetic peg-board activity planning/scheduling system, wherein a set of a ribbon hangers are mounted to the top and rear sides of said framework for supporting vertical and horizontal mounting orientations of the peg-board panel.

Another object of the present invention is to provide such a magnetic peg-board activity planning/scheduling system, wherein the peg apertured panel made of thin plastic material, in which the plurality of peg apertures is formed in a uniform manner using a laser cutting beam.

Another object of the present invention is to provide such a magnetic peg-board activity planning/scheduling system, wherein the peg apertured panel made of thin wood material, in which the plurality of peg apertures is formed in a uniform manner using a laser cutting beam.

Another object of the present invention is to provide such a magnetic peg-board activity planning/scheduling system, wherein the magnetic element has a cylindrical geometry; and wherein the cross-sectional geometry of each peg aperture is matched to the cross-sectional geometry of the peg structure, so that the peg structure can be easily inserted into said the aperture.

Another object of the present invention is to provide such a magnetic peg-board activity planning/scheduling system, wherein the peg structure has a cylindrical recess for receiving the magnetic element which has a cylindrical shape and dimensions sized to fit securely within the cylindrical recess formed in the peg structure.

Another object of the present invention is to provide such a magnetic peg-board activity planning/scheduling system, wherein each magnetic peg-based indicating tile component further comprises graphical indicia to visually indicate a specific name, activity, or other legend on the magnetic peg-based indicating tile component.

Another object of the present invention is to provide such a magnetic peg-board activity planning/scheduling system, wherein the magnetic peg-based indicating tile component further comprises: a blank front surface without bearing any graphics, text or other graphical indications, and free and available for a parent or caregiver to draw a graphic and/or write out a name for an activity on the blank surface, using an erasable, a semi-permanent or permanent ink-based mark indicating tile component so as to visually indicate a specific name, activity or other legend on the magnetic peg-based tile.

Another object of the present invention is to provide such a magnetic peg-board activity planning/scheduling system, wherein the set of magnetic peg-based indicating tile components include: at least one Name Indicating Magnetic Peg-Based Tile, each for indicating the name of a child who will use the magnetic peg-board activity planning/scheduling system; a set of Day of Week Day Indicating Magnetic Peg-Based Tiles, each for indicating a day of the week (namely S-M-T-W-TH-F-S); at least six Magnetic Peg-Based Dividers, each having two of more magnetic peg-structures for mounting to the metallic-based pegboard panel; and a plurality of Specific Activity/Event Indicating Magnetic Peg-Based Activity Tiles, each for mounting on the metallic-based pegboard panel between the Magnetic Peg-Based Dividers; wherein each magnetic peg-based indicating tile component includes an indicating graphic representative of an activity and/or indicating text representative of a child's name, the day of the week, activity, or status of a task to be performed.

Another object of the present invention is to provide such a magnetic peg-board activity planning/scheduling system, wherein, for arrangement in vertical display orientation, the set of magnetic peg-based indicating tile components include: at least one Name Indicating Magnetic Peg-Based Tile, each for indicating the name of a child who will use the magnetic peg-board activity planning/scheduling system; a pair of Magnetic Peg-Based Dividers, each having two of more magnetic peg-structures for mounting to the metallic-based pegboard panel assembly, and creating Morning Activity and Evening Activity Spaces and on the front surface of the pegboard board panel, between which a Daily Routine Planning Space is created; Morning and Evening Indicating Magnetic Peg-Based Tiles for mounting in Morning and Evening Activity Spaces created on the metallic-based pegboard panel assembly; a set of Week Day Indicating Magnetic Peg-Based Tiles, each for indicating a day of the week (namely S-M-T-W-TH-F-S) for mounting in the Daily Routine Planning Space; a plurality of Specific Activity/Event Indicating Magnetic Peg-Based Activity Tiles, each for mounting on said metallic-based pegboard panel assembly between the Magnetic Peg-Based Dividers, within the Daily Routine Planning Space; wherein each magnetic peg-based indicating tile component includes an indicating graphic representative of an activity and/or indicating text representative of a child's name, the day of the week, activity, or status of a task to be performed.

Another object of the present invention is to provide such a magnetic peg-board activity planning/scheduling system, wherein for arrangement in a vertical display orientation, said set of magnetic peg-based indicating tile components include: at least one Name Indicating Magnetic Peg-Based Tile, each adapted for mounting on the metallic-based pegboard panel assembly and indicating the name of a child who will use the magnetic peg-board activity planning/scheduling system; To Do and Done Indicating Magnetic Peg-Based Tiles adapted for mounting on the metallic-based pegboard panel assembly and forming a To Do Space and a Done Space; a Magnetic Peg-Based Divider having two of more magnetic peg-structures for mounting to the metallic-based pegboard panel assembly to form a Do Space and a Done Space; and a plurality of Specific Activity/Event Indicating Magnetic Peg-Based Activity Tiles, each adapted for mounting on the metallic-based pegboard panel assembly in either the Do Space or Done Space of the Magnetic Peg-Based Divider; wherein each magnetic peg-based indicating tile component includes an indicating graphic representative of an activity and/or indicating text representative of a child's name, the day of the week, activity, or status of a task to be performed.

Another object of the present invention is to provide such a magnetic peg-board activity planning/scheduling system, wherein for arrangement in a horizontal display orientation, the set of magnetic peg-based indicating tile components include: at least one Name Indicating Magnetic Peg-Based Tile, each for indicating the name of a child who will use the magnetic peg-board activity planning/scheduling system; a Magnetic Peg-Based Divider, having two of more magnetic peg-structures for mounting to the metallic-based pegboard panel and creating a Morning Space and an Evening Space; Morning and Evening Indicating Magnetic Peg-Based Indication Tiles, each having a magnetic peg-structure for mounting to the metallic-based pegboard panel assembly within the Morning Space or the Evening Space; a plurality of Specific Activity/Event Indicating Magnetic Peg-Based Activity Tiles, each for mounting on said metallic-based pegboard panel assembly within the Morning Space or the Evening Space; wherein each magnetic peg-based indicating tile component includes an indicating graphic representative of an activity and/or indicating text representative of a child's name, the day of the week, activity, or status of a task to be performed.

Another object of the present invention is to provide such a magnetic peg-board activity planning/scheduling system, wherein for arrangement in a vertical display orientation, the set of magnetic peg-based indicating tile components include: at least one Name Indicating Magnetic Peg-Based Tile, each for indicating the name of a child who will use said magnetic peg-board activity planning/scheduling system; a Magnetic Peg-Based Divider, having two of more magnetic peg-structures for mounting to the metallic-based pegboard panel and creating a To Do Space and a Done Space; Morning and Evening Indicating Magnetic Peg-Based Indication Tiles, each having a magnetic peg-structure for mounting to the metallic-based pegboard panel assembly within the To Do Space or the Done Space; a plurality of Specific Activity/Event Indicating Magnetic Peg-Based Activity Tiles, each for mounting on the metallic-based pegboard panel assembly within the To Do Space or the Done Space; wherein each magnetic peg-based indicating tile component includes an indicating graphic representative of an activity and/or indicating text representative of a child's name, the day of the week, activity, or status of a task to be performed.

Another object of the present invention is to provide a magnetic peg-board activity planning/scheduling system, comprising: a metallic-based pegboard panel assembly including a magnetic-steel sheet, and a peg apertured panel made of thin material through which a plurality of peg apertures are formed in a uniform manner, and being mounted and held together within a framework made from wood or plastic material, wherein a plurality of peg apertures are formed in a uniform manner through the peg apertured panel; and a set of magnetic peg-based indicating tiles, each having a peg structure that is adapted for physically coupling to the peg apertures in the metallic-based pegboard panel and magnetically coupling to the magnetic-steel sheet in a releasable manner to selective changing the placement of the magnetic peg-based indicating tile on the surface of the metallic-based pegboard panel; wherein each magnetic peg-based indicating tile component includes an indicating graphic representative of an activity and/or indicating text representative of a child's name, the day of the week, activity, or status of a task to be performed; and wherein each magnetic peg-based title component is designed to enable a young child to simply and controllably insert the peg structure of the magnetic peg-based indication tile into any intended peg aperture formed in the metallic peg-board panel, and then securely but releasably held in place by the forces of magnetic attraction existing between (i) the magnetic element inside the peg structure of the magnetic peg-based indicating tile component, and (ii) the magnetic-steel sheet mounted within the framework of the magnetic peg-board panel assembly.

Another object of the present invention is to provide such a magnetic peg-board activity planning/scheduling system, wherein the magnetic-steel sheet is painted or powder-coated; and wherein the peg apertured panel is made of plastic material; and wherein the magnetic-steel sheet and the peg apertured panel are assembled using a set of spaced-apart standoff screws fastened though the corners and mid-sections of the metallic-based pegboard panel assembly.

Another object of the present invention is to provide such a magnetic peg-board activity planning/scheduling system, wherein the framework includes a pair of metal hanging plate inserts for mounting within the top and rear sides of said framework for vertical and horizontal mounting, respectively.

Another object of the present invention is to provide such a magnetic peg-board activity planning/scheduling system, wherein a set of a ribbon hangers are mounted to the top and rear sides of the framework for supporting vertical and horizontal mounting orientations of the peg-board panel.

Another object of the present invention is to provide such a magnetic peg-board activity planning/scheduling system, wherein the peg apertured panel made of thin plastic material, in which the plurality of peg apertures is formed in a uniform manner using a laser cutting beam.

Another object of the present invention is to provide such a magnetic peg-board activity planning/scheduling system, wherein said peg apertured panel made of thin wood material, in which the plurality of peg apertures is formed in a uniform manner using a laser cutting beam.

Another object of the present invention is to provide such a magnetic peg-board activity planning/scheduling system, wherein the magnetic element has a cylindrical geometry; and wherein the cross-sectional geometry of each peg aperture is matched to the cross-sectional geometry of the peg structure, so that the peg structure can be easily inserted into the peg aperture.

Another object of the present invention is to provide such a magnetic peg-board activity planning/scheduling system, wherein the peg structure has a cylindrical recess for receiving the magnetic element which has a cylindrical shape and dimensions sized to fit securely within the cylindrical recess formed in the peg structure.

Another object of the present invention is to provide such a magnetic peg-board activity planning/scheduling system, wherein the magnetic peg-based indicating tile component further comprises graphical indicia to visually indicate a specific name, activity, or other legend on the magnetic peg-based indicating tile component.

Another object of the present invention is to provide such a magnetic peg-board activity planning/scheduling system, wherein the magnetic peg-based indicating tile component further comprises: a blank front surface without bearing any graphics, text or other graphical indications, and free and available for a parent or caregiver to draw a graphic and/or write out a name for an activity on the blank surface, using an erasable, a semi-permanent or permanent ink-based mark indicating tile component so as to visually indicate a specific name, activity or other legend on said magnetic peg-based tile.

Another object of the present invention is to provide a magnetic peg-based indicating tile component for use with and mounting to a metallic-based pegboard panel assembly including a magnetic-steel sheet, and a peg apertured panel made of thin material through which a plurality of peg apertures is formed in a uniform manner, and being mounted together within a framework, wherein the magnetic peg-based indicating tile component comprises: a planar base plate provided with a square aperture; a planar indication plate of the same geometrical dimensions as the planar base plate, and mounted to the planar base plate with adhesive or other fastening means; a small cubic structure provided with a hollow cylindrical recess for mounting a permanent magnetic cylinder with its magnetic field aligned with the axis of the cubic structure and having cross sectional dimensions that permit permanent mounting within the square aperture of the planar base plate; and an indication surface provided on the planar indication plate for carrying and/or supporting an exemplary graphic representative of an activity or event, along with a typographical name for the activity, as the case may be; wherein each magnetic peg-based indicating tile component is designed to enable a young child to simply and controllably insert the magnetic peg-based indication tile into any intended peg aperture formed in a magnetic peg-board panel, and then securely but releasably held in place by the forces of magnetic attraction existing between (i) a magnetic element mounted inside a recess portion formed in the wooden peg portion of the magnetic peg-based indicating tile structure, and (ii) the magnetic steel sheet mounted inside the magnetic peg-board panel assembly.

Another object of the present invention is to provide such a magnetic peg-board activity planning/scheduling system, wherein the planar base plate, the planar indication plate and the small cubic structure are made from wood material.

Another object of the present invention is to provide a magnetic peg-based indicating tile component for use with and mounting to a metallic-based pegboard panel assembly including a magnetic-steel sheet, and a peg apertured panel made of thin material, through which a plurality of peg apertures is formed in a uniform manner, and being mounted together within a framework, wherein the magnetic peg-based indicating tile component comprises: a plastic back plate component having an integrated plastic peg structure with a cylindrical recess for installation and embodying of a permanent magnet of similar cylindrical geometry; and an indication surface provided on the plastic back plate for carrying and/or supporting an exemplary graphic representative of an activity or event, along with a typographical name for the activity, as the case may be; and wherein each magnetic peg-based indicating tile component is designed to enable a young child to simply and controllably insert the magnetic peg-based indication tile into any intended peg aperture formed in a magnetic peg-board panel, and then securely but releasably held in place by the forces of magnetic attraction existing between (i) a magnetic element mounted inside a recess portion formed in the wooden peg portion of the magnetic peg-based indicating tile structure, and (ii) the magnetic steel sheet mounted inside the magnetic peg-board panel assembly.

Another object of the present invention is to provide a new and improved method of using the child's magnetic peg-board activity planning/scheduling system comprising: procuring a magnetic pegboard system designed to meet the needs, interests and activities of a specific child or group of children; mounting the magnetic pegboard on a surface in either a vertical or horizontal orientation; inserting the components (i.e. magnetic activity tiles) within magnetic pegboard of the system, to configure a desired routine for the child/children during the course of the first week, and allow the child/children to start using the system according to the configured routine; after passage of the first week, reconfiguring the tiles on the magnetic pegboard system, to reflect the desired routine of the child/children for the second week; repeating the above step each subsequent week, and reconfiguring the activity tiles on the magnetic pegboard system to reflect the desired routines of the child/children for the future weeks; after passage of time and use of the magnetic pegboard system, and as the child/children grows older, develops new interests and adopts new activities and modified routines, the customer returning to and logging into the e-commerce site, accessing the customer's user account and redesigning/updating the customized magnetic pegboard system design, based on new interests, activities and routines of the child/children; and after receiving new activity tiles for the system, reconfiguring the tiles on the magnetic pegboard system, to reflect the desired routine of the child/children for subsequent weeks and months ahead.

Another object of the present invention is to provide a cloud-based system network supporting customization, updating and maintenance of the magnetic peg-board activity planning/scheduling systems, deployed and used by child and caregivers, comprising: a plurality of client computing systems operably connected to the internet infrastructure that is provided with cloud-based services; a plurality data centers distributed around the world, each operably connected to the internet infrastructure, and supporting web, application and database servers, and cloud-based services; one or more factory production and fulfilment centers for manufacturing, producing, packaging and shipping magnetic peg-board systems to customers around the world; a web portal for use by customers around the world, when designing, ordering and updating their QR-coded magnetic peg-board systems using the web portal(s), and client computing systems; and GPS-based system for GPS tracking the location of Magnetic Peg-board Systems that have been constructed and deployed to customers and families around the world, and periodically updated as children grow and expand their interests and activities.

Another object of the present invention is to provide such a cloud-based system network, wherein each client computing system may have one of many possible form factors, such as a desktop computing system, a tablet computing system, a desktop workstation, a mobile smartphone device, and/or a portable computing appliance; wherein said client computing system is web-enabled and fully capable of accessing, displaying and processing webpages served to the client computing system by the web, application and database system servers, and the web pages containing graphical user interfaces (GUIS) with interface objects that enable the updating and maintenance of customized magnetic peg-board children activity planning/scheduling systems in accordance with the principles of the present invention.

Another object of the present invention is to provide a new and improved method of designing, producing, ordering and updating a child's magnetic pegboard system comprising the steps of: (a) customer uses a web browser to log into an e-commerce based magnetic pegboard design and maintenance site, creates a user account for the customer, and uses the tools supported on the site to generate graphical user interfaces (GUIs) served to the web browser, that enable the customer to digitally model and design a customized/bespoke magnetic peg-board activity scheduling and routine planning system for specific use by a specific child/children and his/her/their daily routines at any moment in time, wherein the design is specified in terms of the needs, interests and activities of the child and/or children; (b) customer specifies the size of the magnetic pegboard system (i.e. small or large display space), and its orientation of use/display (i.e. vertical or horizontal mounting); (c) based on the specification of the daily routines and pegboard size and orientation, the system designs a bespoke/custom magnetic pegboard system with a custom set of magnetic activity tiles for the customer, wherein each magnetic activity tile has a proper activity title for printing on the magnetic tile component during its manufacture/construction; (d) based on the design specifications for the customer's magnetic pegboard system design, the system accepts the customer's purchase order for a magnetic pegboard system with the provided design specifications; (e) the system fulfills the customer's order for the magnetic pegboard system, by constructing the system according to the customer's magnetic pegboard system design specifications, and packages the produced components for the system, and ships the assembled product to the customer's shipping address; (f) the customer mounts the magnetic pegboard on a surface and inserts the components (i.e. magnetic activity tiles) within magnetic pegboard system, and the child/children start using the system according to the guidelines and instructions provided with the system; (g) after passage of time and use of the magnetic pegboard system, and as the child/children grows older, develop new interests and adopt new activities and modified routines, the customer returns to and logs into the e-commerce site, accesses the customer's user account and redesigns/updates the customized/bespoke magnetic pegboard system design, based on new interests, activities and routines of the child/children; (h) based on the new/updated design for the child's customized/bespoke magnetic pegboard system design, the customer places a new purchase order for new custom magnetic tiles for use with the customer's customized/bespoke magnetic pegboard system so that the system will continue to meet and support the needs, interests and activities of the child/children and its family; (i) the system fulfills the customer's order for new activity tiles for use with the magnetic pegboard system, by constructing the new magnetic tiles according the updated system design specifications, and packages the components for the system, and ships them to the customer's shipping address; and (j) the customer uses the new magnetic activity tiles with the customer's bespoke magnetic pegboard system, according to the guidelines and instructions provided with the pegboard system.

Another object of the present invention is to provide new and improved a cloud-based system network designed and built for designing, ordering, managing and updating customized magnetic peg-board activity planning/scheduling systems deployed to families and their children around the world, comprising: a plurality of client computing systems operably connected to the internet infrastructure that is provided with cloud-based services; a plurality data centers distributed around the world, each operably connected to the internet infrastructure and supporting web, application and database servers, and cloud-based services; a magnetic peg-board system maintenance web portal for use by customers around the world, when designing, ordering and updating said magnetic peg-board systems using a designated website portal(s), and client computing systems used for scanning the machine-readable codes applied to the magnetic peg-board systems before shipment to customers around the world; one or more factory production and fulfilment centers for manufacturing, producing, packaging and shipping magnetic peg-board systems to customers around the world, wherein each magnetic peg-board system bears a machine-readable code (e.g. QR code symbol) encoding (i) the product/customer identification assigned to the customer and its designed and purchased magnetic peg-board system, and (ii) the URL linked to the designated website portal where the customer can visit (re) design, order and update the magnetic peg-board system and its tile components; and a GPS-based system for GPS tracking the location of magnetic peg-board systems that have registered with the designated website portal, and have been constructed and deployed to customers and families around the world, and are which are periodically updated as children grow and expand their interests and activities; wherein each client computing system is a web-enabled and capable of accessing, displaying and processing webpages served to the client computing system by the web, application and database system servers supporting said designated website portal, and wherein the web pages contain graphical user interfaces (GUIS) having interface objects that enable the updating and maintenance of customized magnetic peg-board children activity planning/scheduling systems.

Another object of the present invention is to provide such cloud-based system network, wherein the client computing systems comprises a plurality of web-enabled smartphone or web-enabled tablet computers.

Another object of the present invention is to provide such cloud-based system network, wherein said designated website portal comprises web, application and database servers maintained within the plurality of data centers.

Another object of the present invention is to provide such cloud-based system network, wherein each client computing system has one of several possible form factor, selected from the group consisting of a desktop computing system, a tablet computing system, a desktop workstation, a mobile smartphone device, and/or a portable computing appliance.

Another object of the present invention is to provide such cloud-based system network, wherein each client computing system further comprises a GPS receiver enabling the processing of GPS signals transmitted from the GPS satellites to the Earth and supporting geolocation services within the client computing system.

Another object of the present invention is to provide such cloud-based system network, wherein each client computing system further comprises a camera subsystem for use in facilitating camera functions, such as recording photographs and video clips, that can be uploaded to a designated location on said designated website portal by the customer.

Another object of the present invention is to provide such cloud-based system network, wherein each client computing system further supports communication functions that can be facilitated through one or more wireless communication subsystems, which can include radio frequency receivers and transmitters and/or optical (e.g. infrared) receivers and transmitters.

Another object of the present invention is to provide such cloud-based system network, wherein each said client computing system further comprises a web-enabled browser program. Another object of the present invention is to provide such cloud-based system network, wherein each client computing system further comprises a machine code scanning module for scanning and reading any machine-readable code, including optical code symbols and/or RFID tags, that are applied to the magnetic peg-board system, and provide a direct link to said designated website portal.

Another object of the present invention is to provide such cloud-based system network, wherein client computing system is a mobile computing device with the capacity to read machine-readable code symbols, and support the display of GUI screen on the mobile device to support designing, ordering, producing, and updating a child's customized magnetic peg-board activity planning/scheduling system.

Another object of the present invention is to provide a new and improved method of designing, ordering, producing, and updating a child's customized magnetic peg-board activity planning/scheduling system, comprising the steps: providing a customer with the web browser of a mobile computing system deployed on a system network; and the customer entering a proper URL into the customer's web browser which automatically directs the customer's web browser to a designated Website Portal, where the customer can design and order/procure a magnetic peg-board activity planning/scheduling system for delivery to the customer's family and children for intended use.

Another object of the present invention is to provide a new and improved method of designing, ordering, producing, and updating a child's customized magnetic peg-board activity planning/scheduling system, comprising the steps: a providing a customer with the web browser of a client computing system deployed on a system network, to scan and read a machine-readable code (e.g. QR code) applied to the surface of a peg-board having magnetic tile components, a manual, publications and/or other media, which automatically directs the user's web browser to the URL of a designated website portal, where the user can either: design, order/procure and deliver a magnetic peg-board activity planning/scheduling system to the user's family and children for intended use; or re-design and update and deliver new tile components to the user, as their children grow and their interests and activities change with time.

Another object of the present invention is to provide a new and improved method of designing, ordering, producing, and updating a child's customized magnetic peg-board activity planning/scheduling system, comprising the steps: (a) logging into the web-site portal, and the user/customer creating a user account, and then using the tools supported on the website to generate graphical user interfaces (GUIs) served to the web browser, enabling the customer to digitally model and design a customized magnetic peg-board activity scheduling and routine planning system, for use by a specific child/children in daily routines at any moment in time, wherein the customer specifies the size of the magnetic pegboard system (i.e. small or large display space), and its orientation of use/display (i.e. vertical or horizontal mounting); (b) based on the specification of the daily routines and pegboard size and orientation, the system will design a custom-designed magnetic pegboard system having a custom set of magnetic activity tiles selected exclusively for the customer; (c) during the system design specifications, each magnetic activity tile will be assigned a proper activity title (i.e. specified by graphics and text) for printing on the magnetic tile component during its manufacture/construction, and the user will be provided with choices as to font style, color and other features of the graphical indicia to be custom printed on the activity tile components of the custom system; (d) based on the design specifications for the customer's magnetic pegboard system design, the system will accept the customer's purchase order placed online via the computer system for purchase of a magnetic pegboard system having the provided design specifications; (e) the system fulfills the customer's order for the magnetic pegboard system, by (i) constructing the system according to the customer's magnetic pegboard system design specifications, (ii) packaging the produced components for the system, and then (iii) shipping the assembled product to the customer's shipping address; (f) applying a unique machine-readable code (e.g. QR (quick response) code symbol) that is automatically generated for the customer's specially-ordered magnetic pegboard activity planning/scheduling system and applied to the magnetic pegboard activity planning/scheduling system (and related product brochures and learning guides), preferably at the factory production and order fulfillment center, where the product is manufactured, assembled, packaged and shipped to its customer's address, wherein the unique QR code symbol is encoded with the URL (unform resource locator) of the magnetic peg-board system maintenance web-portal and other information relating to the customer's product order, and is maintained within the system database servers at the data centers supporting the product delivery and service platform; (g) once the system is received at the customer's shipping address, the customer mounts the magnetic pegboard on a surface and inserts the components (i.e. magnetic divider tiles, day of week tiles etc.) within magnetic pegboard system, and then child/children start using the system according to the guidelines and instructions provided with the system; (h) after passage of time and use of the magnetic pegboard system, the child/children grows older, develops new interests and adopts new interests, activities and modified routines, and so the customer returns to and logs into the e-commerce web site portal, and accesses the customer's user account and redesigns/updates the customized/bespoke magnetic pegboard system design, based on the new interests, activities and routines of the child/children; (i) based on the new/updated design for the child's customized magnetic pegboard system design, the customer places a new purchase order, on the website portal, for new custom magnetic tiles designed for use with the customer's updated customized magnetic pegboard system so that the system will continue to meet and support the growing needs, interests and activities of the child/children and their family; (j) the system fulfills the customer's order for new activity tiles for use with the custom-design magnetic pegboard system, by constructing the new magnetic tiles according the updated system design specifications. The system then packages the newly constructed tile components for the system, and ships the ordered product(s) to the customer's shipping address for integration and use with the magnetic pegboard system; and (k) the customer uses the new magnetic activity tiles with the customer's magnetic pegboard system, according to the guidelines and instructions provided with the pegboard system, which may be printed and/or provided as digital publications and online video tutorials at the manufacturer's magnetic peg-board system website portal, providing step-by-step instructions and guidance to parents and caregivers.

There and other objects of the present invention will become apparent hereinafter and in the Claims.

### BRIEF DESCRIPTION OF THE DRAWINGS

The above Objects of the Present Invention will be more fully understood when taken in conjunction with the following Figure Drawings, wherein like elements are indicated by like reference numbers, wherein:

FIG. 1 is a schematic representation of the cloud-based system network of the present invention supporting customization, updating and maintenance of the magnetic peg-board activity planning/scheduling systems of the present invention, deployed and used by child and caregivers;

FIG. 1A is a perspective view of a first mobile client computing system, having a smartphone form factor, for scanning a QR code applied to the rear surface of a deployed magnetic peg-board activity planning/scheduling system of the present invention, and encoded with a programmed URL that assists the system user (e.g. parent or caregiver) to instantly navigate to, access and log-onto a magnetic peg-board system maintenance web portal of the present invention, so as to re-design and update the library of magnetic peg-based activity tiles required to meet the growing interests and activities of particular children within the family, and thereafter purchase extra custom-designed activity tiles for production and delivery to the system user using e-commerce methods and principles;

FIG. 1B is a perspective view of a second mobile client computing system, having a mobile tablet computer form factor, for scanning a QR code applied to the rear surface of a deployed magnetic peg-board activity planning/scheduling system of the present invention, deployed, and used by child and caregivers;

FIG. 1C is a schematic representation of the general system architecture of the mobile client computing system deployed on the system network of the present invention;

FIGS. 2A and 2B, taken together, set forth a flow chart describing the primary steps involved in the practice of the method of designing, ordering, producing, and updating a child's customized magnetic peg-board activity planning/scheduling system, in accordance with the principles of the present invention;

FIG. 3A is an elevated front side view of the first (large) illustrative embodiment of the magnetic peg-board activity planning/scheduling system of the present invention, shown arranged in its horizontal display orientation, and comprising its metallic-based pegboard panel of wood-framework construction, to which a set of magnetic peg-based indicating tiles are magnetically and peg-board coupled, including (i) a Custom Name Indicating Magnetic Peg-Based Tile of the present invention, (ii) 7 Days of Week Indicating Magnetic Peg-Based Tiles (S-M-T-W-TH-F-S), (iii) Six (6) Magnetic Peg-Based Dividers having 3 or more magnetic peg-structures for mounting to the magnetic peg-board panel, and (iv) a plurality of Specific Activity/Event Indicating Magnetic Peg-Based Activity Tiles mounted between the Magnetic Peg-Based Dividers;

FIG. 3A1 shows a partial fragmented cross-sectional view of the magnetic peg-board panel and sequence of activity indicating tile pieces mounted on the child activity planning/scheduling system of the present invention, taken along line 3A1-3A1 in FIG. 3A;

FIG. 3B is an elevated front side view of the first (large) illustrative embodiment of the magnetic peg-board activity planning/scheduling system of the present invention, shown arranged in its vertical display orientation, and comprising its metallic-based peg-board panel construction, to which a set of magnetic peg-based indicating tiles are magnetically and peg-board coupled, including (i) a Custom Name (e.g. AVA) Indicating Magnetic Peg-Based Tile of the present invention, (ii) Two Magnetic Peg-Based Dividers mounted on the peg-board panel construction using several (e.g. 3 or 4) magnetic peg structures, and creating Morning activity and Evening Activity spaces on the front surface of the pegboard board panel, between which a Daily Routine Planning space is created, (iii) Morning and Evening Indicating Magnetic Peg-Based Tiles for mounting in Morning and Evening Activity Spaces created on the peg-board panel, (iv) 7 Days of the Week Indicating Magnetic Peg-Based Tiles (S-M-T-W-TH-F-S) for mounting in the Daily Routine Planning Space, and (v) a plurality of Specific Activity/Event Indicating Magnetic Peg-Based Activity Tiles mounted between the Magnetic Peg-Based Tiles within the Daily Routine Planning Space;

FIG. 4A is an elevated front side view of the second (small) illustrative embodiment of the magnetic peg-board activity planning/scheduling system of the present invention, shown arranged in its horizontal display orientation, and comprising its metallic-based pegboard panel construction, to which a set of magnetic peg-based indicating tiles are magnetically and peg-board coupled, including (i) a Custom Name (e.g. HENRY) Indicating Magnetic Peg-Based Tile of the present invention, Morning and Evening Indicating Magnetic Peg-Based Indication Tiles, One Magnetic Peg-Based Divider, and a plurality of Specific Activity/Event Indicating Magnetic Peg-Based Activity Tiles;

FIG. 4B is an elevated front side view of the second (small) illustrative embodiment of the magnetic peg-board activity planning/scheduling system of the present invention, shown arranged in its vertical display orientation, and comprising its metallic-based pegboard panel construction, to which magnetically coupled a set of magnetic peg-based indicating tiles area are magnetically and peg-board coupled, including (i) a To Do and Done Indicating Magnetic Peg-Based Tiles of the present invention, (ii) One Magnetic Peg-Based Divider mounted on the panel construction to create a Top Do Space, and a Done Space, and (iii) a plurality of Specific Activity/Event Indicating Magnetic Peg-Based Activity Tiles mounted on the To Do and Done Space side of the Magnetic Peg-Based Divider;

FIG. 5 is an elevated front side view of the first (large) illustrative embodiment of the magnetic peg-board activity planning/scheduling system of the present invention shown arranged in its vertical display orientation, and comprising its metallic-based pegboard panel construction, to which a set of magnetic peg-based indicating tiles are magnetically and peg-board coupled, including (iv) a Custom Name Indicating Magnetic Peg-Based Tile of the present invention, Morning and Evening Indicating Magnetic Peg-Based Tiles, (ii) Two Magnetic Peg-Based Dividers mounted on the peg-board panel construction and creating Morning Activity and Evening Activity Spaces on the board, between which is a Daily Routine space, (iii) 7 Days of Week Indicating Magnetic Peg-Based Tiles (S-M-T-W-TH-F-S) mounted in the Daily Activity Routine Space of the activity peg-board panel, and (iv) a plurality of Specific Activity/Event Indicating Magnetic Peg-Based Activity Tiles mounted between the Magnetic Peg-Based Divider Tiles within the Daily Activity Routine Space of the system;

FIG. 6A is a front perspective view of metallic-based pegboard panel construction employed in the first (large) illustrative embodiment of the magnetic peg-board activity planning/scheduling system shown in FIG. 3A, and arranged in its horizontal display orientation, to which a set of magnetic peg-based indicating tiles, constructed in accordance with the present invention, are magnetically and physically (i.e. peg-board) coupled;

FIG. 6B is a front side view of metallic-based pegboard panel construction of FIG. 6A employed in the first (large) illustrative embodiment of the magnetic peg-board activity planning/scheduling system shown in FIG. 3A;

FIG. 6C is a rear perspective view of metallic-based pegboard panel construction of FIGS. 6A and 6B employed in the first (large) illustrative embodiment of the magnetic peg-board activity planning/scheduling system shown in FIG. 3A, comprising a wooden framework within which a metallic panel and laser-cut peg-board panel are mounted, and having tapered top and side hardware wall hangers (e.g. handing brackets);

FIG. 6D is an elevated edge view of metallic-based pegboard panel construction of FIGS. 6A, 6B and 6C employed in the first (large) illustrative embodiment of the magnetic peg-board activity planning/scheduling system of the present invention shown in FIG. 3A;

FIG. 6E is an elevated side view of metallic-based pegboard panel construction of FIGS. 6A, 6B, 6C and 6E employed in the first (large) illustrative embodiment of the magnetic peg-board activity planning/scheduling system shown in FIG. 3A;

FIG. 6F is a front perspective view of metallic-based pegboard panel construction of FIGS. 6A, 6B, 6C, 6D and 6E employed in the first (large) illustrative embodiment of the magnetic peg-board activity planning/scheduling system shown in FIG. 3A, and arranged in its horizontal display orientation, to which a set of magnetic peg-based indicating tiles are magnetically and peg-board coupled, wherein a set of magnetic peg-based indicating tiles are being set up for use in a child's daily activity planning and scheduling, namely (i) a Custom Name (i.e. Blank) Indicating Magnetic Peg-Based Tile of the present invention, (ii) Six Magnetic Peg-Based Dividers mounted below the Child Name Tile and creating seven (7) daily Activity Routine Spaces, one for each day of week, (iii) the 7 Days of Week Indicating Magnetic Peg-Based Tiles (S-M-T-W-TH-F-S) mounted to the left of its respective Day of Week Routine Space (i.e., Track) as shown, within which a plurality of Specific Activity/Event Indicating Magnetic Peg-Based Activity Tiles can and will be mounted between the Magnetic Peg-Based Dividers within the Daily Activity Routine Tracks by the child and/or parent during the use of the magnetic peg-board system of the present invention;

FIG. 7A is a front partially-cutaway perspective exploded view of metallic-based pegboard panel construction employed in the first (large) illustrative embodiment of the magnetic peg-board activity planning/scheduling system in FIG. 3A, showing a first board construction according to the present invention comprising a wooden framework mounting and holding together (i) a painted (i.e. powder-coated) magnetic-steel sheet, and a laser-cut peg apertured panel made of ⅛ acrylic plastic material, wherein a pair of metal hanging plate inserts are mounted within the rear side of the wood material within the top and rear sides of the wooden framework for vertical and horizontal mounting installations of the peg-board panel;

FIG. 7B is a front perspective exploded view of the metallic-based pegboard panel construction employed in the magnetic peg-board activity planning/scheduling system shown in FIGS. 3A. and 7A;

FIG. 7C is a rear perspective exploded view of metallic-based pegboard panel construction employed in the magnetic peg-board activity planning/scheduling system shown in FIGS. 3A, 7A and 7B, shown comprising a wooden framework mounting and holding together a painted (i.e. powder-coated) magnetic-steel sheet and a laser-cut peg apertured panel made of ⅛ acrylic plastic material, and a pair of metal hanging plate inserts for mounting within the top and rear sides of the wooden framework for vertical and horizontal mounting;

FIG. 8A is a front perspective view of metallic-based pegboard panel construction employed in the second (large) illustrative embodiment of the magnetic peg-board activity planning/scheduling system of the present invention, shown constructed using metallic and plastic components;

FIG. 8B is a front perspective exploded view of metallic-based pegboard panel construction employed in the magnetic peg-board activity planning/scheduling system in FIG. 8A, shown comprising a laser-cut opaque acrylic (⅛″) plastic panel mounted to a painted (i.e. powder-coated) magnetic-steel sheet, and a laser-cut peg apertured panel made of ⅛ acrylic plastic material, both being assembled together using a set of spaced-apart standoff screws fastened though the corners and mid-sections of the peg-board panel construction, and wherein a set of a ribbon hangers are shown mounted to the top and rear sides of the plastic framework for supporting vertical and horizontal mounting orientations of the peg-board panel;

FIG. 9A is a front perspective view of metallic-based pegboard panel construction employed in the second (small) illustrative embodiment of the magnetic peg-board activity planning/scheduling system shown in FIG. 4A, and arranged in its vertical display orientation, to which a set of magnetic peg-based indicating tiles are magnetically and peg-board coupled in accordance with the principles of the present invention;

FIG. 9B is a rear side view of metallic-based pegboard panel construction of FIG. 9A employed in the second (small) illustrative embodiment of the magnetic peg-board activity planning/scheduling system shown in FIG. 4A;

FIG. 9C is an elevated edge view of metallic-based pegboard panel construction of FIGS. 9A and 9B employed in the second (small) illustrative embodiment of the magnetic peg-board activity planning/scheduling system shown in FIG. 4A;

FIG. 9D is an elevated side view of metallic-based pegboard panel construction of FIGS. 9A and 9B employed in the second (small) illustrative embodiment of the magnetic peg-board activity planning/scheduling system shown in FIG. 4A;

FIG. 9E is a front perspective view of metallic-based pegboard panel construction employed in the second (small) illustrative embodiment of the magnetic peg-board activity planning/scheduling system shown in FIG. 4A, and arranged in its horizontal display orientation, to which a set of magnetic peg-based indicating tiles are magnetically and physically peg-board coupled, including (i) a Custom Name (i.e. HENRY) Indicating Magnetic Peg-Based Tile of the present invention, (ii) One Magnetic Peg-Based (Space) Divider Tile having a multi-peg structure for securely magnetically coupling to the peg-board panel using extra-strong permanent magnets within the peg-structures, and having a flat low-profile structure to prevent children from (re) moving these divider tiles once mounted, (iii) Morning and Evening Indicating Magnetic Indication Tiles mounted to the peg-board and dividing up its overall indication space into upper and lower spaces, and (iv) a plurality of Specific Activity/Event Indicating Magnetic Peg-Based Activity Tiles for mounting on the Morning and Night sides of the peg-board, for use in planning out activity routines and scheduling specific activities for a specific child (or children) in particular orders throughout the Morning and Night Time;

FIG. 9F is an elevated front side view of the second (small) illustrative embodiment of the magnetic peg-board activity planning/scheduling system shown in FIG. 4A, and arranged in its vertical display orientation, and comprising its metallic-based pegboard panel construction, to which a set of magnetic peg-based indicating tiles are magnetically and physically peg-board coupled, including (i) a To Do and Done Indicating Magnetic Peg-Based Tiles mounted at the top left and right sides of the peg-board panel as shown to create a To Do Space and a Done Space, (ii) one elongated Magnetic Peg-Based Divider Tile mounted vertically down the middle of the peg-board panel to divide and create a To Do Space and a Done Space, and (iii) and a plurality of Specific Activity/Event Indicating Magnetic Peg-Based Activity Tiles mounted on the peg-board panel in the To Do Space and the Done Space of the peg-board panel;

FIG. 10 is a cut-away section of the magnetic peg-based tile mounting surface on the magnetic peg-board activity planning/scheduling system of the present invention, showing the mounting of three Custom Name (i.e. AVAI, MALORY and CHRISTOPHER) Indicating Magnetic Peg-Based Tiles of different sizes and lengths, and each being accommodated and mounted to the peg-based mounting surface using at least two magnetic peg-based structures and the peg-board mounting system and method taught herein;

FIG. 10A1 is a front perspective view of a first illustrative embodiment of the magnetic peg-based indicating tile component of the present invention, showing an exemplary indicating graphic (i.e. graphical indicia) representative of a “hair brush” with the typographical name for its activity indicated as “Brush hair”;

FIG. 10A2 is a rear perspective view of the first illustrative embodiment of the magnetic peg-based indicating tile component shown in FIG. 10A1;

FIG. 10B1 is a front perspective view of a second illustrative embodiment of the magnetic peg-based indicating tile component of the present invention employing a single magnetic peg-based structure, and providing a blank (e.g. white) front surface without bearing any graphics, text or other graphical indications, and free and available for a parent or caregiver to draw a graphic and/or write out a name for an activity on the blank surface, using an erasable, a semi-permanent or permanent ink-based marker, so as to be visually indicate a specific name, activity or other legend on the magnetic peg-based tile of the present invention;

FIG. 10B2 is a rear perspective view of the second illustrative embodiment of the magnetic peg-based indicating tile component shown in FIG. 10B1, showing a magnetic peg structure mounted within the planar wood-based body portion of the magnetic peg-based tile, designed to enable a young child to simply and controllably insert each magnetic peg-based indication tile into any intended peg aperture formed in the magnetic peg-board panel of the present invention, and then securely, but releasably held in place by the forces of magnetic attraction existing between (i) the magnetic element inside the wooden peg portion of the magnetic peg-based indicating tile structure, and (ii) the magnetic steel sheet mounted inside the magnetic peg-board panel assembly;

FIG. 10B3 is an elevated rear view of the second illustrative embodiment of the magnetic peg-based indicating tile component shown in FIGS. 10B1 and 10B2;

FIG. 10B4 is an elevated front view of the second illustrative embodiment of the magnetic peg-based indicating tile component shown in FIGS. 10B1, 10B2 and 10B3, showing its blank front surface free and available for a parent or caregiver to draw a graphic and/or write out a name for an activity to be visually indicated on the magnetic peg-based tile of the present invention;

FIG. 10B5 is a first elevated edge view of the second illustrative embodiment of the magnetic peg-based indicating tile component shown in FIGS. 10B1, 10B2, 10B3, and 10B4;

FIG. 10B6 is a second elevated edge view of the second illustrative embodiment of the magnetic peg-based indicating tile component shown in FIGS. 10B1, 10B2, 10B3, 10B4 and 10B5;

FIG. 10C1 is a front exploded perspective view of a first illustrative embodiment of the magnetic peg-based indicating tile shown in FIGS. 10A1, 10A2, 10B1, 10B2, 10B3, 10B4, 10B5, and 10B6, comprising (i) a planar base plate provided with an square aperture, (ii) a planar indication plate of the same geometrical dimensions as the base plate, and mounted to the planar base plate with adhesive or other fastening means, (iii) a small cubic structure provided with a hollow cylindrical recess for mounting a permanent magnetic cylinder with its magnetic field aligned with the axis of the cubic structure, and having cross sectional dimensions that permit permanent mounting within the square aperture of the planar base plate, and (iv) an indication surface on the planar indication plate for carrying and/or supporting an exemplary graphic representative of an activity or event, along with a typographical name for the activity, as the case may be;

FIG. 10C2 is a rear exploded perspective view of the first illustrative embodiment of the magnetic peg-based indicating tile component shown in FIGS. 10A1, 10A2, 10B1, 10B2, 10B3, 10B4, 10B5, and 10B6, and exploded in FIG. 10C2 showing an exemplary typographical name for the time period (e.g. day) indicated as “Thursday;”

FIG. 11A is a front perspective view of a first illustrative embodiment of the magnetic peg-based “Activity” indicating tile component of the present invention constructed as shown in FIGS. 11C1 and 11C2, using a plastic back plate component having an integrated plastic peg structure embodying a permanent magnet, and showing an exemplary graphic and typographical name for the activity indicated as “Put on Sunscreen;”

FIG. 11B1 is a front perspective view of a second illustrative embodiment of the magnetic peg-based “Activity” indicating tile component of the present invention constructed using a plastic back plate component having an integrated plastic peg structure embodying a permanent magnet, and showing an exemplary graphic and typographical name for the activity indicated as “Brush Hair;”

FIG. 11B2 is a rear perspective view of a third illustrative embodiment of the magnetic peg-based “Activity” indicating tile components of FIGS. 11A and 11B1 constructed using a plastic back plate component having an integrated plastic peg structure embodying a permanent magnet, and showing an exemplary graphic and typographical name for the specific activity indicated on each respective peg-based activity indicating tile;

FIG. 11C1 is a front perspective exploded view of the illustrative embodiment of the magnetic peg-based “Activity” indicating tile component of the present invention shown in FIGS. 11A, 11B1 and 11B2, and constructed using a plastic back plate component having an integrated plastic peg structure embodying a permanent magnet within its hollow cylindrical recess, and permanently mounted to a planar indication plate having a front surface for carrying and/or supporting graphical indications and/or text description of the activity to be represented by the activity indicating tile component of the present invention;

FIG. 11C2 is a rear perspective exploded view of the illustrative embodiment of the magnetic peg-based “Activity” indicating tile component of the present invention shown in FIGS. 11A, 11B1, and 11B2, and constructed using a plastic back plate component having an integrated plastic peg structure embodying a permanent magnet within its hollow cylindrical recess, and permanently mounted to a planar indication plate having a front surface for carrying and/or supporting graphical indications and/or text description of the activity to be represented by the activity indicating tile component of the present invention;

FIG. 12A is a perspective view of a fourth illustrative embodiment of the magnetic peg-based “Day of the Week” indicating tile component of the present invention, constructed as shown in FIG. 12A1-12A6, using a plastic back plate component having an integrated plastic peg structure with a cylindrical recess for installation and embodying of a permanent magnet of similar cylindrical geometry, and showing an exemplary graphic and typographical name for the activity indicated as “Put on Sunscreen;”

FIG. 12A1 is an elevated front view of the fourth illustrative embodiment of the magnetic peg-based indicating tile component of the present invention shown in FIG. 12A, and employing two spaced apart magnetic peg-based structures design for releasable magnetic-force-based mounting the elongated indicating tile component, and further showing its blank front surface free and available for a parent or caregiver to draw a graphic and/or write out a name for an activity to be visually indicated on the magnetic peg-based tile of the present invention, or for supporting a graphical image and/or text description of an activity to be represented by the magnetic tile component;

FIG. 12A2 is an elevated rear view of the fourth illustrative embodiment of the magnetic peg-based indicating tile component of FIG. 12A employing two spaced-apart magnetic peg structures for mounting the elongated indicating tile component, and further showing its rear front surface and its two spaced apart magnetic peg structures for magnetically and peg-board coupling to the magnetic pegboard panel of the present invention;

FIG. 12A3 is a plan rear view of the fourth illustrative embodiment of the magnetic peg-based indicating tile component shown in FIGS. 12A1 and 12A2;

FIG. 12A4 is a plan front view of the fourth illustrative embodiment of the magnetic peg-based indicating tile component shown in FIGS. 12A1, 12A2 and 12A3;

FIG. 12A5 is a first elevated edge view of the fourth illustrative embodiment of the magnetic peg-based indicating tile component shown in FIGS. 12A1, 12A2, 12A3 and 12A4;

FIG. 12A6 is a second elevated edge view of the fourth illustrative embodiment of the magnetic peg-based indicating tile component shown in FIGS. 12A1, 12A2, 12A3 12A4 and 12A5;

FIG. 12B1 is a front perspective exploded view of the fourth illustrative embodiment of the two magnetic peg-based indicating tile component shown in FIGS. 12A1 through 12A6, having a wood tile construction comprising (i) a planar base plate provided with a square (i.e. or diamond-shaped) aperture, (ii) a planar indication plate of the same geometrical dimensions as the base plate, and mounted to the planar base plate with adhesive or other fastening means, (iii) a small cubic structure provided with a hollow cylindrical recess for mounting a permanent magnetic cylinder with its magnetic field aligned with the axis of the cubic structure, and having cross sectional dimensions that permit permanent mounting within the square aperture of the planar base plate, and (iv) an indication surface on the planar indication plate for carrying and/or supporting an exemplary graphic representative of an activity or event, along with a typographical name for the activity, as the case may be;

FIG. 12B2 is a rear exploded perspective view of the fourth illustrative embodiment of the two magnetic peg-based indicating tile component of FIGS. 12A1 through 12A6, and 12B1;

FIG. 13A is a front perspective view of fifth illustrative embodiment of the magnetic two peg-based indicating tile component of the present invention similar to the tile design shown in FIGS. 12A to 12A6, and 12B1 and 12B2, however, having an elongated length for displaying more graphical indicia, and employing a wood/plastic tile construction using a plastic back plate component having an integrated plastic peg structure embodying a permanent magnet within its hollow cylindrical recess, and permanently mounted to a planar wood-based indication plate having a front surface for carrying and/or supporting graphical indications and/or text description to be represented by the graphics/text indicating tile component of the present invention;

FIG. 13B is a rear perspective view of the fifth illustrative embodiment of the magnetic two peg-based indicating tile component of FIG. 13A having elongated design;

FIG. 13C is an elevated rear view of the fifth illustrative embodiment of the magnetic peg-based indicating tile component of FIGS. 13A and 13B;

FIG. 13D is an elevated front view of the fifth illustrative embodiment of the magnetic peg-based indicating tile component of FIGS. 13A, 13B and 13C;

FIG. 13E is an elevated first edge view of the fifth illustrative embodiment of the magnetic peg-based indicating tile component of FIGS. 13A through 13D;

FIG. 13F is an elevated first edge view of the fifth illustrative embodiment of the magnetic peg-based indicating tile component of FIGS. 13A through 13E;

FIG. 14A is a front perspective view of six illustrative embodiment of the magnetic two peg-based indicating tile component of the present invention similar to the tile design shown in FIGS. 13A1 to 13A6, however, having an extra-elongated length for displaying more graphical indicia, and employing a wood/plastic tile construction using a plastic back plate component having an integrated plastic peg structure embodying a permanent magnet within its hollow cylindrical recess, and permanently mounted to a planar wood-based indication plate having a front surface for carrying and/or supporting graphical indications and/or text description to be represented by the graphics/text indicating tile component of the present invention;

FIG. 14B is a rear perspective view of the sixth illustrative embodiment of the magnetic two peg-based indicating tile component of FIG. 14A having elongated design;

FIG. 14C is an elevated rear view of the sixth illustrative embodiment of the magnetic peg-based indicating tile component of FIGS. 14A and 14B;

FIG. 14D is an elevated front view of the sixth illustrative embodiment of the magnetic peg-based indicating tile component of FIGS. 14A, 14B and 14C;

FIG. 14E is an elevated first edge view of the sixth illustrative embodiment of the magnetic peg-based indicating tile component of FIGS. 14A through 14D;

FIG. 14F is an elevated first edge view of the sixth illustrative embodiment of the magnetic peg-based indicating tile component of FIGS. 14A through 14E;

FIG. 15A is a front perspective view of the seventh illustrative embodiment of the magnetic three (3) peg-based indicating tile component, showing the plastic tile construction of the present invention using a plastic back plate component of extra-elongated length having an integrated plastic three (3) peg structure embodying a permanent magnet within its hollow cylindrical recess, and permanently mounted to a planar wooden indication plate having a front surface for carrying and/or supporting graphical indications and/or text description to be represented by the graphics/text indicating tile component of the present invention;

FIG. 15B is a rear perspective view of the seventh illustrative embodiment of the magnetic three peg-based indicating tile component of FIG. 15A;

FIG. 15C is an elevated rear view of the seventh illustrative embodiment of the magnetic peg-based indicating tile component of FIGS. 15A and 15B;

FIG. 15D is an elevated front view of the seventh illustrative embodiment of the magnetic peg-based indicating tile component of FIGS. 15A through 15C;

FIG. 15E is an elevated first edge view of the seventh illustrative embodiment of the magnetic peg-based indicating tile component of FIGS. 15A through 15D;

FIG. 15F is an elevated first edge view of the seventh illustrative embodiment of the magnetic peg-based indicating tile component of FIGS. 15A through 15E;

FIG. 16 is a flow chart describing the primary steps involved in practicing an exemplary method of using the child's magnetic peg-board activity planning/scheduling system of the present invention for purpose of helping parent and caregivers, and their children, to learn how to plan, schedule and execute activities and routines in the life of a child(ren) in ways that will add to the harmony and joy of family life, foster family connections, while developing the skills and minds of children;

FIG. 17 is a schematic representation of printed product brochure (e.g. single sheet flyer) illustrating the magnetic peg-board activity scheduling/planning system of the present invention, bearing a machine-readable (e.g. QR) code printed on the brochure that is programmed to direct a web-enabled smartphone or tablet computer, when scanning and reading the code, to automatically navigate to and display webpages of a website portal operated by the product manufacturer, where the consumer can design, build order and procure a customized magnetic peg-board activity scheduling/planning system of the present invention for a specific child, or children, as the case may be, for fulfillment and delivery to the customer anywhere around the world;

FIG. 18A is a schematic representation of a mobile smartphone computing system shown operated in its digital camera mode, wherein its digital camera system images and captures a machine-readable code printed on the product brochure of FIG. 17, and wherein its web-enabled browser application supports and enables the first step of the mobile phone method of designing, building and ordering custom magnetic peg-board child activity planning/scheduling systems of the present invention, involving the automated reading of the machine-readable code and navigating to the webpage(s) of the website portal operated by the product manufacturer and/or its partner(s);

FIG. 18B is a schematic representation of a graphical user interface (GUI) supported by the web browser of the mobile smartphone computing system shown in FIG. 18A, and displaying the webpage at the manufacturer's website portal, and enabling the second step of the mobile phone method of designing, building and ordering custom magnetic peg-board child activity planning/scheduling systems of the present invention supported by the website portal and related order fulfillment infrastructure, and involving a brief overview on the primary steps of the method of the present invention;

FIG. 18C is a schematic representation of a graphical user interface (GUI) supported by the web browser of the mobile smartphone computing system shown in FIG. 18A, and displaying the webpage at the manufacturer's website portal, and enabling the third step of the mobile phone method of designing, building and ordering custom magnetic peg-board child activity planning/scheduling systems of the present invention, involving the identification of the child for whom the system is being custom design, built and deployed over the system network of the present invention;

FIG. 18D is a schematic representation of a graphical user interface (GUI) supported by the web browser of the mobile smartphone computing system shown in FIG. 18A, and displaying the webpage at the manufacturer's website portal, and enabling the fourth step of the mobile phone method of designing, building and ordering custom magnetic peg-board child activity planning/scheduling systems of the present invention, involving identifying the date of birth of each child for whom the custom magnetic peg-board child activity planning/scheduling system will be used:

FIG. 18E is a schematic representation of a graphical user interface (GUI) supported by the web browser of the mobile smartphone computing system shown in FIG. 18A, and displaying the webpage at the manufacturer's website portal, and enabling the fifth step of the mobile phone method of designing, building and ordering custom magnetic peg-board child activity planning/scheduling systems of the present invention, involving specification of the size of the custom magnetic peg-board child activity planning/scheduling system, and disclosure of the purchase price thereof,

FIG. 18F is a schematic representation of a graphical user interface (GUI) supported by the web browser of the mobile smartphone computing system shown in FIG. 18A, and displaying the webpage at the manufacturer's website portal, and enabling the sixth step of the mobile phone method of designing, building and ordering custom magnetic peg-board child activity planning/scheduling systems of the present invention, involving specification of what components are included in the selected size and model of the product;

FIG. 18G is a schematic representation of a graphical user interface (GUI) supported by the web browser of the mobile smartphone computing system shown in FIG. 18A, and displaying the webpage at the manufacturer's website portal, and enabling the seventh step of the mobile phone method of designing, building and ordering custom magnetic peg-board child activity planning/scheduling systems of the present invention, involving specification and selection of the peg-board layout for the selected size, which will influence how a child's activity tiles can be arranged in a routine;

FIG. 18H is a schematic representation of a graphical user interface (GUI) supported by the web browser of the mobile smartphone computing system shown in FIG. 18A, and displaying the webpage at the manufacturer's website portal, and enabling the eighth step of the mobile phone method of designing, building and ordering custom magnetic peg-board child activity planning/scheduling systems of the present invention, involving an overview description on the specification and selection of colors for the magnetic peg-board panel and its tile components;

FIG. 18I is a schematic representation of a graphical user interface (GUI) supported by the web browser of the mobile smartphone computing system shown in FIG. 18A, and displaying the webpage at the manufacturer's website portal, and enabling the ninth step of the mobile phone method of designing, building and ordering custom magnetic peg-board child activity planning/scheduling systems of the present invention, involving the specification of the child's name to be printed on the name indicating tile for use with the custom magnetic peg-board panel of the system;

FIG. 18J is a schematic representation of a graphical user interface (GUI) supported by the web browser of the mobile smartphone computing system shown in FIG. 18A, and displaying the webpage at the manufacturer's website portal, and enabling the tenth step of the mobile phone method of designing, building and ordering custom magnetic peg-board child activity planning/scheduling systems of the present invention, involving specification and selection of name tile finish for the name indicating tile to be used in building the framework of the custom magnetic peg-board panel of the system;

FIG. 18K is a schematic representation of a graphical user interface (GUI) supported by the web browser of the mobile smartphone computing system shown in FIG. 18A, and displaying the webpage at the manufacturer's website portal, and enabling the eleventh step of the mobile phone method of designing, building and ordering custom magnetic peg-board child activity planning/scheduling systems of the present invention, involving the specification and selection of the “frame” finish to be used in building the framework portion of the custom magnetic peg-board panel of the system;

FIG. 18L is a schematic representation of a graphical user interface (GUI) supported by the web browser of the mobile smartphone computing system shown in FIG. 18A, and displaying the webpage at the manufacturer's website portal, and enabling the twelfth step of the mobile phone method of designing, building and ordering custom magnetic peg-board child activity planning/scheduling systems of the present invention, involving the specification and selection of the “layout and activity” tile finishes to be used in building the layout and activity tile components for the custom magnetic peg-board panel of the system, and then the specification and selection of the “divider” tile finish to be used in building the divider tile components for the custom magnetic peg-board panel of the system;

FIG. 18M is a schematic representation of a graphical user interface (GUI) supported by the web browser of the mobile smartphone computing system shown in FIG. 18A, and displaying the webpage at the manufacturer's website portal, and enabling the thirteenth step of the mobile phone method of designing, building and ordering custom magnetic peg-board child activity planning/scheduling systems of the present invention, involving selecting the activity tiles for the daily routines of the child each day of the week (e.g. M-T-W-TH-FR-SAT-SUN);

FIG. 18N is a schematic representation of a graphical user interface (GUI) supported by the web browser of the mobile smartphone computing system shown in FIG. 18A, and displaying the webpage at the manufacturer's website portal, and enabling the fourteenth step of the mobile phone method of designing, building and ordering custom magnetic peg-board child activity planning/scheduling systems of the present invention, involving specification of which days of the week should each routine of activities should be applied;

FIG. 18O is a schematic representation of a graphical user interface (GUI) supported by the web browser of the mobile smartphone computing system shown in FIG. 18A, and displaying the webpage at the manufacturer's website portal, and enabling the fifteenth step of the mobile phone method of designing, building and ordering custom magnetic peg-board child activity planning/scheduling systems of the present invention, display the current design of the child's routine of activities for each day of the week, and edit as deemed necessary until the final checkout stage reflected in FIG. 18P,

FIG. 18P is a schematic representation of a graphical user interface (GUI) supported by the web browser of the mobile smartphone computing system shown in FIG. 18A, and displaying the webpage at the manufacturer's website portal, and enabling the sixteenth step of the mobile phone method of designing, building and ordering custom magnetic peg-board child activity planning/scheduling systems of the present invention, involving confirmation of the final design of the child's activity planning/scheduling routine, and layout(s), and completing the purchase of the custom magnetic peg-board child activity planning/scheduling system,

FIG. 19 is a schematic representation of printed magazine containing a two page product advertisement illustrating the magnetic peg-board activity scheduling/planning system of the present invention, bearing a machine-readable (e.g. QR) code printed on the magazine page that is programmed to direct a web-enabled smartphone or tablet computer, when scanning and reading the code, to automatically navigate to and display webpages of a website portal operated by the product manufacturer, where the consumer can design, build, order and procure a customized magnetic peg-board activity scheduling/planning system of the present invention for a specific child, or children, as the case may be, for fulfillment and delivery to the customer anywhere around the world;

FIG. 20A is a schematic representation of a mobile tablet computing system shown operated in its digital camera mode, wherein its digital camera system images and captures a machine-readable code printed on the product brochure of FIG. 19, and wherein its web-enabled browser application supports and enables the first step of the tablet computer method of designing, building and ordering custom magnetic peg-board child activity planning/scheduling systems of the present invention, involving the automated reading of the machine-readable code on the magazine page, and navigating to the webpage(s) of the website portal operated by the product manufacturer and/or its partner(s);

FIG. 20B is a schematic representation of a graphical user interface (GUI) supported by the web browser of the mobile tablet computing system shown in FIG. 19, and displaying the webpage at the manufacturer's website portal, and enabling the second step of tablet computer method of designing, building and ordering custom magnetic peg-board child activity planning/scheduling systems of the present invention supported by the website portal and related order fulfillment infrastructure, and involving a brief overview on the primary steps of the method of the present invention;

FIG. 20C is a schematic representation of a graphical user interface (GUI) supported by the web browser of the mobile tablet computing system shown in FIG. 19, and displaying the webpage at the manufacturer's website portal, and enabling the third step of the tablet computer method of designing, building and ordering custom magnetic peg-board child activity planning/scheduling systems of the present invention, involving the identification of the child by name, for whom the system is being custom design, built and deployed over the system network of the present invention,

FIG. 20D is a schematic representation of a graphical user interface (GUI) supported by the web browser of the mobile tablet computing system shown in FIG. 19, and displaying the webpage at the manufacturer's website portal, and enabling the fourth step of the tablet computer method of designing, building and ordering custom magnetic peg-board child activity planning/scheduling systems of the present invention, involving identifying the date of birth of each child for whom the custom magnetic peg-board child activity planning/scheduling system will be used;

FIG. 20E is a schematic representation of a graphical user interface (GUI) supported by the web browser of the mobile tablet computing system shown in FIG. 19, and displaying the webpage at the manufacturer's website portal, and enabling the fifth step of the tablet computer method of designing, building and ordering custom magnetic peg-board child activity planning/scheduling systems of the present invention, involving specification of the size of the custom magnetic peg-board child activity planning/scheduling system, and disclosure of the purchase price thereof;

FIG. 20F is a schematic representation of a graphical user interface (GUI) supported by the web browser of the mobile tablet computing system shown in FIG. 19, and displaying the webpage at the manufacturer's website portal, and enabling the sixth step of the tablet computer method of designing, building and ordering custom magnetic peg-board child activity planning/scheduling systems of the present invention, involving specification of layout and display orientation that feels right for the child and selected size and model, and which will influence how a child's activity tiles can be arranged in a routine;

FIG. 20G is a schematic representation of a graphical user interface (GUI) supported by the web browser of the mobile tablet computing system shown in FIG. 19, and displaying the webpage at the manufacturer's website portal, and enabling the seventh step of the tablet computer method of designing, building and ordering custom magnetic peg-board child activity planning/scheduling systems of the present invention, involving an overview description on the specification and selection of colors for the magnetic peg-board panel and its tile components;

FIG. 20H is a schematic representation of a graphical user interface (GUI) supported by the web browser of the mobile tablet computing system shown in FIG. 19, and displaying the webpage at the manufacturer's website portal, and enabling the eighth step of the tablet computer method of designing, building and ordering custom magnetic peg-board child activity planning/scheduling systems of the present invention, involving the specification of finishes for the child's Name Indicating Tile, the Layout (e.g. Morning/Evening) Indicating Tiles, Divider Tiles, and Peg-Board Framework to be built for use with the custom magnetic peg-board panel of the system;

FIG. 20I is a schematic representation of a graphical user interface (GUI) supported by the web browser of the mobile tablet computing system shown in FIG. 19, and displaying the webpage at the manufacturer's website portal, and enabling the ninth step of the tablet computer method of designing, building and ordering custom magnetic peg-board child activity planning/scheduling systems of the present invention, involving selecting the activity tiles for a first routine (e.g. Morning or Evening; or Daily Routine) of the child during the course of the week;

FIG. 20J is a schematic representation of a graphical user interface (GUI) supported by the web browser of the mobile tablet computing system shown in FIG. 19, and displaying the webpage at the manufacturer's website portal, and enabling the tenth step of the tablet computer method of designing, building and ordering custom magnetic peg-board child activity planning/scheduling systems of the present invention, involving selecting the activity tiles for another routine (e.g. Morning and Evening; or Daily Routine) of the child during the course of the week;

FIG. 20K is a schematic representation of a graphical user interface (GUI) supported by the web browser of the mobile tablet computing system shown in FIG. 19, and displaying the webpage at the manufacturer's website portal, and enabling the eleventh step of the tablet computer method of designing, building and ordering custom magnetic peg-board child activity planning/scheduling systems of the present invention, involving selecting additional activity tiles for another routine (e.g. Morning and Evening; or Daily Routine) of the child during the course of the week; and

FIG. 20L is a schematic representation of a graphical user interface (GUI) supported by the web browser of the mobile tablet computing system shown in FIG. 19, and displaying the webpage at the manufacturer's website portal, and enabling the twelfth step of the tablet computer method of designing, building and ordering custom magnetic peg-board child activity planning/scheduling systems of the present invention, involving confirmation of the final design of the child's activity planning/scheduling routine, and layout(s), and completing the purchase of the custom magnetic peg-board child activity planning/scheduling system.

### DETAILED DESCRIPTION OF THE ILLUSTRATIVE EMBODIMENTS OF THE PRESENT INVENTION

Referring to the figures in the accompanying Drawings, the various illustrative embodiments of the present invention will be described in detail, wherein like elements will be indicated using like reference numerals.

Specification of the Cloud-Based System Network of the Present Invention Designed and Built for Managing and Updating Customized Magnetic Peg-Board Activity Planning/Scheduling Systems Deployed to Families and their Children Around the World

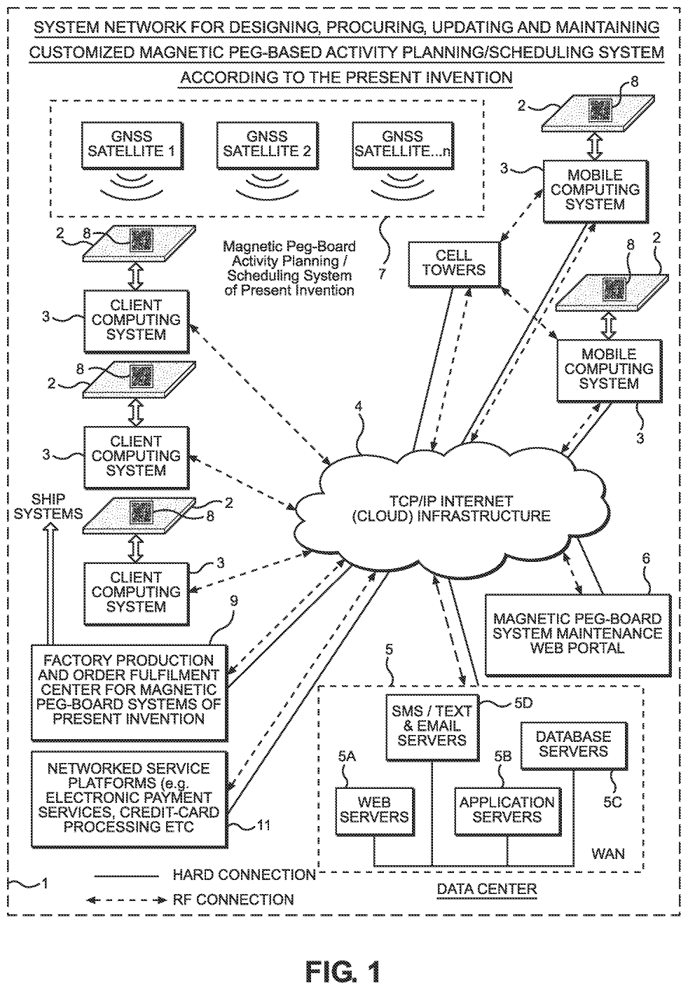

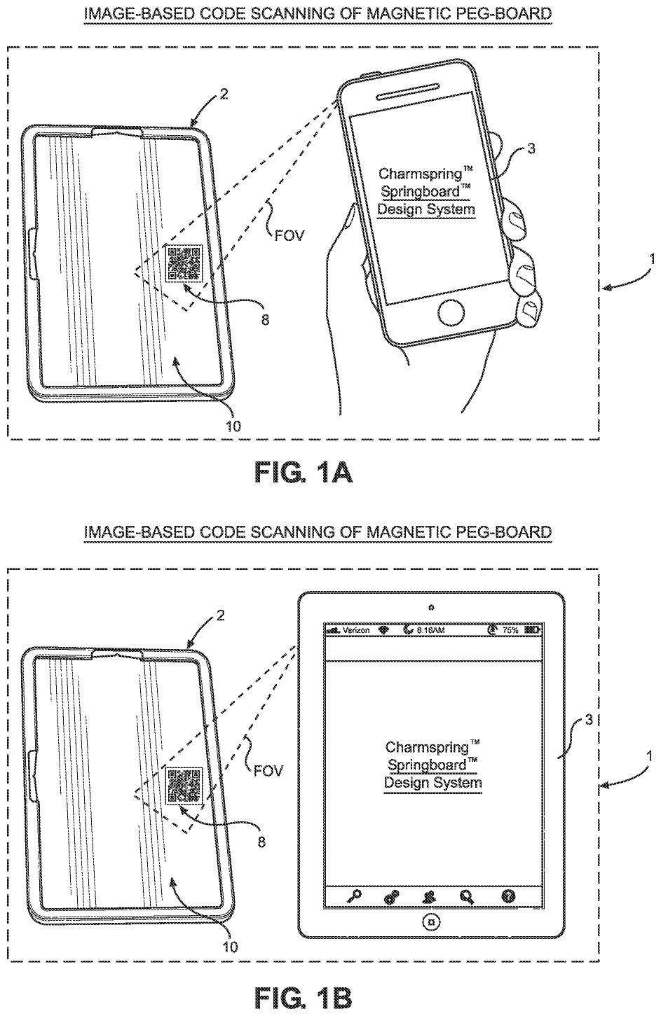

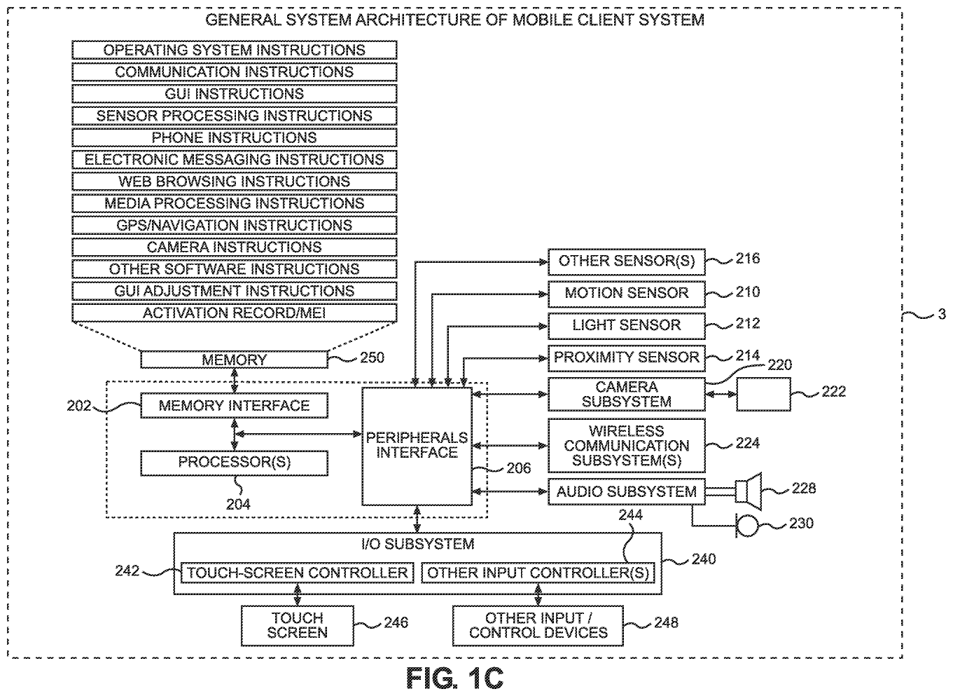

FIG. 1 shows a cloud-based system network of the present invention 1 designed and built for supporting the procurement, deployment, updating and maintenance of the customized magnetic peg-board activity planning/scheduling systems of the present invention 2 that allow families around the world, including parents, caregivers, and their young children, achieve and enjoy the many benefits of the present invention.

As shown in FIG. 1, the system network 1 comprises: a plurality of client computing systems 3 operably connected to the internet infrastructure 4 that is provided with cloud-based services described below; a plurality data centers 5 distributed around the world, each operably connected to the internet infrastructure 4, and supporting web, application and database servers, 5A, 5B, 5C and cloud-based services, in a manner well known in the cloud-based computing arts; one or more Factory Production and Fulfilment Centers 9 for manufacturing, producing, packaging and shipping Magnetic Peg-board Systems of the present invention 2 to customers around the world; a Magnetic Peg-board System Maintenance Web Portal 6 for use by customers around the world, when designing, ordering and updating their QR-coded magnetic peg-board systems of the present invention 2 using the web portal(s) 6 and client computing systems, as described herein; GPS-based system 7 for GPS tracking the location of Magnetic Peg-board Systems 2 that have been constructed and deployed to customers and families around the world, and are periodically updated as children grow and expand their interests and activities; and networked service platforms 11 (e.g. electronic payment services, credit card processing, etc.) deployed around the world.

Each family wishing to order, procure, and maintain a magnetic peg-board children activity planning/scheduling system 2 customized for their children, will employ a client computing system 3 to visit a designated website portal (e.g. https://www.chamspring.com) that is hosted on the industrial strength web, application and database servers 5 maintained within one or more data centers 5. Each client computing system 3 may have one of many possible form factors, such as a desktop computing system, a tablet computing system, a desktop workstation, a mobile smartphone device (e.g. Apple iPhone®, Google™ Android phone, or Samsung Galaxy® smartphone), and/or a portable computing appliance (implemented on a Linux® or other embedded operating system OS). In general, each client computing system 3 will be web-enabled and fully capable of accessing, displaying, and processing webpages served to the client computing system 3 by the web, application, and database system servers 5. The web pages containing graphical user interfaces (GUIS) with interface objects that enable the updating and maintenance of customized magnetic peg-board children activity planning/scheduling systems 2 in accordance with the principles of the present invention.

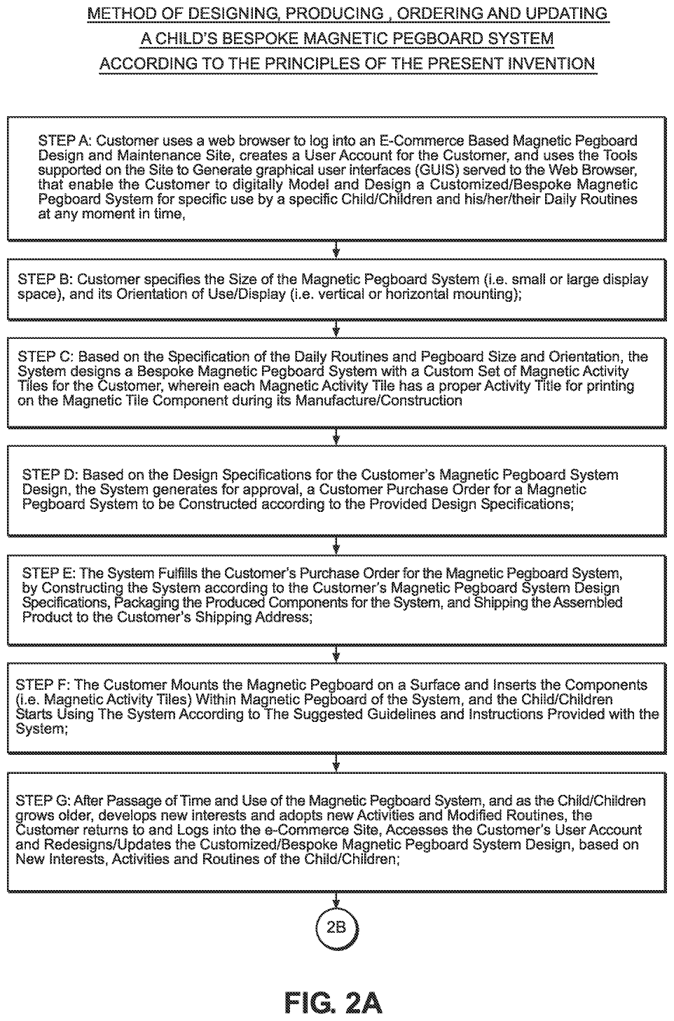

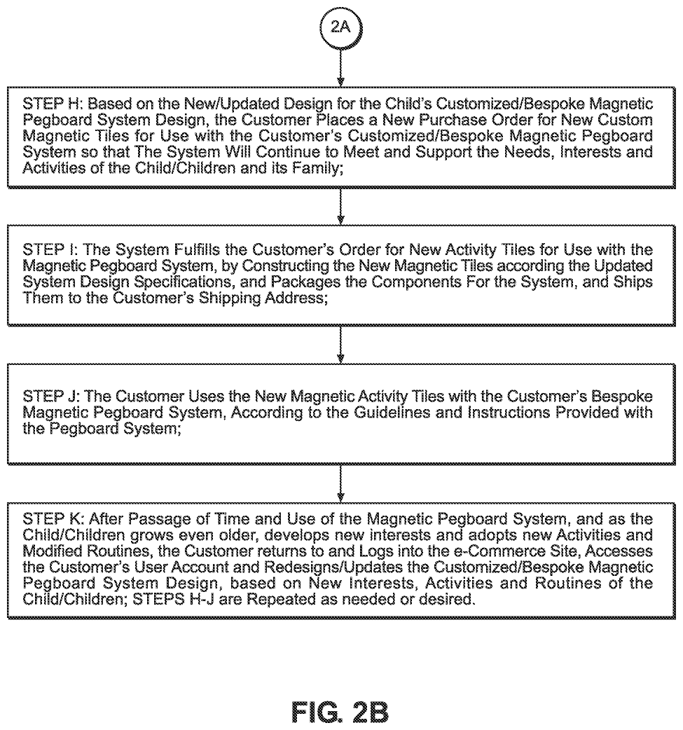

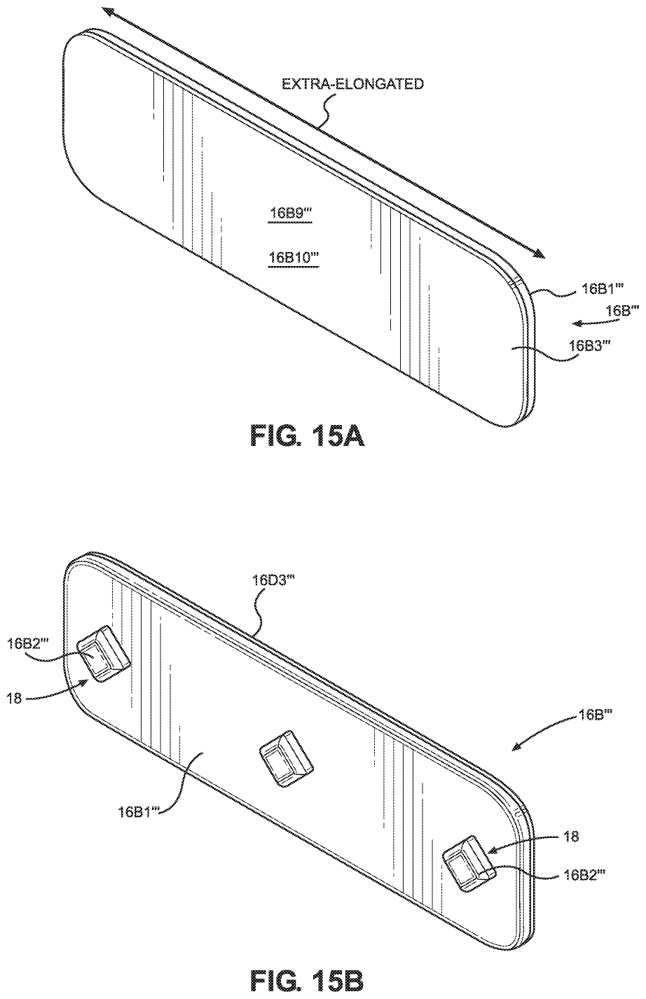

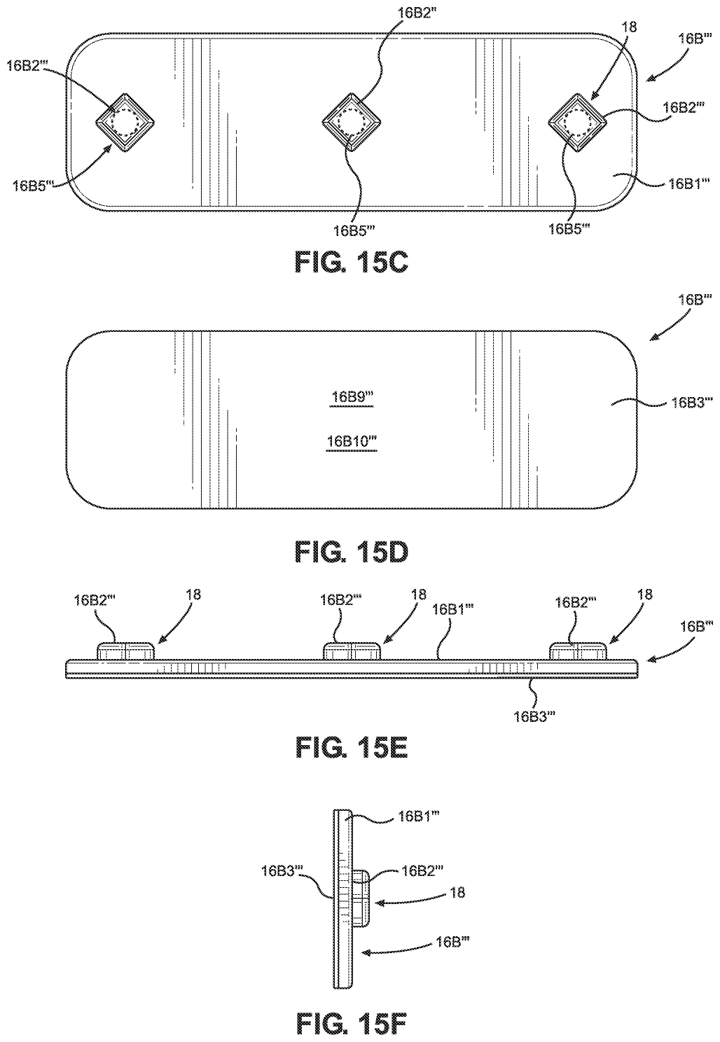

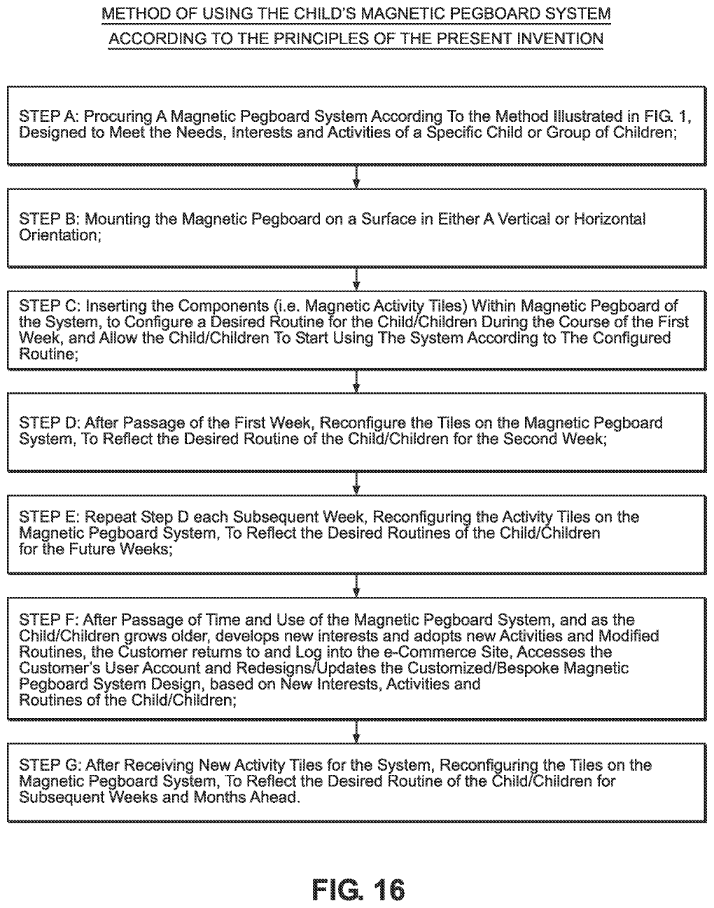

In general, the cloud-based system network of the present invention 1 may be implemented in different ways using available technologies available at the time of deployment now, and into the future. For example, the system can be designed and developed using any object-oriented integrated development environment (IDE) such as for example: the Java Platform, Enterprise Edition, or Java EE (formerly J2EE); IBM Websphere; Oracle Weblogic; a non-Java IDE such as Microsoft's.NET IDE; or any other suitably configured development and deployment environment known in the art, or to be developed in the future. Preferably, although not necessary, the system may be designed using object-oriented systems engineering (OOSE) methods well known in the art. Implementation programming languages may include C, Objective C, C, Java, PHP, Python, and other computer programming languages known in the art. In some deployments, private/public/hybrid cloud service and infrastructure providers, such Amazon Web Services (AWS) or any Open-Stack™ cloud-computing infrastructure provider, may be used to deploy Kubernetes and/or other open-source software container/cluster management/orchestration system for automating deployment, scaling, and management of containerized software applications, such as the enterprise-level application of the present invention, for the purposes of carrying out the methods of the present invention described in FIGS. 2A and 2B, and FIG. 15 described herein.

In a preferred embodiment, the data center 5 of the system network will support a robust cloud computing environment supported by OpenStack™ cloud-computing software and infrastructure. The OpenStack™ software platform consists of interrelated components that control diverse, multi-vendor hardware pools of processing, storage, and networking resources throughout each data center 5. The resulting infrastructure can equal or exceed the capacity and performance of conventional the cloud computing environments, such as provided by Amazon Web Services (AWS) and other infrastructure service providers around the world. In general, the infrastructure should be capable of supporting the data storage, computing, networking, and communication needs of the system network, and its user base around the world.

### Specification of System Architecture of an Exemplary Mobile Computing System Deployed on the Wireless System Network of the Present Invention

FIG. 1A shows a mobile smartphone system (e.g. Apple iPhone device) for performing the functions of the client computing system on the system network. FIG. 1B shows a mobile tablet computing system (e.g. Apple iPad device) for performing the functions of the client computing system on the system network. FIG. 1C shows the system architecture for each mobile smartphone system 3 and/or mobile tablet computing system 3 shown in FIGS. 1A and 1B, and depicted in FIG. 1 and throughout the Patent Specification.

FIG. 1C illustrates the system architecture of an exemplary mobile computing system (e.g. mobile smartphone or tablet computer system) 3 shown in FIGS. 1A and 1B and deployed on the wireless system network 1. While the detailed specification of the mobile computing device 3 can be found in U.S. Pat. No. 8,631,358 (assigned to Apple Inc), incorporated herein by reference in its entirety, it will helpful to illustrate its general construction below as this system component can be used to support the various services offered by the system network 1 for purposes of procuring, updating and maintaining the magnetic peg-based activity planning/scheduling board of the present invention.

As disclosed in FIG. 1C, the mobile computing device can include a memory interface 202, one or more data processors, image processors and/or central processing units 204, and a peripherals interface 206. The memory interface 202, the one or more processors 204 and/or the peripherals interface 206 can be separate components or can be integrated in one or more integrated circuits. One or more communication buses or signal lines can couple the various components in the mobile device. Sensors, devices, and subsystems can be coupled to the peripherals interface 206 to facilitate multiple functionalities. For example, a motion sensor 210, a light sensor 212, and a proximity sensor 214 can be coupled to the peripherals interface 206 to facilitate the orientation, lighting, and proximity functions. Other sensors 216 can also be connected to the peripherals interface 206, such as a positioning system (e.g., GPS receiver), a temperature sensor, a biometric sensor, a gyroscope, or other sensing device, to facilitate related functionalities. The GPS receiver enables processing GPS signals from the GPS satellites and supporting geolocation services within the mobile smartphone system 3. A camera subsystem 220 and an optical sensor 222, e.g., a charged coupled device (CCD) or a complementary metal-oxide semiconductor (CMOS) optical sensor, can be utilized to facilitate camera functions, such as recording photographs and video clips. Communication functions can be facilitated through one or more wireless communication subsystems 224, which can include radio frequency receivers and transmitters and/or optical (e.g., infrared) receivers and transmitters. The specific design and implementation of the communication subsystem 224 can depend on the communication network(s) over which the mobile computing device 3 is intended to operate. For example, a mobile device 3 may include communication subsystems 224 designed to operate over a GSM network, a GPRS network, an EDGE network, a Wi-Fi or WiMax network, and a Bluetooth™ network. In particular, the wireless communication subsystems 224 may include hosting protocols such that the mobile computing device 3 may be configured as a base station for other wireless devices. An audio subsystem 226 can be coupled to a speaker 228 and a microphone 230 to facilitate voice-enabled functions, such as voice recognition, voice replication, digital recording, and telephony functions. The I/O subsystem 240 can include a touch screen controller 242 and/or other input controller(s) 244. The touch-screen controller 242 can be coupled to a touch screen 246. The touch screen 246 and touch screen controller 242 can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen 246. The other input controller(s) 244 can be coupled to other input/control devices 248, such as one or more buttons, rocker switches, thumb-wheel, infrared port, USB port, and/or a pointer device such as a stylus. One or more buttons (not shown) can include an up/down button for volume control of the speaker 228 and/or the microphone 230. Such buttons and controls can be implemented as a hardware objects, or touch-screen graphical interface objects, touched and controlled by the system user.

In the preferred embodiments of the present invention, each mobile smartphone 3 requires a web-enabled browser program, such as Apple® Safari http browser program for the Apple® iPhone device 3 and the Apple® iPad® device 3, or any suitable web browser program for other brands of mobile phones, such as offered by Samsung, Google, Microsoft, and others. The mobile smartphone 3 should also be capable of scanning and reading any machine-readable code 8 described herein, including optical code symbols and/or RFID tags, as the wireless access and control application at hand may require to be properly and adequately supported on the access and control system network of the present invention.

Alternatively, a native mobile application may be designed, developed, and installed on any mobile computing system 3 to provide the mobile computing device 3 with the capacity to read machine-readable code symbols, and support the display of GUI screens on the mobile device to support the procurement, updating and management services provided to the user by the service provider. In most applications, it is expected that native mobile applications designed for practicing components of the present invention will be (i) web/http-enabled despite running on native code, and (ii) enable the receipt, display, and transmission of HMTL documents (e.g. webpages) on the mobile phone, in a manner well known in the Internet arts and Web-based technology.

### Method of Designing, Producing, Ordering and Updating a Child's Custom Magnetic Pegboard System According to the Principles of the Present Invention

FIGS. 2A and 2B describe the primary steps involved in the practice of the method of designing, ordering, producing, and updating a child's customized magnetic peg-board activity planning/scheduling system 2, in accordance with the principles of the present invention;

As indicated in Step A of FIG. 2A, a customer uses the web browser of a mobile computing system 3 deployed in the system network of FIG. 1 to log into an E-Commerce Based Magnetic Pegboard Design and Maintenance Portal 6 of the present invention. This may be achieved in several different ways. One way is by entering a proper URL into the user's web browser which directs the user to the Web Portal 6 of the present invention, where the magnetic peg-board activity planning/scheduling system can be custom designed, ordered/procured and delivered to the user's family and children for intended use. An alternative way is for the user to use a web-enabled computing system 3 (e.g. Apple iPhone, Samsung Galaxy® smartphone, or a Google Android phone, or Apple iPad or other web-enabled tablet computer), as shown in FIGS. 1A and 1B, to scan and read a QR code 8 that is mounted on the rear surface of a peg-board 10, a manual, web advertisement, printed publication or other media, which automatically directs the user to the URL of the website portal, where the user can either: (i) design, order/procure and deliver a magnetic peg-board activity planning/scheduling system 2 to the user's family and children for intended use; or (ii) re-design and update and deliver new tile components to the user, as their children grow and their interests and activities change with time.

Once logged into the web-site portal, the user/customer will create a User Account, and then use the tools supported on the Website to generate graphical user interfaces (GUIS) served to the Web Browser, enabling the customer to digitally model and design a customized/bespoke magnetic peg-board activity scheduling and routine planning system, for use by a specific child/children of a given age, in daily routines at any moment in time. Notably, the design of any given pegboard system should be specified in terms of the needs, interests, and activities of the child and/or children.

As indicated in Step B in FIG. 2A, the customer specifies the size of the magnetic pegboard system 2 (i.e. small or large display space), and its orientation of use/display (i.e. vertical or horizontal mounting).

As indicated in Step C in FIG. 2A, based on the specification of the daily routines and pegboard size and orientation, the system will design a custom-designed magnetic pegboard system having a custom set of magnetic activity tiles selected exclusively for the customer. In the system design specifications, each magnetic activity tile will be assigned a proper activity title (i.e. specified by graphics and text) for printing on the magnetic tile component during its manufacture/construction. Typically, the user will be provided with choices as to font style, color, and other features of the graphical indicia to be custom printed on the activity tile components of the custom system.

As indicated in Step D in FIG. 2A, based on the design specifications for the customer's magnetic pegboard system design, the system will accept the customer's purchase order placed online via the computer system 3 for purchase of a magnetic pegboard system having the provided design specifications.

As indicated in Step E in FIG. 2A, the system fulfills the customer's order for the magnetic pegboard system, by (i) constructing the system according to the customer's magnetic pegboard system design specifications, (ii) packaging the produced components for the system, and then (iii) shipping the assembled product to the customer's shipping address.

At this stage a unique QR code symbol 8 will be automatically generated for the customer's specially-ordered magnetic pegboard activity planning/scheduling system 2 and applied to the magnetic pegboard activity planning/scheduling system (and related product brochures and learning guides), preferably at the factory production and order fulfillment center 9, shown in FIG. 1, where the product is manufactured, assembled, packaged, and shipped to its customer's address. This unique QR code symbol 8 is encoded with the URL of the magnetic peg-board system maintenance web-portal 6 and other information relating to the customer's product order, and is maintained within the system database servers 5A, 5B, 5C at the data centers 5 supporting the product delivery and service platform of the present invention.

As indicated in Step F in FIG. 2A, once the system is received at the customer's shipping address, the customer mounts the magnetic pegboard 2 on a surface and inserts the components (i.e. magnetic divider tiles, day of week tiles etc.) within magnetic pegboard system 2, and then child/children start using the system according to the guidelines and instructions provided with the system 2.

As indicated in Step G in FIG. 2A, after passage of time and use of the Magnetic Pegboard System 2, the child/children grows older, develops new interests and adopts new interests, activities and modified routines, and so the customer returns to and logs into the e-commerce web site portal, and accesses the customer's user account and redesigns/updates the customized/bespoke magnetic pegboard system design, based on the new interests, activities and routines of the child/children.

As indicated in Step H in FIG. 2B, based on the new/updated design for the child's customized magnetic pegboard system design 2, the customer places a new purchase order, on the website portal 6, for new custom magnetic tiles 16 designed for use with the customer's updated customized magnetic pegboard system 2 so that the system will continue to meet and support the growing needs, interests and activities of the child/children and their family.

As indicated in Step I in FIG. 2B, the system fulfills the customer's order for new activity tiles 16 for use with the custom-design magnetic pegboard system 2, by constructing the new magnetic tiles according to the updated system design specifications, the system then packages the newly constructed tile components for the system, and ships the ordered product(s) to the customer's shipping address for integration and use with the magnetic pegboard system 2.

As indicated in Block J in FIG. 2B, the customer uses the new magnetic activity tiles with the customer's magnetic pegboard system 2 and layout tiles, according to the guidelines and instructions provided with the pegboard system. The guidelines and instructions will be made as printed and digital publications, as well as online video tutorials at the website, providing step-by-step instructions and guidance to the parents and caregivers.

During Step C in FIG. 2A, when using the system network of the present invention, Customers will have the option to purchase pre-set tile packs, based on the child's age, that include the activities that are most common to their age group.

During Step C in FIG. 2A, Customers will have the option to upload custom artwork and have customized tiles printed on demand for them. Customers will have the option to request additional activity names using existing activity illustrators and have the tile custom printed for them. Also, Customers will have the option to have their own photographs printed onto tiles to show the activity being demonstrated in their own home or by their own child.

During Step G in FIG. 2B, for a custom magnetic activity peg-board of the present invention designed on the system network of the present invention, activities will be suggested by the system's application/database server based on the date of birth provided for the child by the customer at the start of the system design flow. Also, activities will be dynamically suggested during the design phase based on expert-recommended activities for that age of the child, as well as what activities are most popular among other customers with children of that age. Based on the indicated age of the child, and the original selections of activities purchased, the system network will algorithmically propose future activities based on how much the child has aged since the last purchase of activity tiles, and what activities the child has likely aged into, using expert recommendations as well as patterns among other customers whose children have aged similarly.

Having been provided an overview on the method of designing, producing, ordering, and updating a child's custom magnetic pegboard system 2 according to the principles of the present invention, it is appropriate at this junctive to now describe the magnetic peg-board system 2 and its various embodiments in greater technical detail below

### Specification of the First and Second Illustrative Embodiments of the Magnetic Peg-Board Activity Planning/Scheduling System of the Present Invention

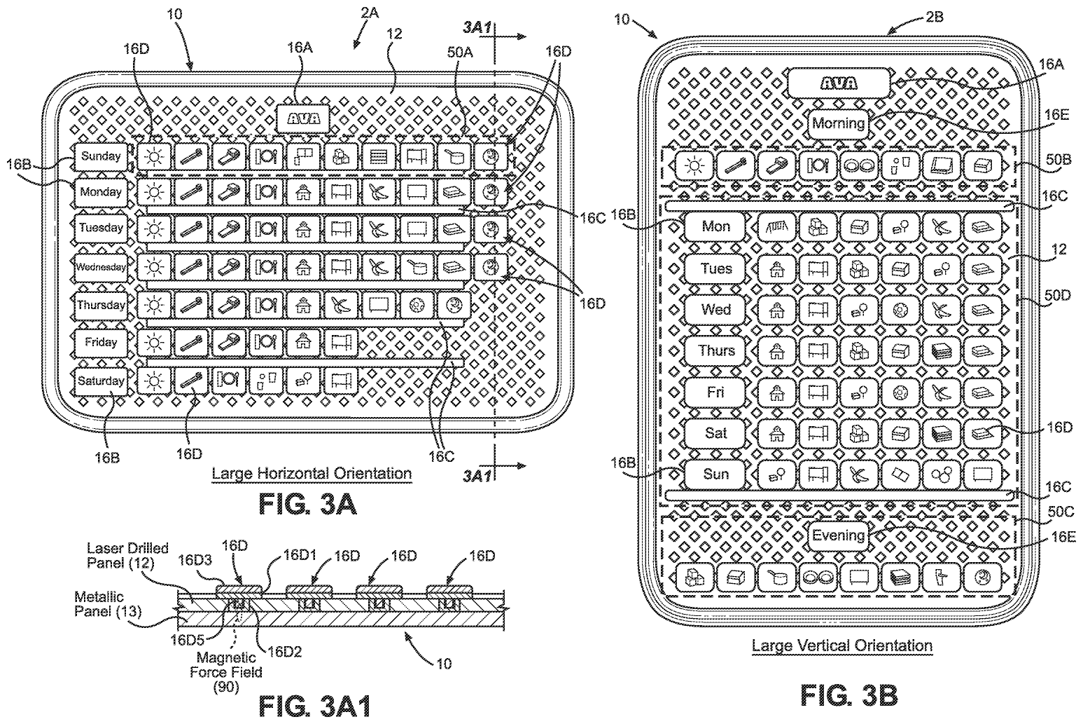

FIG. 3A shows the first (large) illustrative embodiment of the magnetic peg-board activity planning/scheduling system of the present invention 2A′. As shown, the system 2A′ is arranged in its horizontal display orientation, and comprises: a metallic-based pegboard panel 10 of wood-framework construction, to which a set of magnetic peg-based indicating tiles 16 are magnetically and physically coupled to the peg-board 10, including: (i) a Custom Name Indicating Magnetic Peg-Based Tile of the present invention 16A; (ii) 7 Days of Week Indicating Magnetic Peg-Based Tiles 16B (for the seven days of the week namely S-M-T-W-TH-F-S); (iii) Six (6) Magnetic Peg-Based Dividers 16C having 3 or more magnetic peg-structures 18 for mounting to the magnetic peg-board panel 10 for forming Daily Activity Spaces (Tracks) 50A and (iv) a plurality of Specific Activity/Event Indicating Magnetic Peg-Based Activity Tiles 16D mounted between the Magnetic Peg-Based Dividers 16C, within the Daily Activity Tracks 50A.

FIG. 3A1 shows how each peg structure 16D2 and magnet element 16D5 of an activity indicating tile component 16D, passes through a trapezoidal (i.e. diamond shaped) peg aperture formed in the laser drilled panel 12, causing the tile component 16D to be physically attracted to a portion of the metallic panel 13 by a magnetic force field (90) that is locally generated between the magnet element 16D5 and steel panel 13. This magnetic force field 90 functions to releasably hold each mounted tile to the steel panel component 13 of the magnetic peg-board 10. This magnetic peg-board mounting system and method is used in connection with each activity tile component, and layout tile component (including dividers) that are employed in the child activity planning/scheduling system 2 of the present invention.

Notably, by design, the magnetic peg-board activity planning/scheduling system 2 of the present invention seeks to reinforce a sense of calm and confidence in children when using the system and its components during their daily and nightly lives. Specifically, each magnetic peg-based activity-indicating tile component 16D is engineered to allow young children to simply pick up and handle the tile component 16D with ample dexterity to facilitate easy mounting and remounting of the tile component in a particular peg aperture 12A formed in the peg apertured panel 10, at a desired location along an activity routine being constructed while mounting activity tiles 16D. Also, each magnetic peg-based indicating tile component (16A, 16B, 16C, 16D, and 16E) is physically and magnetically mounted through one or more peg apertures 12A formed in the peg apertured panel 10 so as to enable the parent, caregiver and/or child to simply plan and construct child activity routines on the peg-board panel 10 that are always arranged in a uniform and orderly manner, while projecting a sense of order and confidence that structured and orderly routines should naturally bring to the lives of children and their parents.

FIG. 3B shows the second (large) illustrative embodiment of the magnetic peg-board activity planning/scheduling system of the present invention 2B. As shown, the system is arranged in its vertical display orientation, and comprises: a metallic-based peg-board panel construction 10, to which a set of magnetic peg-based indicating tiles 16 are magnetically and physically coupled to the peg-board 10, including: (i) a Custom Name (e.g. AVA) Indicating Magnetic Peg-Based Tile of the present invention 16A; (ii) Two Magnetic Peg-Based Dividers 16C mounted on the peg-board panel construction 10 using several (e.g. 3 or 4) magnetic peg structures 18, and creating Morning Activity and Evening Activity Spaces 50C and 50D on the front surface of the pegboard board panel 10, between which a Daily Routine Planning Space 50D is created; (iii) Morning and Evening Indicating Magnetic Peg-Based Tiles 16E for mounting in Morning and Evening Activity Spaces 50A and 50B created on the peg-board panel 10; (iv) 7 Days of Week Indicating Magnetic Peg-Based Tiles 16B (S-M-T-W-TH-F-S) for mounting in the Daily Routine Planning Space 50D; and (v) a plurality of Specific Activity/Event Indicating Magnetic Peg-Based Activity Tiles 16D mounted between the Magnetic Peg-Based Tiles 16 within the Daily Routine Planning Space 50D.

### Specification of the Third and Fourth Illustrative Embodiments of the Magnetic Peg-Board Activity Planning/Scheduling System of the Present Invention

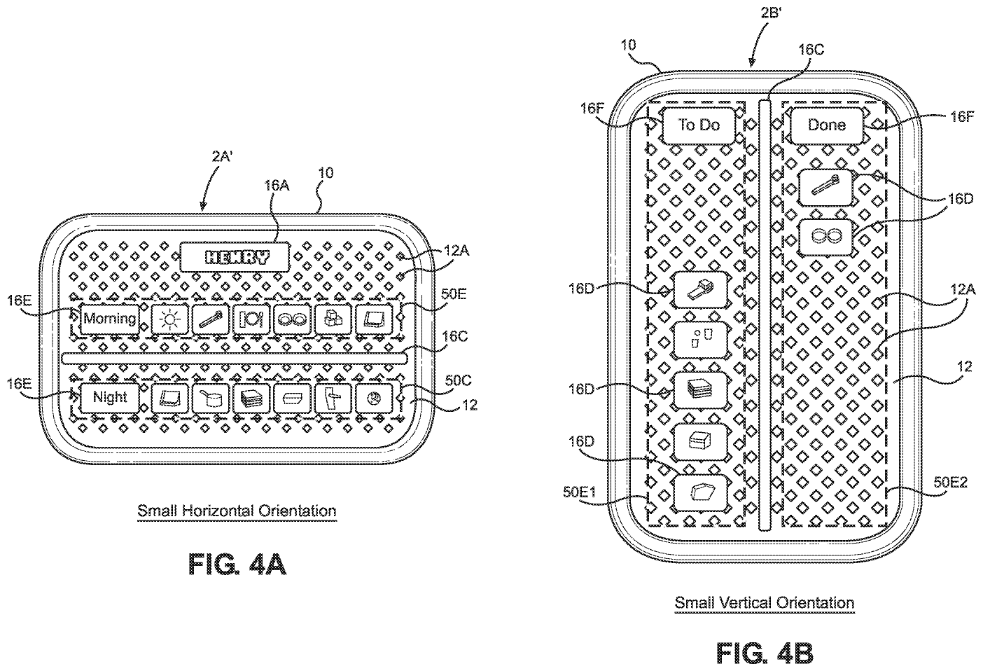

FIG. 4A shows the third (small) illustrative embodiment of the magnetic peg-board activity planning/scheduling system of the present invention 2A′. As shown, the system 2A′ is arranged in its horizontal display orientation, and comprising its metallic-based pegboard panel construction, to which a set of magnetic peg-based indicating tiles 16 are magnetically and physically coupled to the peg-board 10, including (i) a Custom Name (e.g. HENRY) Indicating Magnetic Peg-Based Tile of the present invention 16A, Morning and Evening Indicating Magnetic Peg-Based Indication Tiles 16E, One Magnetic Peg-Based Divider 16C, and a plurality of Specific Activity/Event Indicating Magnetic Peg-Based Activity Tiles 16D.

FIG. 4B shows the fourth (small) illustrative embodiment of the magnetic peg-board activity planning/scheduling system of the present invention 2B′. As shown, the system 2B′ is arranged in its vertical display orientation, and comprising its metallic-based pegboard panel construction 10, to which magnetically coupled a set of Magnetic Peg-Based Indicating Tiles 16 are magnetically and physically coupled to peg-board panel 10, including: (i) a To Do and Done Indicating Magnetic Peg-Based Tiles of the present invention 16F; (ii) One Magnetic Peg-Based Divider 16C mounted on the panel construction to create a To Do Space 50E1 and a Done Space 50E2; and (iii) a plurality of Specific Activity/Event Indicating Magnetic Peg-Based Activity Tiles 16D mounted on the To Do Space 50E1 and Done Space 50E2 sides of the Magnetic Peg-Based Divider 16D.

Specification of the Second Illustrative Embodiment of the Magnetic Peg-Board Activity Planning/Scheduling System of the Present Invention, Shown with Generalized Activity Tile Components for Illustration Purposes

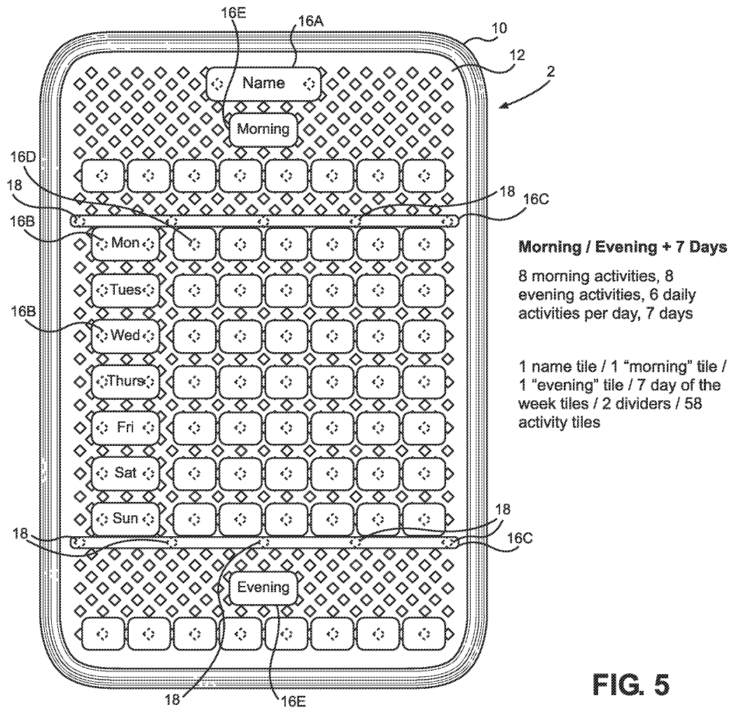

FIG. 5 shows the second (large) illustrative embodiment of the magnetic peg-board activity planning/scheduling system of the present invention 2B, using generalized activity tilt components for purposes of illustration and explication. As shown, the system 2B is arranged in its vertical display orientation, and comprise: a metallic-based pegboard panel construction 10, to which a set of magnetic peg-based indicating tiles 16 are magnetically and peg-board coupled, including: (iv) a Custom Name Indicating Magnetic Peg-Based Tile of the present invention 16A; Morning and Evening Indicating Magnetic Peg-Based Tiles 16E; (ii) Two Magnetic Peg-Based Dividers 16C mounted on the peg-board panel construction 10, and creating Morning Activity and Evening Activity Spaces 50B and 50C on the peg-board board 10, between which a Daily Routine Space 50D is provided; (iii) 7 Days of Week Indicating Magnetic Peg-Based Tiles 16B (S-M-T-W-TH-F-S) mounted in the Daily Activity Routine Space 50D of the activity peg-board panel 10; and (iv) a plurality of Specific Activity/Event Indicating Magnetic Peg-Based Activity Tiles 16D mounted between the Magnetic Peg-Based Divider Tiles 16C within the Daily Activity Routine Space 50D of the system 2B.

### Specification of the Illustrative Embodiments of the Magnetic Peg-Board Panel of the Present Invention Having a Wood-Based Framework Construction

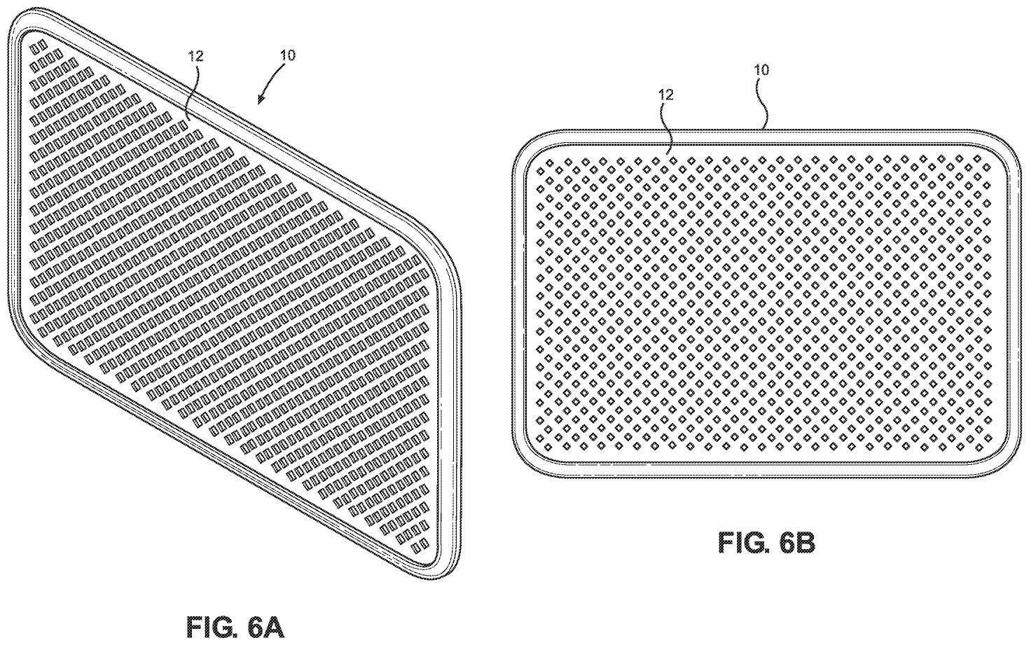

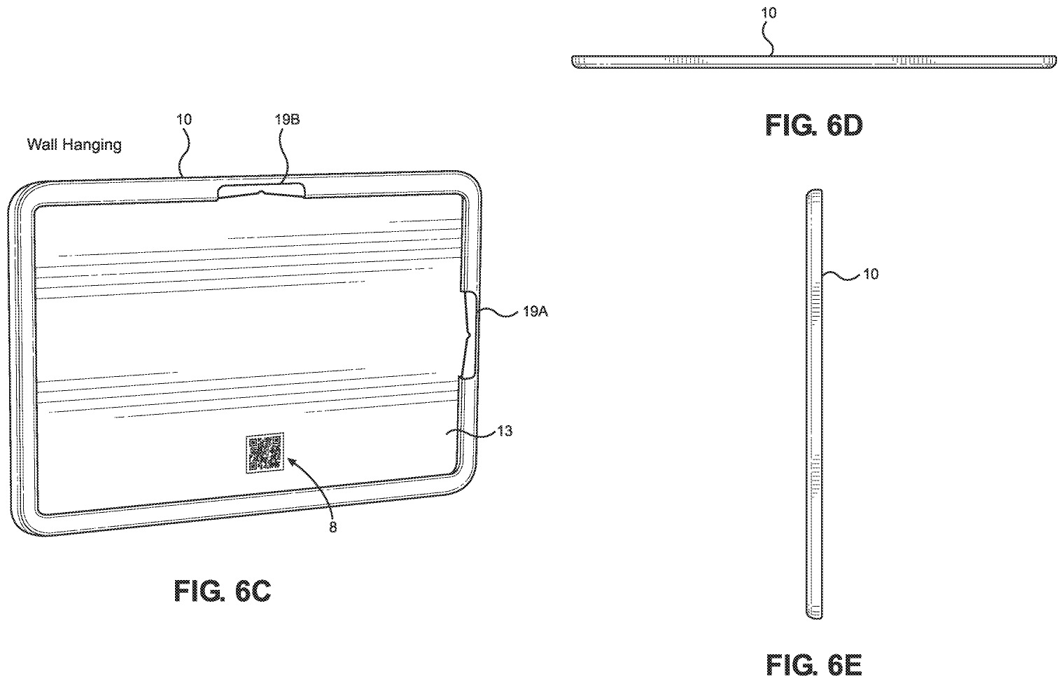

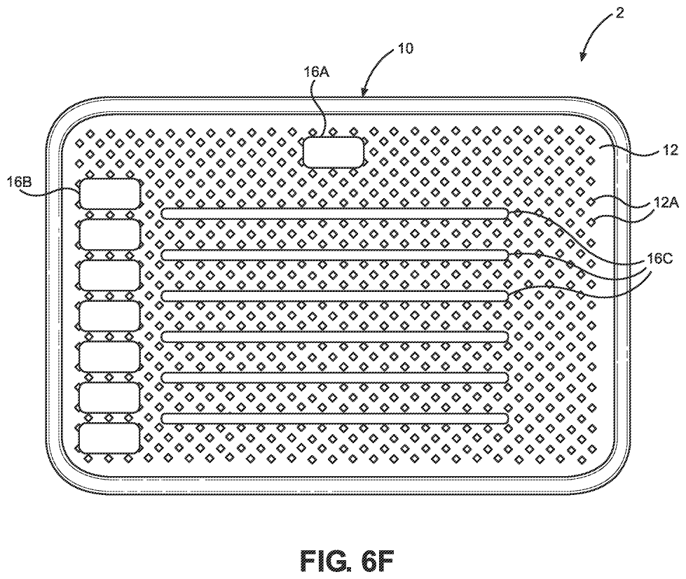

FIG. 6A shows a metallic-based pegboard panel construction 10 employed in the first (large) illustrative embodiment of the magnetic peg-board activity planning/scheduling system 2A, 2B shown in FIGS. 3A and 3B. As shown, this system is arranged in its horizontal display orientation, to which a set of magnetic peg-based indicating tiles 16, constructed in accordance with the present invention, are magnetically and physically coupled to the peg-board panel 10.

FIG. 6B shows the metallic-based pegboard panel construction of FIG. 6A employed in the first (large) illustrative embodiment of the magnetic peg-board activity planning/scheduling system shown in FIGS. 3A and 3B.

FIGS. 6C, 6D and 6E show the metallic-based pegboard panel construction 10 of FIGS. 6A and 6B employed in the first (large) illustrative embodiment of the magnetic peg-board activity planning/scheduling system shown in FIGS. 3A and 3B. As shown, this peg-board panel assembly 10 comprises: a wooden framework 10 within which a metallic panel 13, and laser-cut peg-board panel 12 are mounted, and having tapered top and side hardware wall hangers (e.g. handing brackets) 19A and 19B, as shown.

FIG. 6F shows the metallic-based pegboard panel construction 10 of FIGS. 6A, 6B, 6C, 6D and 6E employed in the first (large) illustrative embodiment of the magnetic peg-board activity planning/scheduling system 2A shown in FIG. 3A. As shown, the system 2A is arranged in its horizontal display orientation, to which a set of magnetic peg-based indicating tiles 16 are magnetically and peg-board coupled. As shown, a set of magnetic peg-based indicating tiles 16 are being set up for use in a child's daily activity planning and scheduling, namely: (i) a Custom Name (i.e. Blank) Indicating Magnetic Peg-Based Tile of the present invention 2A; (ii) Six Magnetic Peg-Based Dividers 16C are mounted below the Child Name Tile and creating seven (7) daily Activity Routine Spaces 50A, one for each day of week; (iii) the 7 Days of Week Indicating Magnetic Peg-Based Tiles (S-M-T-W-TH-F-S) 16B are mounted to the left of its respective Day of Week Routine Space (i.e. Track) 50A as shown, within which a plurality of Specific Activity/Event Indicating Magnetic Peg-Based Activity Tiles 16D mounted within Day of Week Routine Tracks 50A formed between the Magnetic Peg-Based Dividers 16C within the Daily Activity Routine Tracks 50A by the child and/or parent during the use of the magnetic peg-board system of the present invention 2A.

### Specification of the First Illustrative Embodiment of the Magnetic Peg-Board Panel of the Present Invention Characterized by a Wood Construction

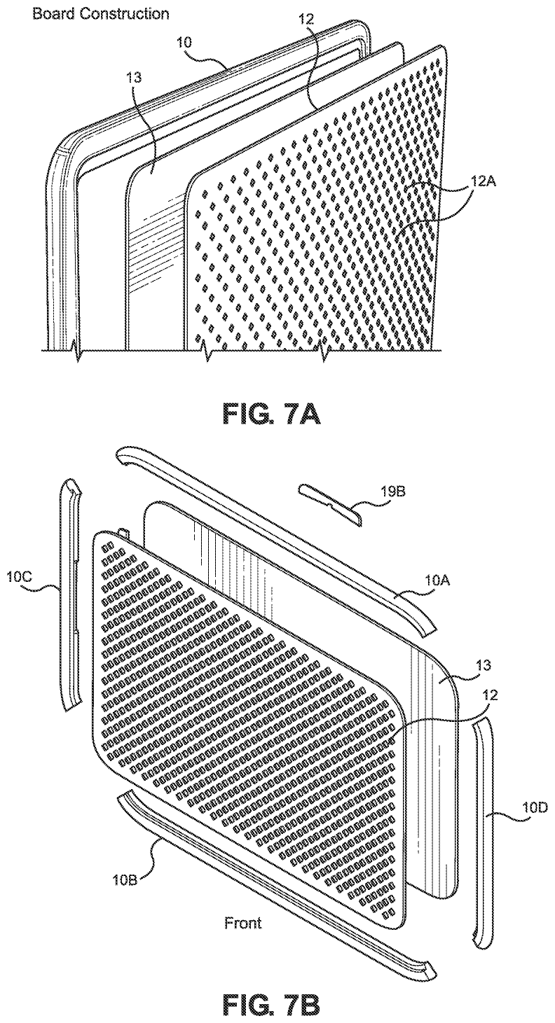

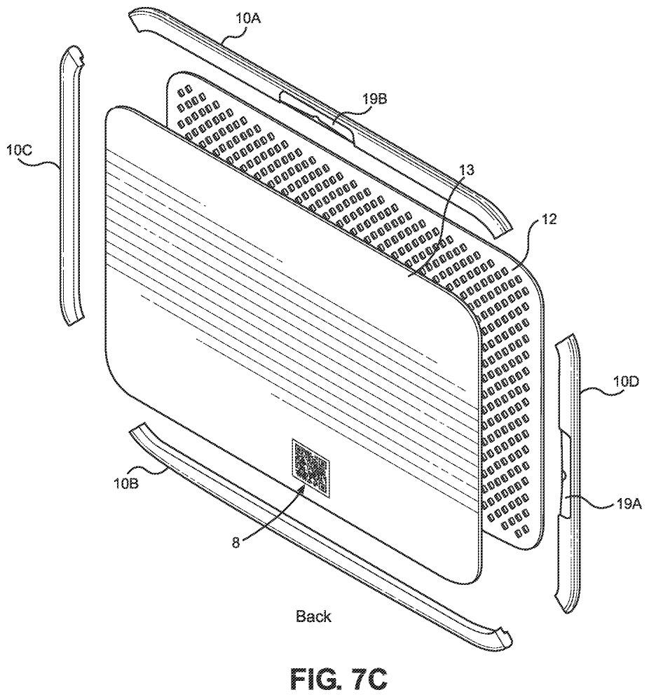

FIG. 7A shows the metallic-based pegboard panel construction 10 employed in the first (large) illustrative embodiment of the magnetic peg-board activity planning/scheduling system 2A and 2B in FIGS. 3A and 3B, respectively. As shown, the first board construction according to the present invention comprises: a wooden framework 10A-10D mounting and holding together (i) a painted (i.e. powder-coated) magnetic-steel sheet 13, and a laser-cut peg apertured panel 12 made of ⅛ acrylic plastic material, wherein a pair of metal hanging plate inserts 19A and 19B are mounted within the rear side of the wood material within the top and rear sides of the wooden framework 10A-10B for vertical and horizontal mounting installations of the peg-board panel 10.

FIGS. 7B and 7C show the metallic-based pegboard panel construction 10 employed in the magnetic peg-board activity planning/scheduling system 2A and 2B shown in FIGS. 3A, 7A and 7B. As shown, the peg-board panel component 10 comprises a wooden framework 10A-10D mounting and holding together a painted (i.e. powder-coated) magnetic-steel sheet 13 and a laser-cut peg apertured panel 12 made of ⅛ acrylic plastic material, and a pair of metal hanging plate inserts 19A and 19B for mounting within the top and rear sides of the wooden framework 10A-10D for vertical and horizontal mounting.

### Specification of the Second Illustrative Embodiment of the Magnetic Peg-Board Panel of the Present Invention Characterized by a Plastic Construction

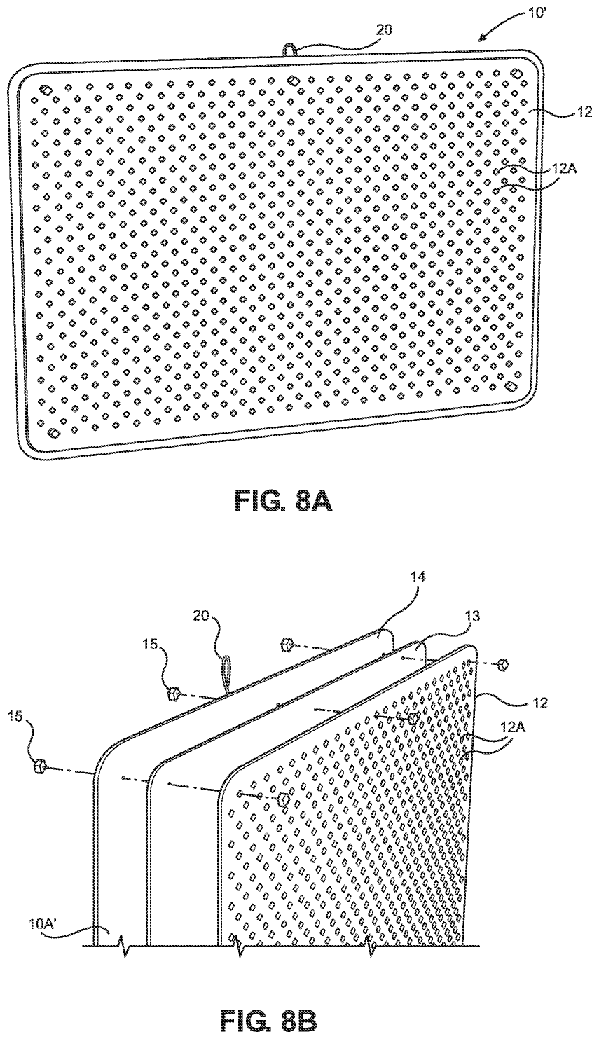

FIGS. 8A and 6B show a metallic-based pegboard panel construction 10′ employed in the second (large) illustrative embodiment of the magnetic peg-board activity planning/scheduling system of the present invention. As shown, the peg-board panel 10′ comprises: a laser-cut opaque acrylic (⅛″) plastic panel 13 mounted to a painted (i.e. powder-coated) magnetic-steel sheet 12, and a laser-cut peg apertured panel 14 made of ⅛ acrylic plastic material, both being assembled using a set of spaced-apart standoff screws 15 fastened though the corners and mid-sections of the peg-board panel construction. As shown, a set of a ribbon hangers 20A and 20B are shown mounted to the top and rear sides of the plastic framework 14 for supporting vertical and horizontal mounting orientations of the peg-board panel 10′.

### Specification of the Third Illustrative Embodiment of the Magnetic Peg-Board Panel of the Present Invention Characterized by a Small Peg-Board Design and Wood-Framework Construction

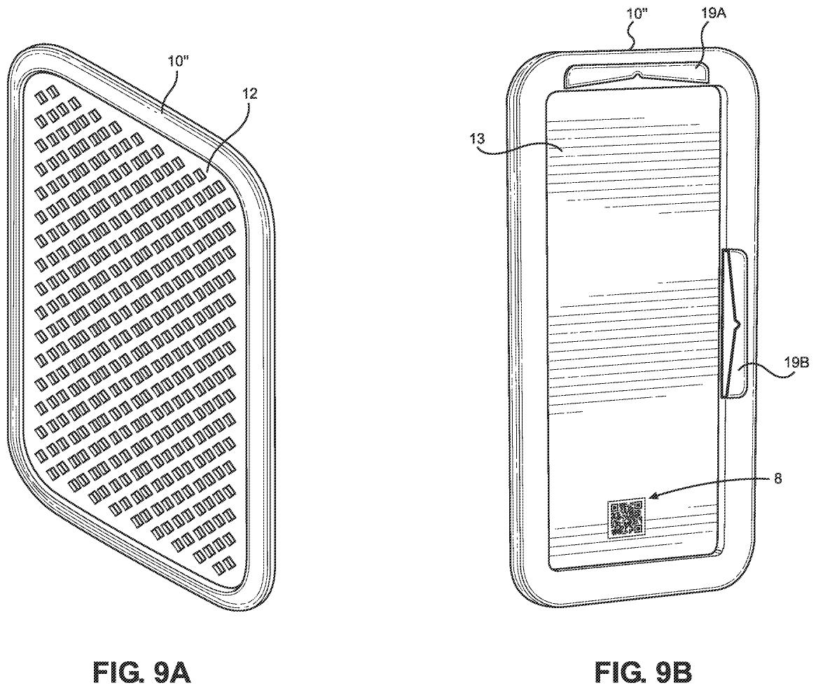

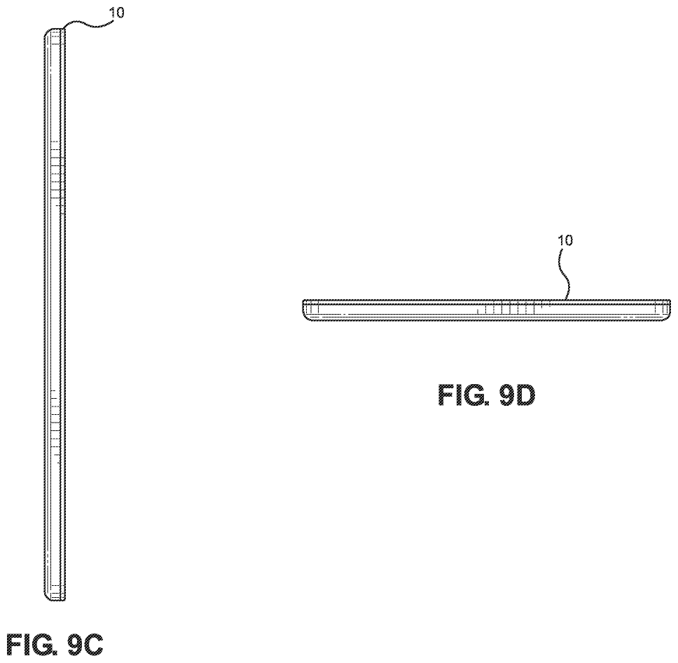

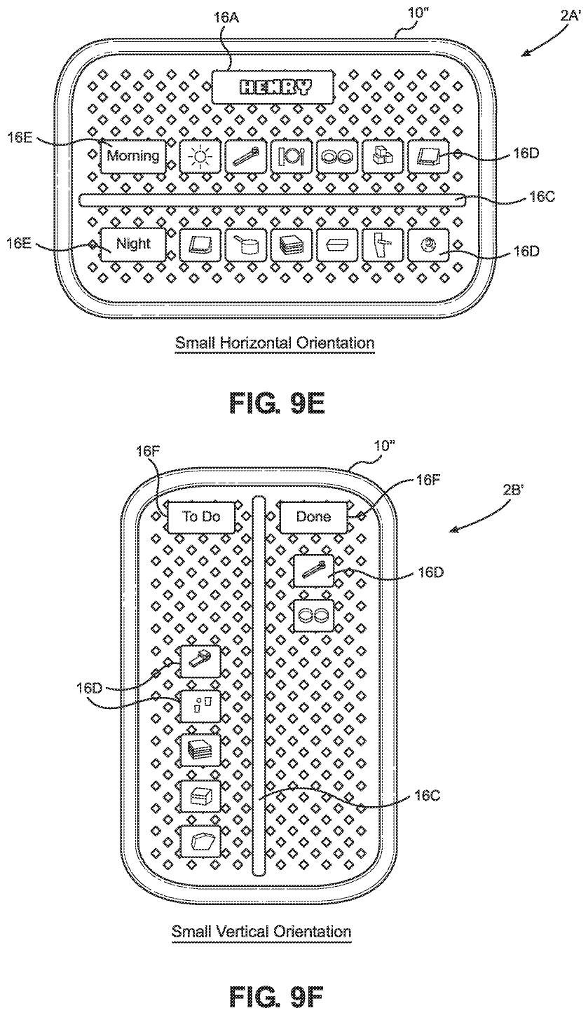

FIG. 9A shows a metallic-based pegboard panel construction 10″ employed in the second (small) illustrative embodiment of the magnetic peg-board activity planning/scheduling system 2A and 2B shown in FIGS. 4A and 4B, and arranged in its vertical display orientation, to which a set of magnetic peg-based indicating tiles 16 are magnetically and peg-board coupled in accordance with the principles of the present invention.

FIGS. 9B, 9C and 9D show the metallic-based pegboard panel construction 10″ of FIG. 9A employed in the second (small) illustrative embodiment of the magnetic peg-board activity planning/scheduling systems 2A and 2B as shown in FIGS. 4A and 4B.

### Specification of a First Method of Using the Magnetic Peg-Board Panel of the Present Invention Characterized by Use of a Small Peg-Board Design

FIG. 9E shows a metallic-based pegboard panel construction 10″ employed in the second (small) illustrative embodiment of the magnetic peg-board activity planning/scheduling system 2A′ shown in FIG. 4A, and arranged in its horizontal display orientation, to which a set of magnetic peg-based indicating tiles 16 are magnetically and physically peg-board coupled. As shown, the a set of magnetic peg-based indicating tiles 16 include: (i) a Custom Name (i.e. HENRY) Indicating Magnetic Peg-Based Tile of the present invention 16A; (ii) One Magnetic Peg-Based (Space) Divider Tile 16C having a multi-peg structure for securely magnetically coupling to the peg-board panel 10″ using extra-strong permanent magnets within the peg-structures 18, and having a flat low-profile structure to prevent children from (re) moving these divider tiles 16C once mounted; (iii) Morning and Evening Indicating Magnetic Indication Tiles 16E mounted to the peg-board 10″ and dividing up its overall indication space into Morning and Evening 50A and 50B; and (iv) a plurality of Specific Activity/Event Indicating Magnetic Peg-Based Activity Tiles 16D for mounting on the Morning and Night sides of the peg-board panel 10″, for use in planning out activity routines and scheduling specific activities for a specific child (or children) in particular orders throughout the Morning and Night Time.

FIG. 9F shows the second (small) illustrative embodiment of the magnetic peg-board activity planning/scheduling system 2B′ shown in FIG. 4A, and arranged in its vertical display orientation. As shown, the peg-board panel 10 comprises: its metallic-based pegboard panel construction 10″, to which a set of magnetic peg-based indicating tiles 16 are magnetically and physically coupled to the peg-board 10″, including (i) a To Do and Done Indicating Magnetic Peg-Based Tiles 16F mounted at the top left and right sides of the peg-board panel 10″ as shown to create a To Do Space 50E1 and a Done Space 50E2 for activity tile placement and mounting during a child's routine; (ii) one elongated Magnetic Peg-Based Divider Tile 16C mounted vertically down the middle of the peg-board panel 10″ to divide and create a To Do Space 50E1 and a Done Space 50E2; and (iii) and a plurality of Specific Activity/Event Indicating Magnetic Peg-Based Activity Tiles 16D mounted on the peg-board panel 10″ in the To Do Space 50E1 and the Done Space 50E2 of the peg-board panel 10″.

Specification of Alternative Methods of Supporting and/or Mounting the Magnetic Peg-Board Activity Planning/Scheduling System of the Present Invention

While the magnetic peg-board panel 10 of the present invention has been shown and described as being mountable on a wall surface in either a horizontal or vertical display orientation, alternatively, it can be propped or otherwise mounted on an easel or other stand structure, stationary or mobile, thereby allowing customers multiple ways to display and access the product during use by them and their children. Using suction cup (or other appropriate) mounting devices installed in the corners, or along the perimeter of the peg-board panel 10, the magnetic peg-board panel 10 of the present invention can also be mounted on closet/room doors, cabinet surfaces, furniture surfaces, home appliance surfaces (e.g. refrigerator door or outer side wall surfaces), as well as window surfaces. Using an appropriately designed stand or spaced apart risers mounted to the rear framework, the magnetic peg-board panel 10 of the present invention can be desktop or countertop supported or mounted.

### Specification of the Magnetic Peg-Board Construction of the Present Invention

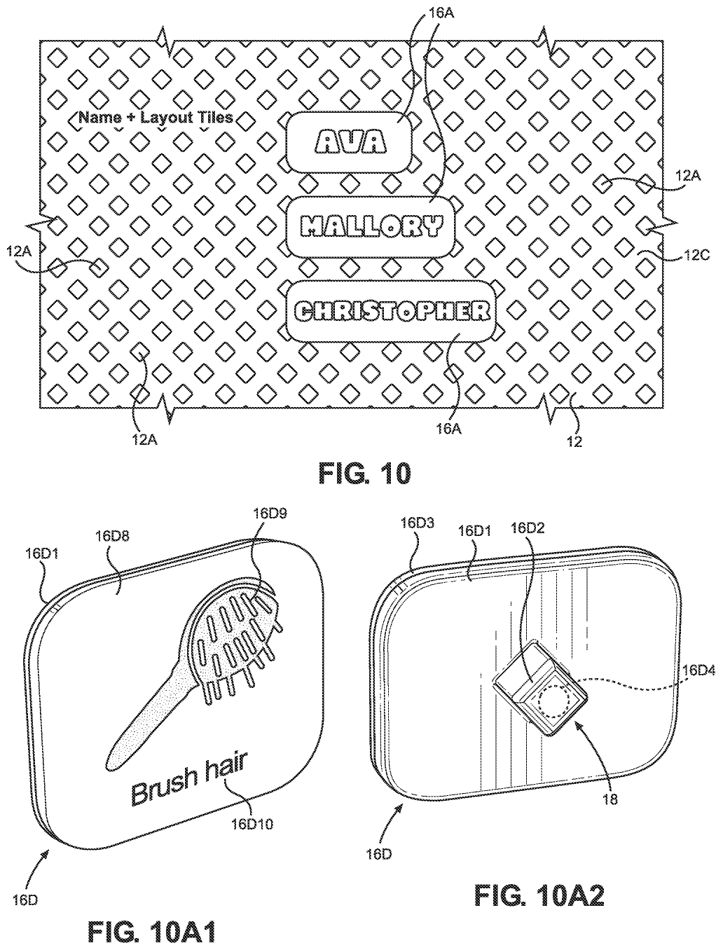

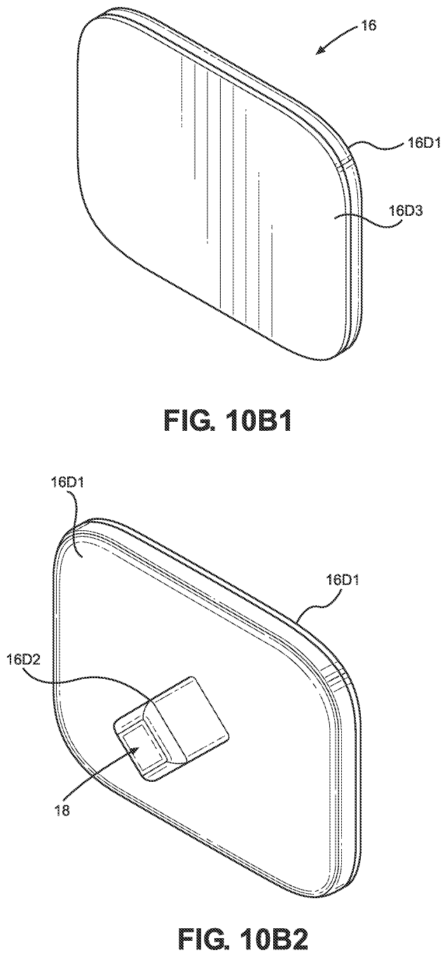

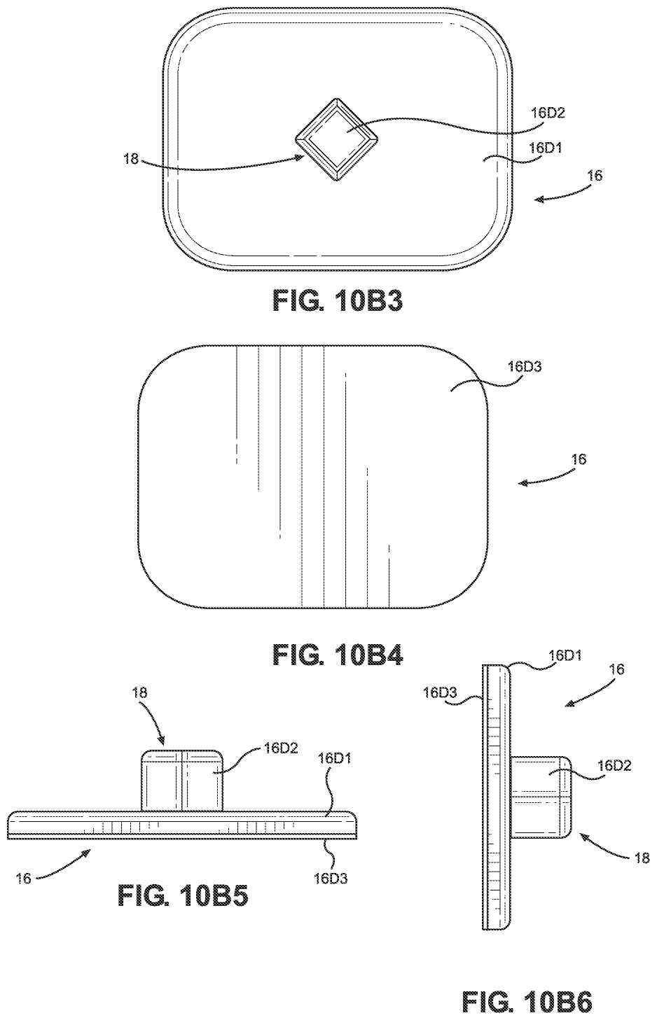

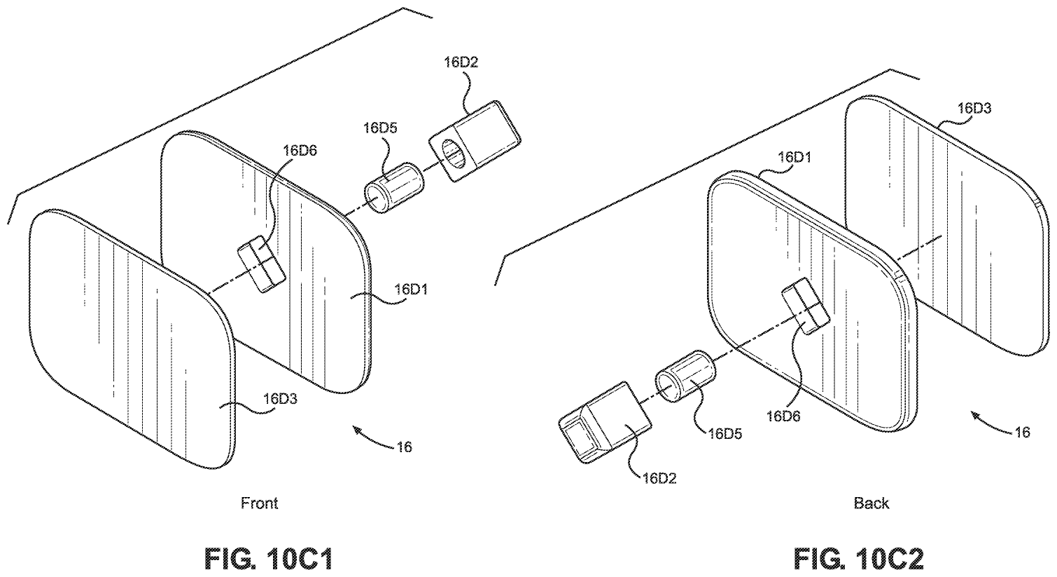

FIG. 10 shows the magnetic peg-based tile mounting surface 12C on the magnetic peg-board activity planning/scheduling system of the present invention 2. As illustrated, the system is capable of mounting multiple (e.g. three) Custom Names (i.e. AVA, MALORY and CHRISTOPJER) Indicating Magnetic Peg-Based Tiles 16A having different sizes and lengths, and each being accommodated and mounted to the peg-based mounting surface 12 using at least two magnetic peg-based structures 18 and the peg-board mounting system and method taught herein. These name titles might be names of brothers and sisters in a single family, or the names of children who are living and learning together in a particular environment.

As illustrated in FIG. 3A through 5, the peg-board panel system 10 can mount different kinds of Layout-Type Magnetic Peg-Based Tiles (e.g. Week Day Indicating Tiles 16B, Space Dividing Tiles 16C, and Morning and Evening Indicating Tiles 16E) having different sizes and lengths, and each being accommodated and mounted to the peg-based mounting surface.

As illustrated in FIG. 3A through 5, the peg-board panel system 10 is also capable of mounting different kinds of Activity-Type Magnetic Peg-Based Tiles 16D (e.g. indicating activities such as Breakfast, Brushing Teeth, Church, etc.) preferably having the same sizes and lengths, and each being accommodated and mounted to the peg-based mounting surface.

In the illustrative embodiments, exemplary names that may be provided to the name indicating surface of Activity Tiles 16D, in the English-speaking language, may include names from the following exemplary list, provided for purposes of illustration only:
Yoga; Haircut; Dad Time; Martial Arts; Grandpa Time; Grandma Time; Grandparents Time; Daycare; Tutor; Play Date; Mom Time; Out to Eat; Speech Therapy; Occupational Therapy; Errands; Family Time; Museum; Free Time; Special Time; Set Table; Clean Bedroom; Puzzle Time; Make Bed; Unload Dishwasher; Put Away Groceries; Pick Apples; Aquarium; Drink Milk; Pack Backpack; Unpack Backpack; Ballet; Baseball; Basketball; Beach; Biking; Boat; Quiet Time; Baking; Clean; Car Ride; Wash Car; Make A Card; Carousel; Chores; Church; Get Dressed; Put Away Clothes; Circus; Dance; Dentist; Clean Dishes; Walk Dog; Fair; Feed Fish; Fishing; Swim; Floss; Put Clothes in Hamper; Football; Leave House; Farmers Market; Put on Glasses; Golf; Grocery Shop; Guitar; Put on Hat; Mom's House; Ice Cream; Ice skate; Put on Jacket; Lake; Library; Homework; Put on Lotion; Pack Lunch; Check Mailbox; Gymnastics; Medicine; Drink Milk; Music Class; Play Music; Cut Nails; Dad's House; Arts and Crafts; Put on Pajamas; Piano; Picnic; Swim; Pick Pumpkins; Rake Leaves; Amusement Park; Bus; Scooter; Put on Shoes; Shop; Shower; Wash Hands; Play in Snow; Doctor; Vacation; Temple; Tennis; Camping; Go to A Show; Train; Trampoline; Vacuum; Violin; Vitamins; Laundry; Drink Water; Buy Gift; Zoo; Chess; Play Outside; Eat Lunch; Eat Dinner; Field Trip; Movie; Snack; Party; Bath; Play; Books; Nap; Change Diaper; Brush Hair; Good Night; Cooking; Go to Park; Feed Pet; Airplane; Water Plants; Eat Breakfast; School; Soccer; Wake Up; Sunscreen; Playground; Potty; Brush Teeth; Clean Up Toys; go For a Walk; TV; Mosque; Camp.

While child around the world will engage in many common activities, by virtue of their humanity, is understood that such activities will typically vary around the world depending on factors such as culture, demographics, religion, climate conditions, economic conditions, and other factors that will be known and/or discovered by those skilled in the art practicing the present invention.

In the preferred embodiment of the present invention, the Activity Tiles 16D are designed to more easily be moved around on the magnetic peg-board 10 by both adults and children (because have a less strong magnet and sit off the board a little bit) while the Layout Tiles 16A, 16C, and 16E utilize a stronger magnet and sit more flatly on the magnetic peg-board to indicate that such tiles will be moved with less frequency on the magnetic peg-board 10. Such desired design and performance characteristics for layout type tiles of the present invention (e.g. 16A, 16C, 16E) is achieved by providing such piece with double and triple strength magnets, and low surface profile features making it difficult for children to (i) pickup and manipulate such tile components, and (ii) remove them from their current locations on the magnetic peg-board 10.

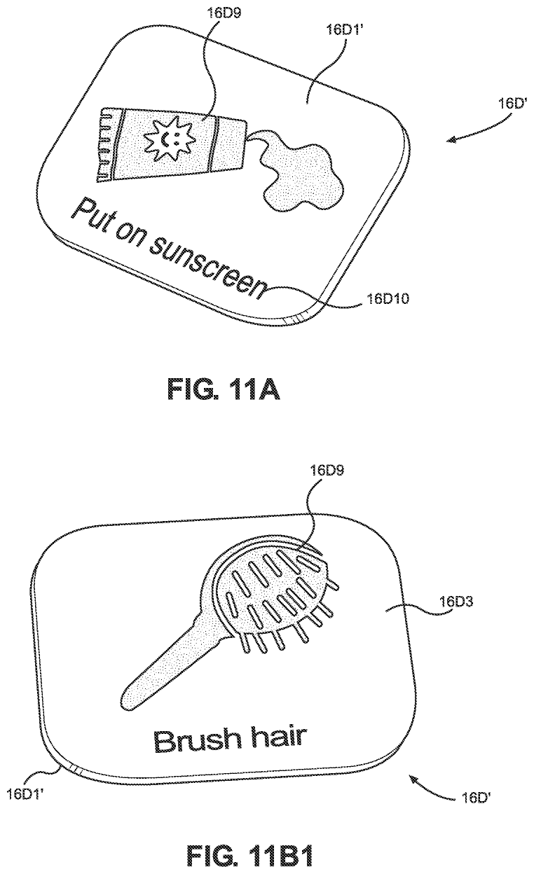

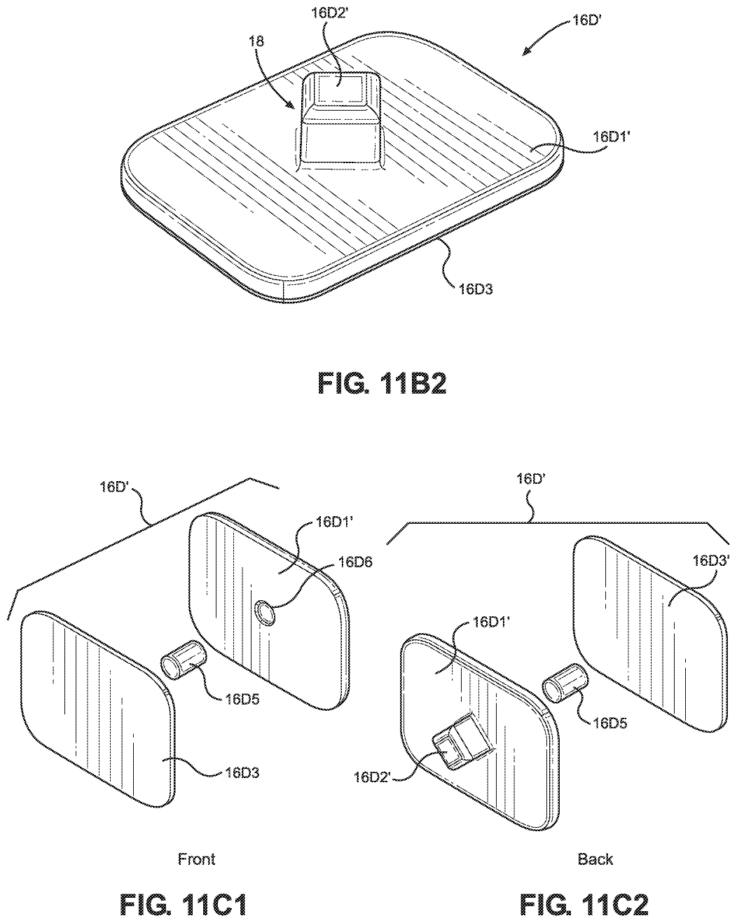

As will be described in FIGS. 11B1, 11B2, 11C1, 11C2, and 12A1-12A6, the magnet tiles of the preferred embodiment will use injection molded plastic to form the base plate 16D1′, with a magnet 16D5 installed in the peg structure 16D2′, and then covered by an over-mold layer of plastic over 16D1 for maximum safety before the wooden front face 16D3′ is affixed. The purpose of over-mold layer of plastic is to provide child safety and protection, wherein, in the event that the wood face panel 16D3 is somehow removed, the magnet 16D5 will remain safely covered and protected by the plastic over-mold layer to ensure that a child cannot access the magnet and accidently ingest it.

### Specification of a First Illustrative Embodiment of the Magnetic Peg-Board Indicating Tile Component of the Present Invention Characterized by One Magnetic Peg-Based Tile Component Having a Wooden Back Plate and Peg Construction

FIG. 10A1 shows a first illustrative embodiment of the magnetic peg-based indicating tile component 16D of the present invention, showing an exemplary indicating graphic (i.e. graphical indicia) 16D9 representative of a “hair brush” with the typographical name 16D10 for its activity indicated as “Brush Hair”.

FIG. 10A2 shows the first illustrative embodiment of the magnetic peg-based indicating tile component 16D shown in FIG. 10A1, showing the magnetic peg structure 18 projecting from the rear back plate 16D1.

FIG. 10B1 shows a second illustrative embodiment of the magnetic peg-based indicating tile component of the present invention 16D employing a single magnetic peg-based structure 18, and providing a blank (e.g. white) front surface 16D3 without bearing any graphics, text or other graphical indications, and free and available for a parent or caregiver to draw a graphic and/or write out a name for an activity on the blank surface, using an erasable, a semi-permanent or permanent ink-based marker, so as to be visually indicate a specific name, activity or other legend on the magnetic peg-based tile of the present invention.

FIGS. 10B2, 10B3, 10B4, 10B5 and 10B6 show the second illustrative embodiment of the magnetic peg-based indicating tile component 16D in FIG. 10B1, showing a magnetic peg structure 18 mounted within the planar wood-based body portion 16D1 of the magnetic peg-based tile 16D. Notably, each magnetic peg-based title component of the present invention has been specially designed to enable a young child to simply and controllably insert the magnetic peg-based indication tile into any intended peg aperture 12A formed in the magnetic peg-board panel of the present invention 10, 10′, and then securely, but releasably held in place by the forces of magnetic attraction existing between (i) the magnetic element 16D5 inside the wooden peg portion 16D2 of the magnetic peg-based indicating tile structure 16D, and (ii) the magnetic steel sheet 13 mounted inside the magnetic peg-board panel assembly 10′.

FIG. 10B4 shows the second illustrative embodiment of the magnetic peg-based indicating tile component 16D shown in FIGS. 10B1, 10B2 and 10B3, with its blank front surface free and available for a parent or caregiver to draw a graphic and/or write out a name for an activity to be visually indicated on the magnetic peg-based tile of the present invention.

FIGS. 10C1 and 10C2 shows the construction and assembly of the magnetic peg-based indicating tiles shown in FIGS. 10A1, 10A2, 10B1, 10B2, 10B3, 10B4, 10B5, and 10B6, comprising: (i) a planar base plate 16D1 provided with an square aperture 16D6; (ii) a planar indication plate 16D3 of the same geometrical dimensions as the base plate 16D1, and mounted to the planar base plate 16D1 with adhesive or other fastening means; (iii) a small cubic structure 16D2 provided with a hollow cylindrical recess 16D2 for mounting a permanent magnetic cylinder 16D5 (e.g. 2 mm×4 mm neodymium magnet cylinders from Apex Magnets of Petersburg, Wyoming) with its magnetic field aligned with the axis of the cubic peg structure 16D2, and having cross sectional dimensions that permit permanent mounting within the square aperture 16D6 of the planar base plate; and (iv) an indication surface 16D3 on the planar indication plate 16D1 for carrying and/or supporting an exemplary graphic representative of an activity or event, along with a typographical name for the activity, as the case may be.

### Specification of a Second Illustrative Embodiment of the Magnetic Peg-Board Indicating Tile Component of the Present Invention Characterized by One Magnetic Peg-Based Tile Component Having an Integrated Plastic Back Plate and Peg Construction

FIG. 11A shows a first illustrative embodiment of the magnetic peg-based “Activity” indicating tile component of the present invention. As shown in FIGS. 11C1 and 11C2, this tile component 16D′ also uses a plastic back plate component 16D1 having an integrated plastic peg structure 16D2 (18) embodying a permanent magnet 16D5 and showing an exemplary graphic 16D9 and typographical name 16D10 for the activity indicated as “Put on Sunscreen”.

FIG. 11B1 shows a second illustrative embodiment of the magnetic peg-based “Activity” indicating tile component of the present invention. As shown in FIGS. 11C1 and 11C2, this tile component 16D′ also uses a plastic back plate component 16D1 having an integrated plastic peg structure 16D2 embodying a permanent magnet 16D, and showing an exemplary graphic 16D9 and typographical name 16D10 for the activity indicated as “Brush Hair”.

FIG. 11B2 shows the plastic back plate component 16D1′ of the first second illustrative embodiments of the magnetic peg-based “Activity” indicating tile component 16D′. As shown, the plastic back plate component 16D1′ has an integrated plastic peg structure 16D2′ (18) embodying a permanent magnet 16D5′, with an exemplary graphic 16D9′ and typographical name 16D10′ for the activity indicated as “Brush Hair”. FIG. 11B3 shows the rear construction of the magnetic peg-based “Activity” indicating tile components of FIGS. 11B1 and 11B2, which is constructed using a plastic back plate component 16D1′ having an integrated plastic peg structure 16D2′ embodying a permanent magnet 16D5′.

FIGS. 11C1 and 11C3 illustrate the construction and assembly of the illustrative embodiment of the magnetic peg-based “Activity” indicating tile component of the present invention 16D′ shown in FIGS. 11B1, 11B2 and 11B3. As shown, this tile component is constructed using a plastic back plate component 16D1′ having an integrated plastic peg structure 16D2′ embodying a permanent magnet 16D5′ within its hollow cylindrical recess 16D6′, and permanently mounted to a planar indication plate 16D3′ having a front surface for carrying and/or supporting graphical indications 16D9′ and/or text description of the activity 19D10′ to be represented by the activity indicating tile component of the present invention.

Specification of a Fourth Illustrative Embodiment of the Magnetic Peg-Board Indicating Tile Component of the Present Invention Characterized by Employing Two (2) Spaced Magnetic Peg-Structures on Tile Components of Regular Length Having Wooden Peg and Back Plate Construction

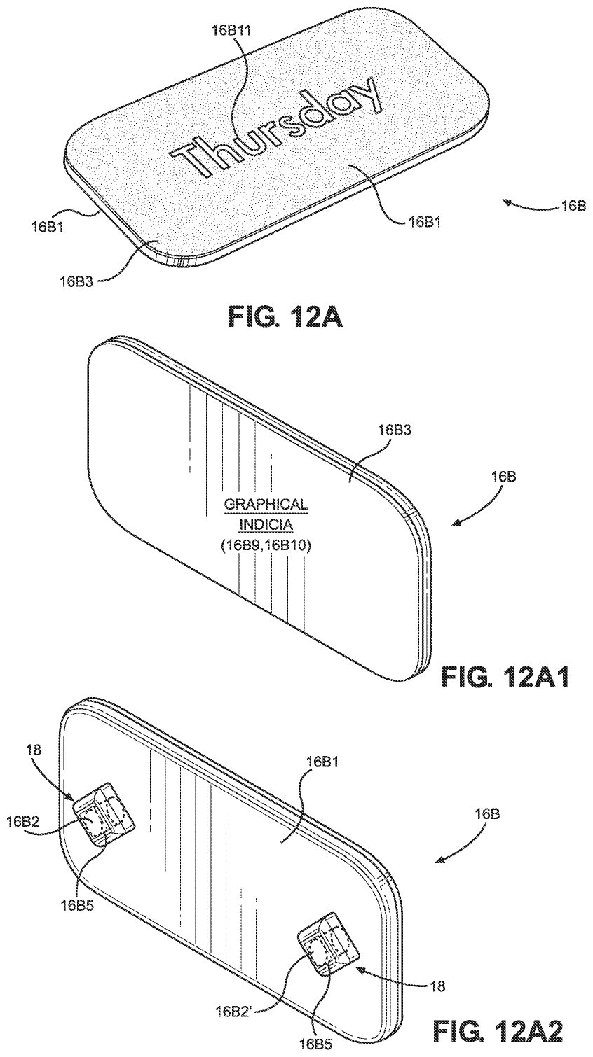

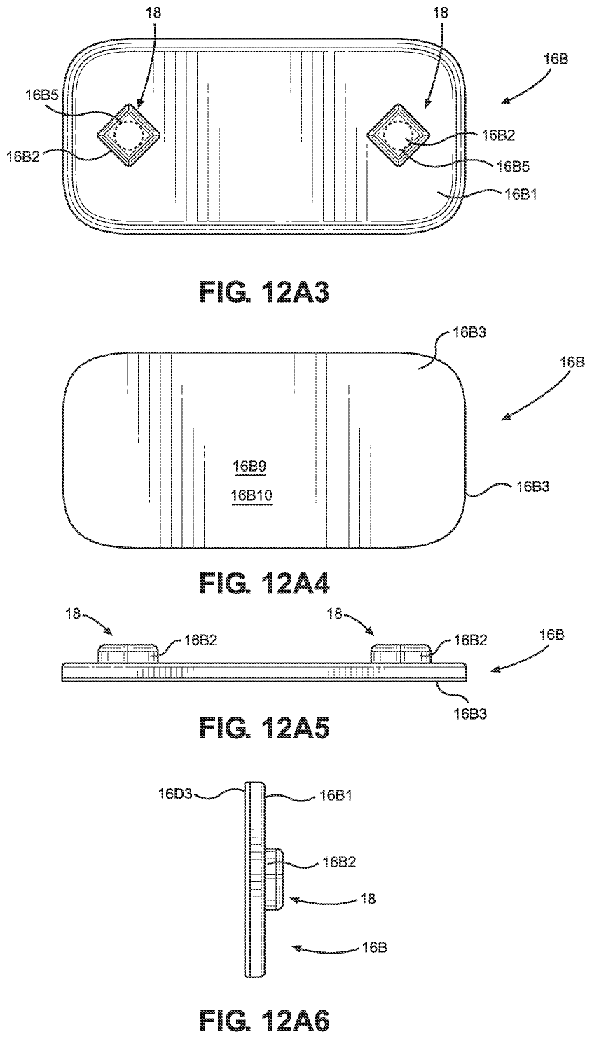

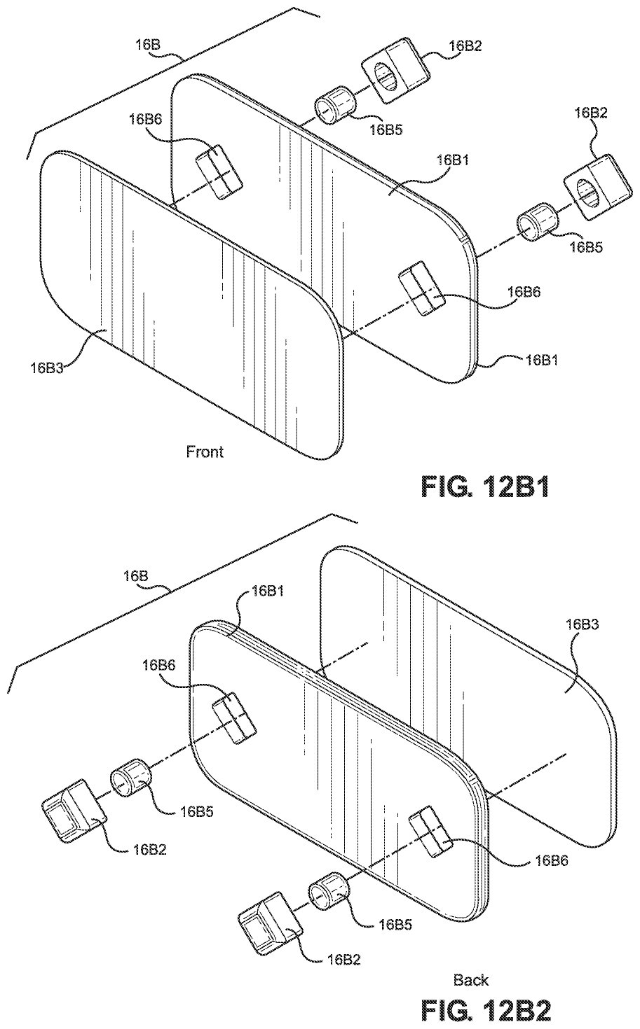

FIG. 12A shows the first illustrative embodiment of the magnetic peg-based “Day of Week” indicating tile component of the present invention 16B. As shown in FIGS. 11C1 and 11C2, this tile component 16B employs a plastic back plate component 16B1 having two (2) integrated plastic peg structures 16B2 (18) with a cylindrical recess 16B5 for installation and embodying of a permanent magnet 16B5 of similar cylindrical geometry, and showing an exemplary graphic 16B9 and typographical name 16B10 for the activity indicated as “Thursday” showing an exemplary typographical name for the time period (e.g. Day) indicated as “Thursday”.

FIGS. 12A1, 12A2, 12A3, 12A4, 12A5 and 12A6 show the fourth illustrative embodiment of the magnetic peg-based indicating tile component of the present invention 16B employing two spaced-apart magnetic peg-based structures 18 for releasable magnetic-force-based mounting the elongated indicating tile component. Also shown, is a blank front surface 16B3 that is free and available for a parent or caregiver to draw a graphic and/or write out a name for an activity to be visually indicated on the magnetic peg-based tile of the present invention 16B3, or for supporting a graphical image 16B9 and/or text description of an activity 16B10 to be represented by the magnetic tile component 16B.

FIGS. 12B1 and 12B2 show the fourth illustrative embodiment of the two magnetic peg-based indicating tile component 16B in FIGS. 12A1 to 12A6, having a wood tile construction comprising: (i) a planar base plate 16B1 provided with an square aperture 16B4; (ii) a planar indication plate 16B1 of the same geometrical dimensions as the base plate 16B1, and mounted to the planar base plate 16B3 with adhesive or other fastening means; (iii) a small cubic structure 16B2 provided with a hollow cylindrical recess 16B4 for mounting a permanent magnetic cylinder 16B5 with its magnetic field aligned with the axis of the cubic structure 16B2, and having cross sectional dimensions that permit permanent mounting within the square aperture of the planar base plate 16B1; and (iv) an indication surface on the planar indication plate 16B3 for carrying and/or supporting an exemplary graphic 16B9 representative of an activity or event 16B10, along with a typographical name for the activity, as the case may be.

Specification of a Fifth Illustrative Embodiment of the Magnetic Peg-Board Indicating Tile Component of the Present Invention Characterized by Two (2) Magnetic Spaced Peg Structures On Tile Component of Elongated Length Having Wooden/Plastic Peg and Back Plate Construction

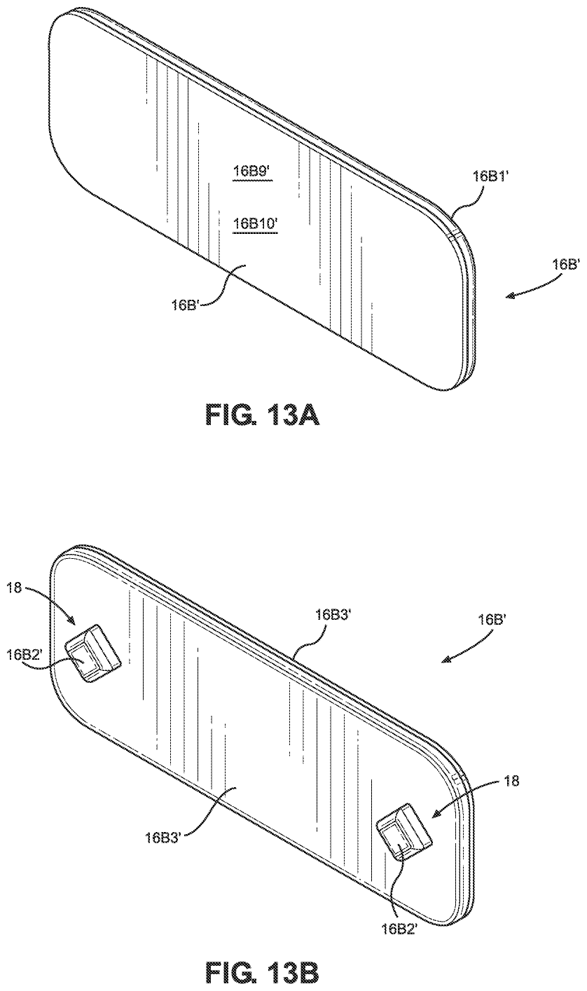

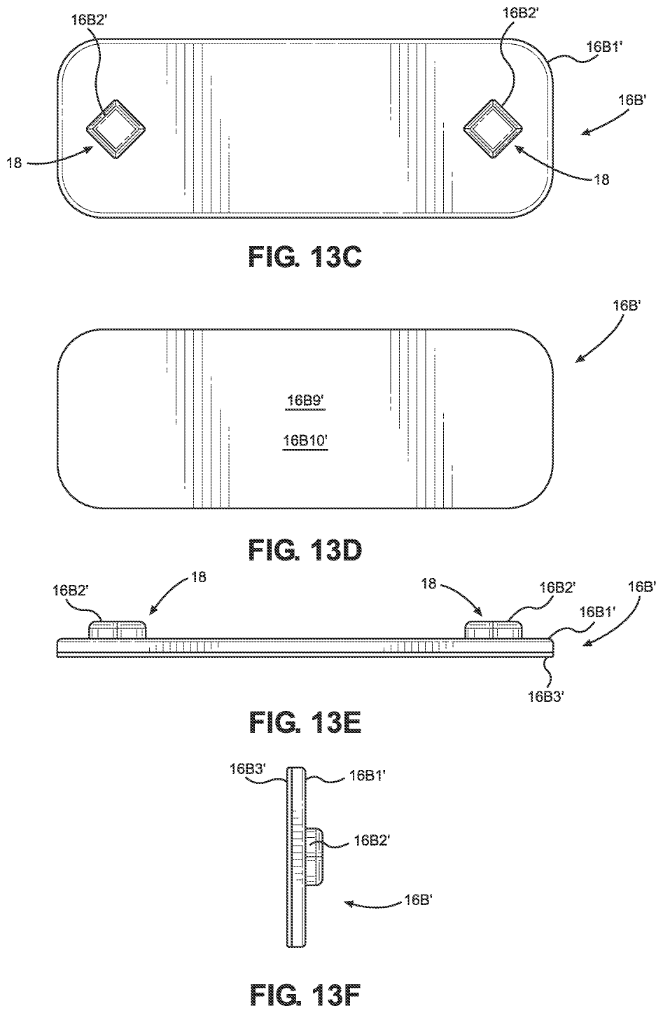

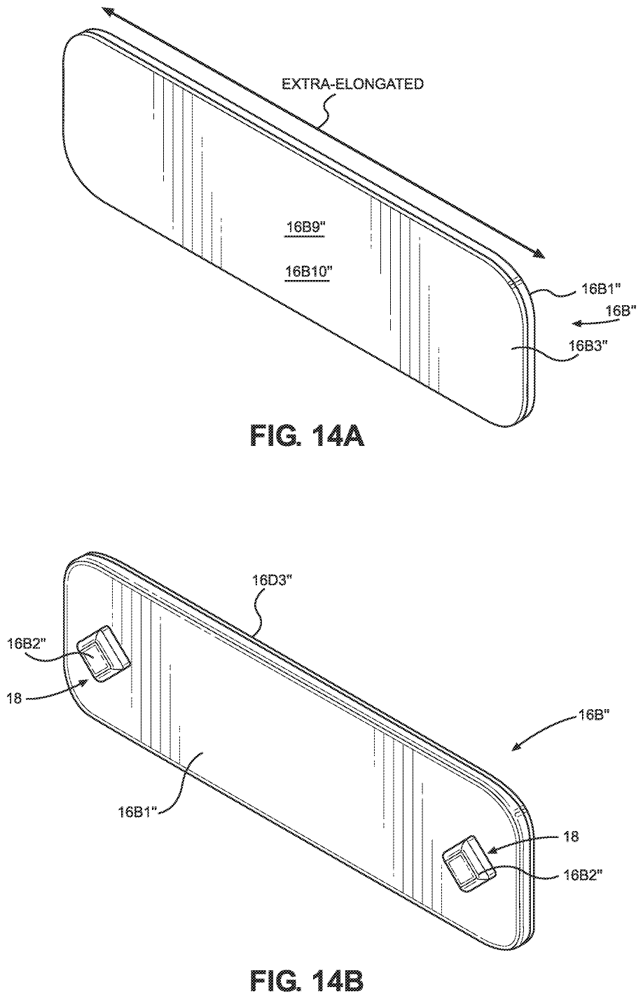

FIGS. 13A, 13B, 13C, 13D, 13E and 13F shows an illustrative embodiment of the magnetic two peg-based indicating tile component of the present invention 16B′ like the Day of the Week Tile design 16B shown in FIGS. 12A1 to 12A6, and 12B1 and 12B2. However, the tile component 16B′ has an elongated length suitable for displaying more graphical indicia 16B9′ and textual indicia 16B10′ as in the case of Child Name Tiles (16A), Morning and Evening Indication Tiles (16E), and/or To Do and Done Indication Tiles (16F). Preferably, the tile component 16B′ comprises: a wood/plastic tile construction using a plastic back plate component 16B1′ having an integrated plastic peg structure 16B2′ (18) embodying a permanent magnet 16B5′ within its hollow cylindrical recess 16B4′; and a planar wood-based indication plate 16B3′ permanently mounted to the front surface of the plastic back plate component 16B1′ for carrying and/or supporting graphical indications 16B9′ and/or text description 16B10′ to be represented by the magnetic peg-based indicating tile component of the present invention 16B′.

Specification of a Sixth Illustrative Embodiment of the Magnetic Peg-Board Indicating Tile Component of the Present Invention Characterized by Two (2) Spaced Magnetic Peg-Based Structures on a Tile Component Having an Integrated Extra-Elongated Wooden/Plastic Back Plate and Peg Construction

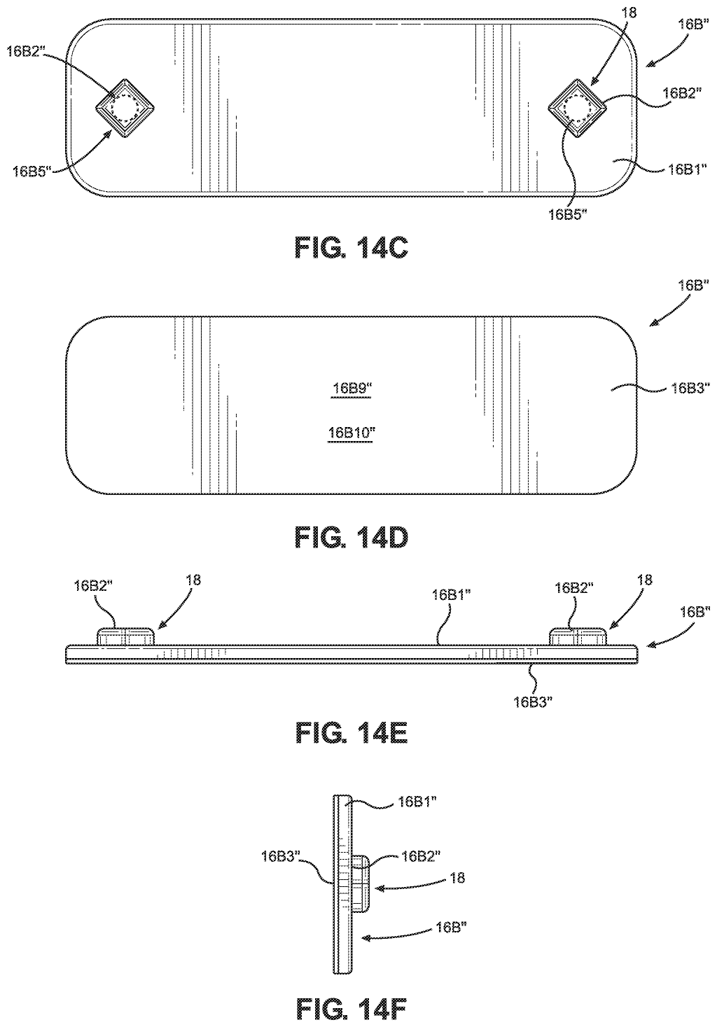

FIGS. 14A, 14B, 14C, 14D, 14E and 14F shows the sixth illustrative embodiment of the magnetic two peg-based indicating tile component 16B″ having an elongated length suitable for displaying more graphical indicia 16B9′ and textual indicia 16B10′ as in the case of Child Name Tiles (16A), Day of the Week Tiles (16B), Morning and Evening Indication Tiles (16E), and/or To Do and Done Indication Tiles (16F). Preferably, this plastic tile construction of the present invention comprises: a plastic back plate component 16B1″ having an integrated plastic two (2) peg structure 16B2″ (18), each embodying a permanent magnet 16B5″ within its hollow cylindrical recess 16B4″, having an over-molded plastic layer to encapsulate the permanent magnet 16B5″; and a planar wooden indication plate 16B3″ being permanently mounted to the front surface of the plastic back plate component 16B1′″ for carrying and/or supporting graphical indications 16B9″ and/or text description 16B10″ to be represented by the magnetic peg-based indicating tile component of the present invention 16B″.

Specification of a Seventh Illustrative Embodiment of the Magnetic Peg-Board Indicating Tile Component of the Present Invention Characterized by Three (3) Spaced Magnetic Peg-Based Structures on a Tile Component Having an Integrated Extra-Elongated Wooden/Plastic Back Plate and Peg Construction

FIGS. 15A, 15B, 15C, 15D, 15E and 15F shows the sixth illustrative embodiment of the magnetic three (3) peg-based indicating tile component 16B′″ having an extra-elongated length for displaying more graphical indicia 16B9′ and textual indicia 16B10′ as in the case of Child Name Tiles (16A), Day of the Week Tiles (16B), Morning and Evening Indication Tiles (16E), and/or To Do and Done Indication Tiles (16F). Preferably, this plastic tile construction of the present invention comprises: a plastic back plate component 16B1′″ having an integrated plastic three (3) peg structure 16B2′″ (18), each embodying a permanent magnet 16B5′″ within its hollow cylindrical recess 16B4″, having an over-molded plastic layer to encapsulate the permanent magnet 16B5′″; and to a planar wooden indication plate 16B3″ being permanently mounted to the front surface of the plastic back plate 16B1′″ for carrying and/or supporting graphical indications 16B9″ and/or text description 16B10′″ to be represented by the magnetic peg-based indicating tile component of the present invention 16B″.

### Specification of an Exemplary Method of Designing, Building, Ordering and Procuring a Child's Magnetic Peg-Board Activity Planning/Scheduling System of the Present Invention Using a Mobile Computing System

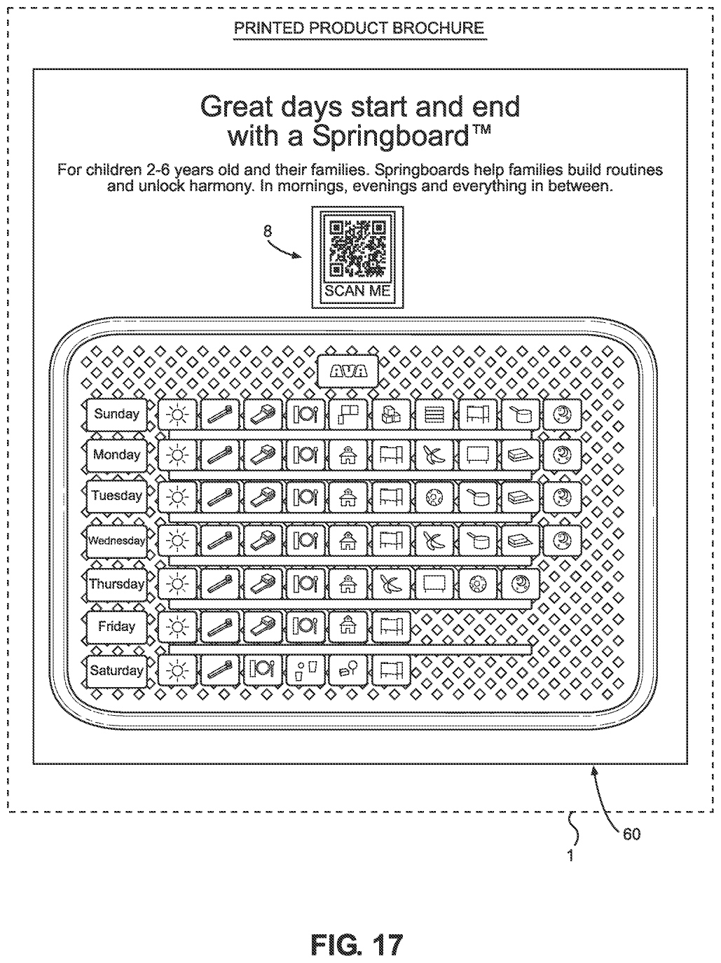

FIG. 17 shows a printed product brochure (e.g. single sheet flyer) 60 illustrating the magnetic peg-board activity scheduling/planning system of the present invention 2, and bearing a machine-readable (e.g. QR) code 8 printed on the brochure 60. In the present invention, the machine-readable code 8 is programmed to direct a web-enabled smartphone or tablet computer 3, when scanning and reading the code 8, to automatically navigate to and display webpages of a website portal 6 operated by the product manufacturer, where the consumer can design, build order and procure a customized magnetic peg-board activity scheduling/planning system 2 for a specific child, or children, as the case may be, for fulfillment and delivery to the customer anywhere around the world. The technical details on linking QR and other machine-readable codes to webpages on websites, and supporting various kinds of transactions is generally disclosed in U.S. Pat. No. 11,631,295, which is incorporated herein by reference in its entirety.

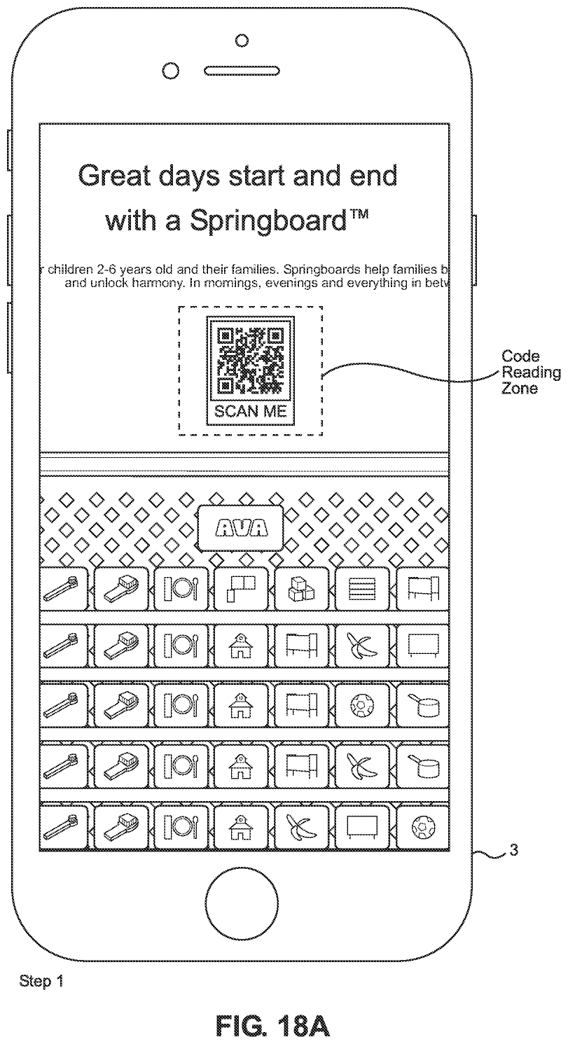

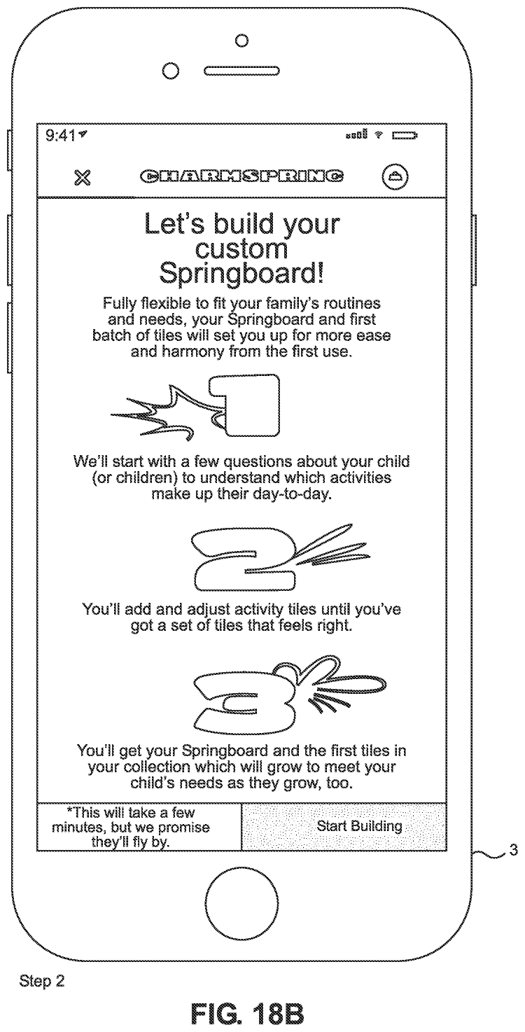

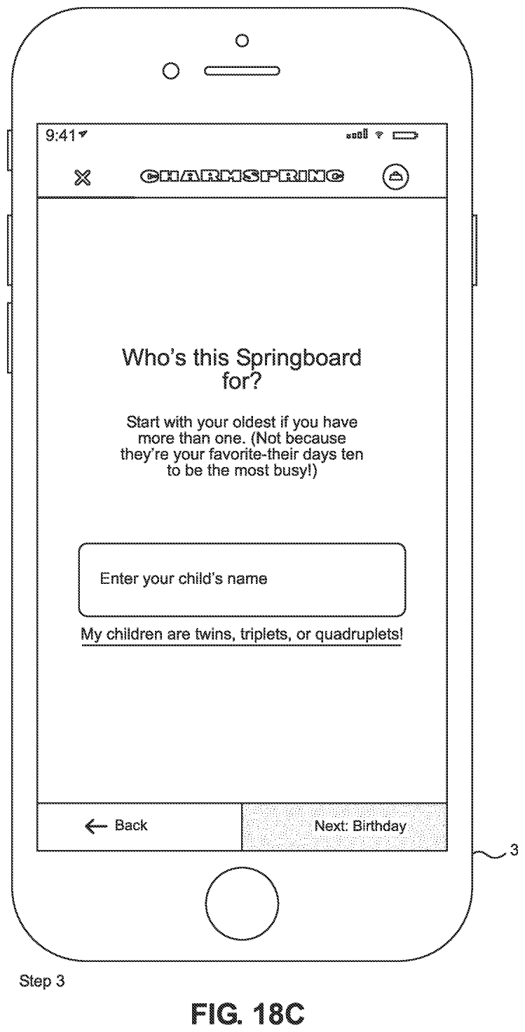

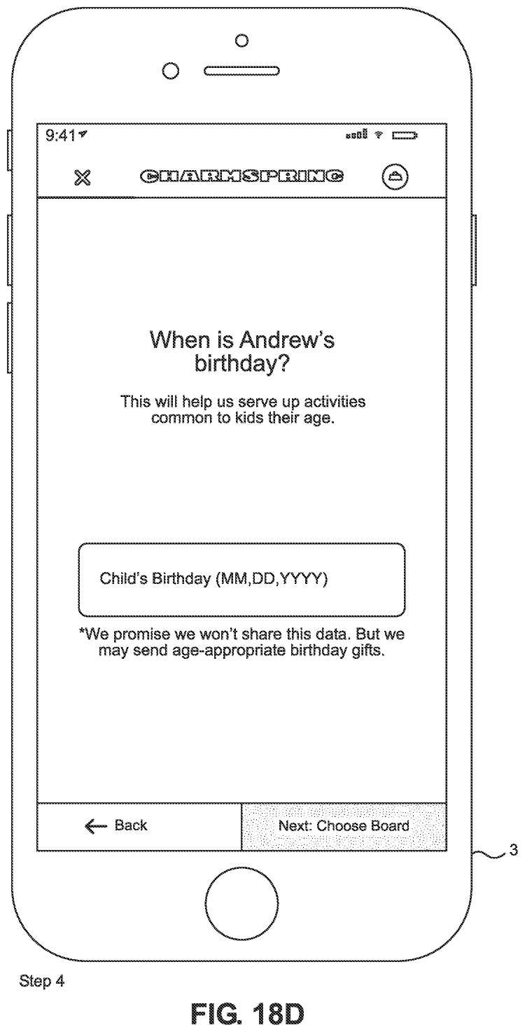

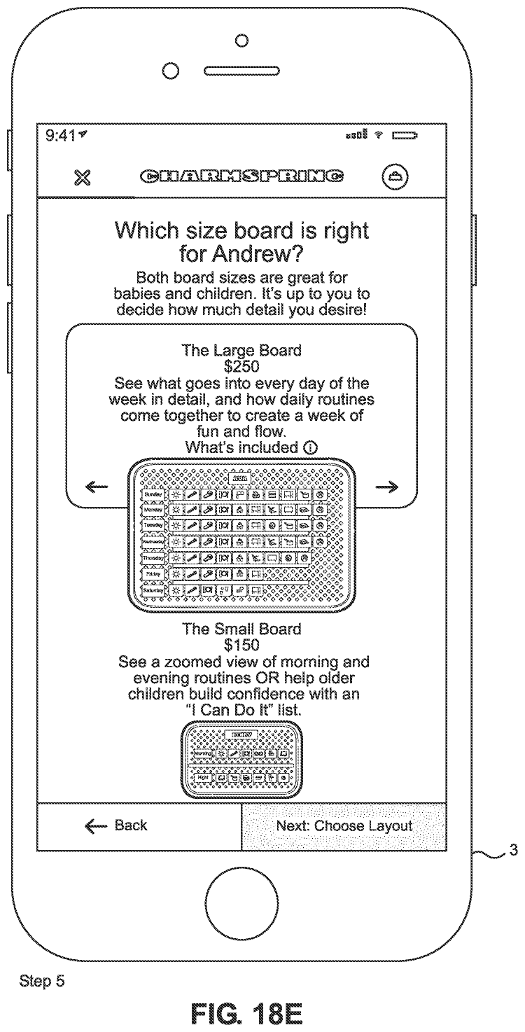

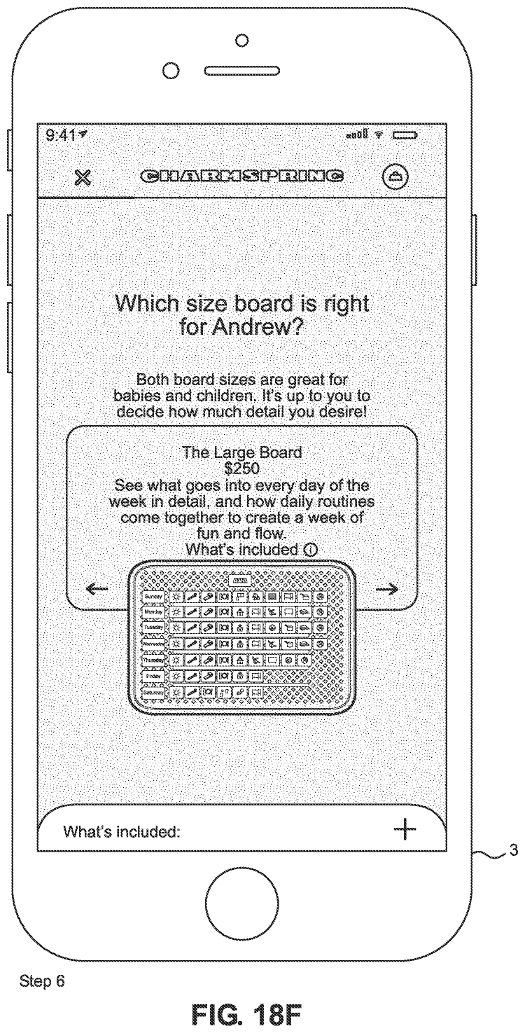

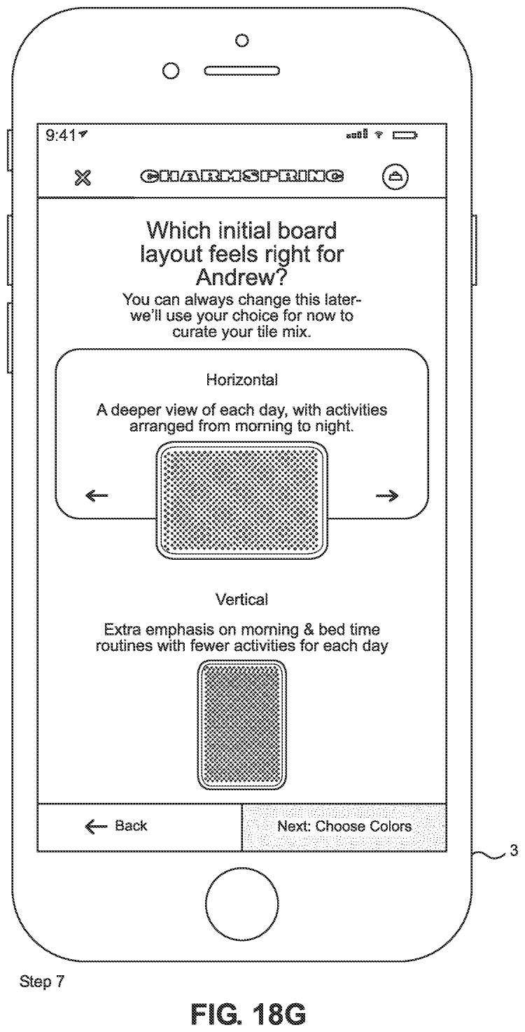

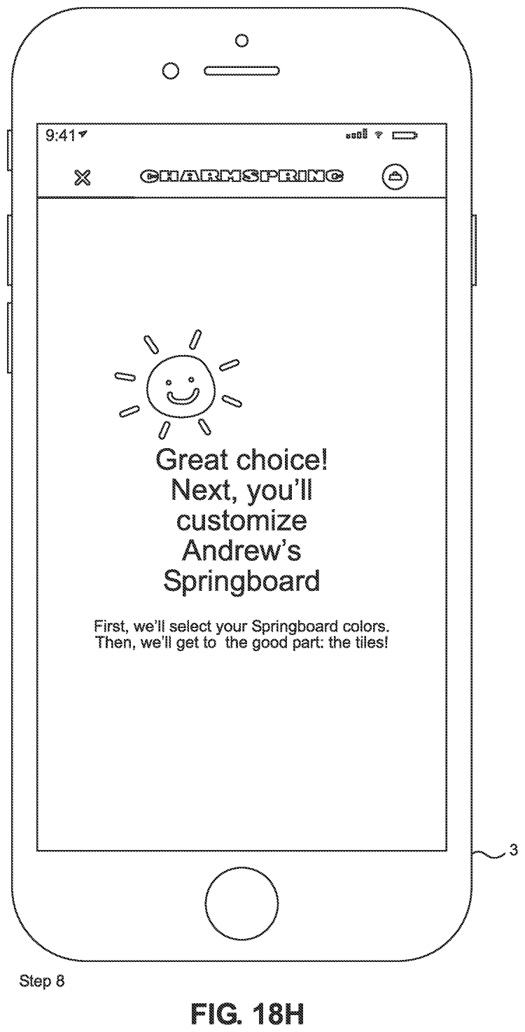

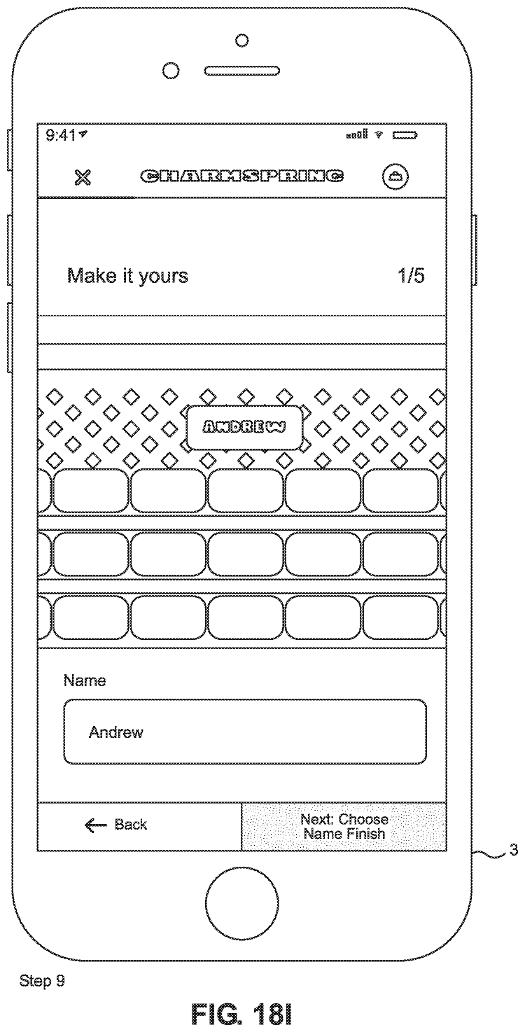

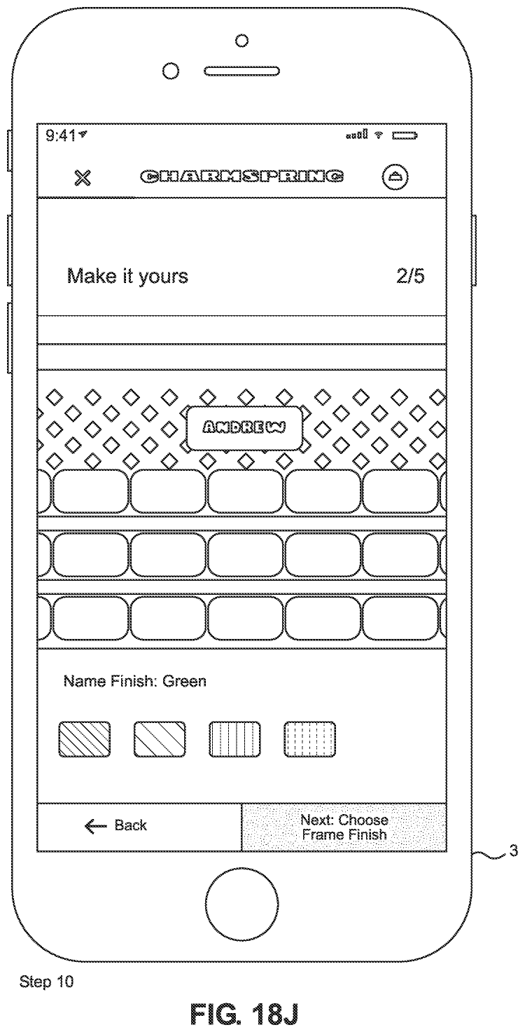

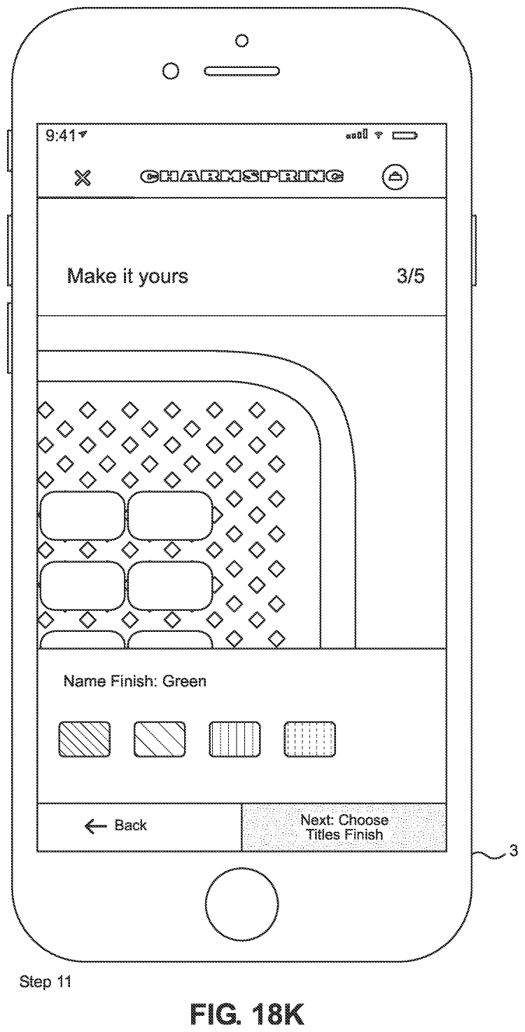

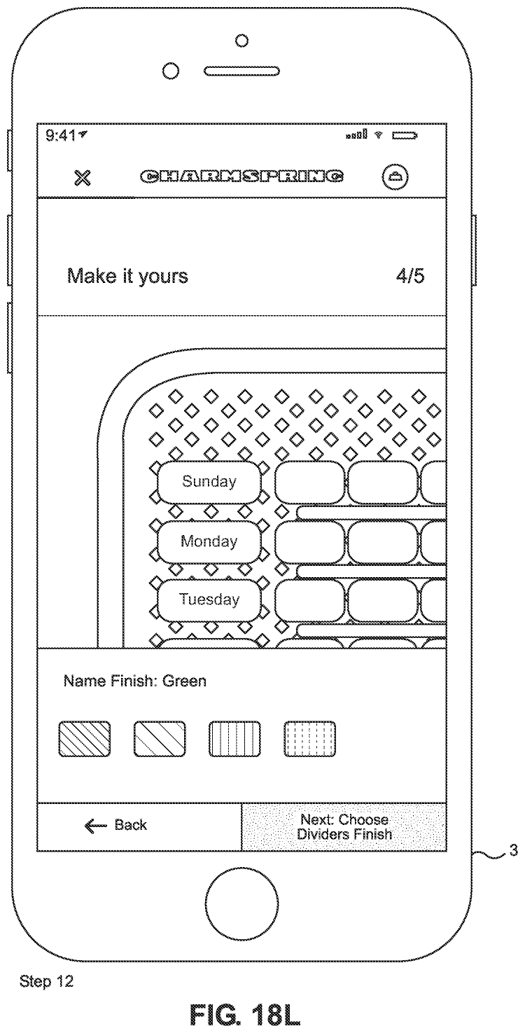

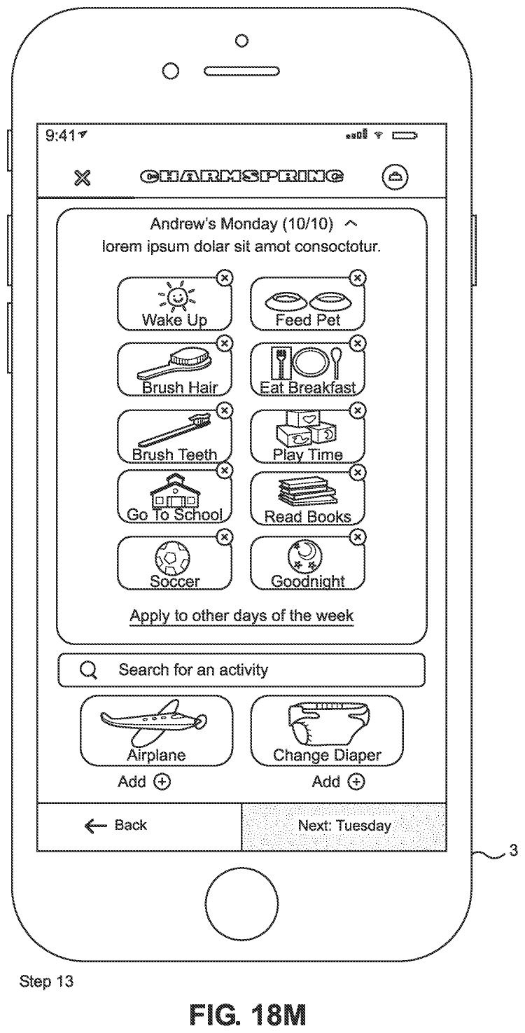

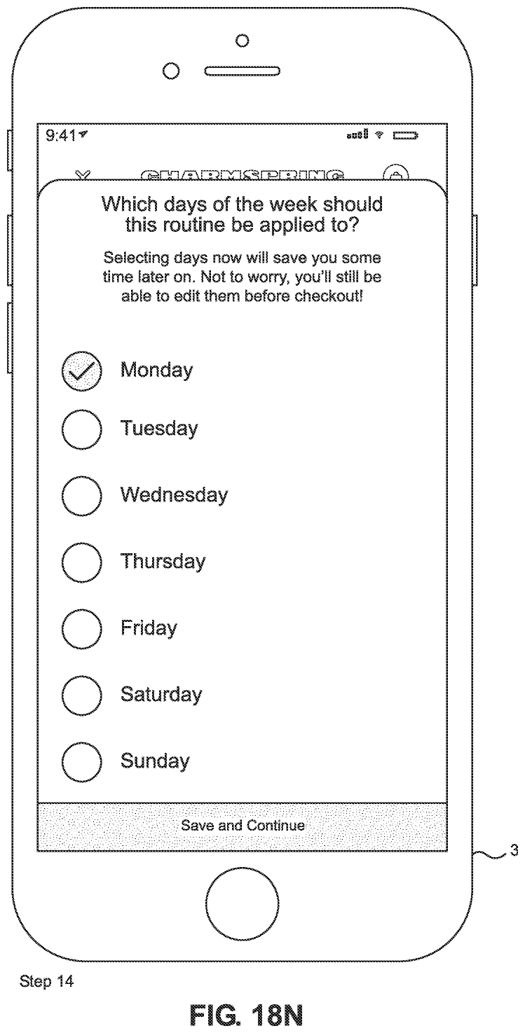

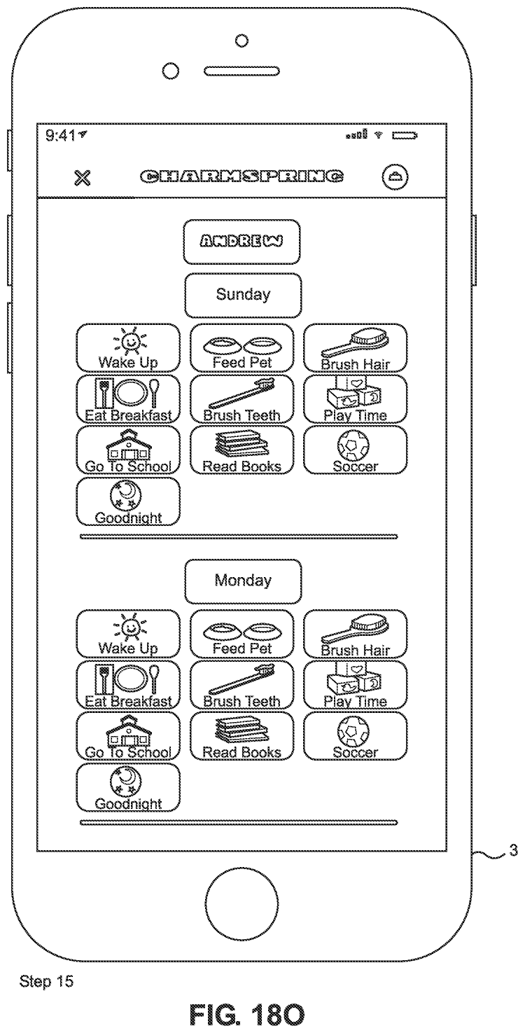

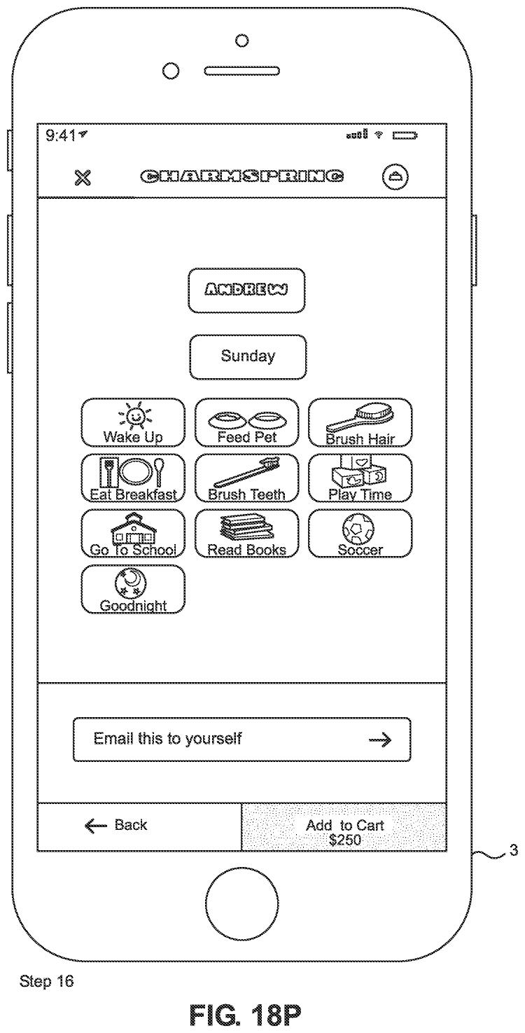

FIG. 18A shows a mobile smartphone computing system 3 operated in its digital camera mode, wherein its digital camera system images and captures a machine-readable code printed on the product brochure of FIG. 17. As shown, its web-enabled browser application supports and enables the first step of the mobile phone method of designing, building, and ordering custom magnetic peg-board child activity planning/scheduling systems of the present invention, involving the automated reading of the machine-readable code, and navigating to the webpage(s) of the website portal operated by the product manufacturer and/or its partner(s).

FIG. 18B shows a graphical user interface (GUI) supported by the web browser of the mobile smartphone computing system of FIG. 18A, displaying the webpage at the manufacturer's website portal, and enabling the second step of the mobile phone method of designing, building, and ordering custom magnetic peg-board child activity planning/scheduling systems of the present invention supported by the website portal and related order fulfillment infrastructure. As shown, this step involves providing a brief overview on the primary steps of the method of the present invention.

FIG. 18C shows a graphical user interface (GUI) supported by the web browser of the mobile smartphone computing system of FIG. 18A, displaying the webpage at the manufacturer's website portal, and enabling the third step of the mobile phone method of designing, building and ordering custom magnetic peg-board child activity planning/scheduling systems of the present invention, involving the identification of the child for whom the system is being custom design, built and deployed over the system network of the present invention.

FIG. 18D shows a graphical user interface (GUI) supported by the web browser of the mobile smartphone computing system of FIG. 18A, displaying the webpage at the manufacturer's website portal, and enabling the fourth step of the mobile phone method of designing, building, and ordering custom magnetic peg-board child activity planning/scheduling systems of the present invention. As shown, this step involves identifying the date of birth of each child for whom the custom magnetic peg-board child activity planning/scheduling system will be used.

FIG. 18E shows a graphical user interface (GUI) supported by the web browser of the mobile smartphone computing system of FIG. 17A, displaying the webpage at the manufacturer's website portal, and enabling the fifth step of the mobile phone method of designing, building, and ordering custom magnetic peg-board child activity planning/scheduling systems of the present invention. As shown, this step involves specification of the size of the custom magnetic peg-board child activity planning/scheduling system, and disclosure of the purchase price thereof.

FIG. 18F a graphical user interface (GUI) supported by the web browser of the mobile smartphone computing system of FIG. 18A, displaying the webpage at the manufacturer's website portal, and enabling the sixth step of the mobile phone method of designing, building, and ordering custom magnetic peg-board child activity planning/scheduling systems of the present invention. As shown, this step involves specification of what components are included in the selected size and model of the product.

FIG. 18G shows a graphical user interface (GUI) supported by the web browser of the mobile smartphone computing system of FIG. 18A, displaying the webpage at the manufacturer's website portal, and enabling the seventh step of the mobile phone method of designing, building, and ordering custom magnetic peg-board child activity planning/scheduling systems of the present invention. As shown, this step involves specification and selection of the peg-board layout for the selected size, which will influence how a child's activity tiles can be arranged in a routine.

FIG. 18H shows a graphical user interface (GUI) supported by the web browser of the mobile smartphone computing system of FIG. 18A, displaying the webpage at the manufacturer's website portal, and enabling the eighth step of the mobile phone method of designing, building, and ordering custom magnetic peg-board child activity planning/scheduling systems of the present invention. As shown, this step involves providing an overview description on the specification and selection of colors for the magnetic peg-board panel and its tile components.

FIG. 18I shows a graphical user interface (GUI) supported by the web browser of the mobile smartphone computing system of FIG. 18A, displaying the webpage at the manufacturer's website portal, and enabling the ninth step of the mobile phone method of designing, building, and ordering custom magnetic peg-board child activity planning/scheduling systems of the present invention. As shown, this step involves the specification of the child's name to be printed on the name indicating tile for use with the custom magnetic peg-board panel of the system;

FIG. 18J shows a graphical user interface (GUI) supported by the web browser of the mobile smartphone computing system of FIG. 18A, displaying the webpage at the manufacturer's website portal, and enabling the tenth step of the mobile phone method of designing, building, and ordering custom magnetic peg-board child activity planning/scheduling systems of the present invention. As shown, this step involves specification and selection of name tile finish for the name indicating tile to be used in building the framework of the custom magnetic peg-board panel of the system.

FIG. 18K shows a graphical user interface (GUI) supported by the web browser of the mobile smartphone computing system of FIG. 18A, displaying the webpage at the manufacturer's website portal, and enabling the eleventh step of the mobile phone method of designing, building, and ordering custom magnetic peg-board child activity planning/scheduling systems of the present invention. As shown, this step involves the specification and selection of the “frame” finish to be used in building the framework portion of the custom magnetic peg-board panel of the system.

FIG. 18L shows a graphical user interface (GUI) supported by the web browser of the mobile smartphone computing system of FIG. 18A, displaying the webpage at the manufacturer's website portal, and enabling the twelfth step of the mobile phone method of designing, building, and ordering custom magnetic peg-board child activity planning/scheduling systems of the present invention. As shown, this step involves the specification and selection of the “layout and activity” tile finishes to be used in building the layout and activity tile components for the custom magnetic peg-board panel of the system, and then the specification and selection of the “divider” tile finish to be used in building the divider tile components for the custom magnetic peg-board panel of the system.

FIG. 18M shows a graphical user interface (GUI) supported by the web browser of the mobile smartphone computing system of FIG. 18A, shown displaying the webpage at the manufacturer's website portal, and enabling the thirteenth step of the mobile phone method of designing, building, and ordering custom magnetic peg-board child activity planning/scheduling systems of the present invention. As shown, this step involves selecting the activity tiles for the daily routines of the child each day of the week (e.g. M-T-W-TH-FR-SAT-SUN).

FIG. 18N shows a graphical user interface (GUI) supported by the web browser of the mobile smartphone computing system of FIG. 18A, displaying the webpage at the manufacturer's website portal, and enabling the fourteenth step of the mobile phone method of designing, building, and ordering custom magnetic peg-board child activity planning/scheduling systems of the present invention. As shown, this step involves specification of which days of the week should each routine of activities should be applied.

FIG. 18O shows a graphical user interface (GUI) supported by the web browser of the mobile smartphone computing system of FIG. 18A, displaying the webpage at the manufacturer's website portal, and enabling the fifteenth step of the mobile phone method of designing, building and ordering custom magnetic peg-board child activity planning/scheduling systems of the present invention, and displaying the current design of the child's routine of activities for each day of the week, and edit as deemed necessary until the final checkout stage reflected in FIG. 18P.

FIG. 18P shows a graphical user interface (GUI) supported by the web browser of the mobile smartphone computing system of FIG. 18A, displaying the webpage at the manufacturer's website portal, and enabling the sixteenth step of the mobile phone method of designing, building, and ordering custom magnetic peg-board child activity planning/scheduling systems of the present invention. As shown, this step involves confirmation of the final design of the child's activity planning/scheduling routine, and layout(s), and completing the purchase of the custom magnetic peg-board child activity planning/scheduling system.

### Specification of an Exemplary Method of Designing, Building, Ordering and Procuring a Child's Magnetic Peg-Board Activity Planning/Scheduling System of the Present Invention Using a Desktop/Tablet Computing System

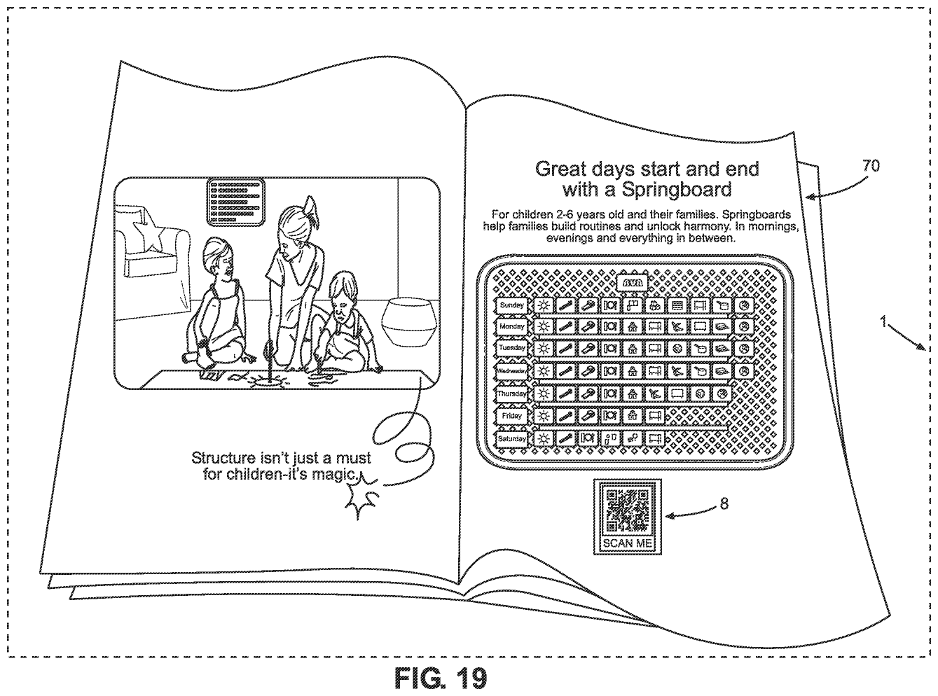

FIG. 19 shows a printed magazine 70 containing a two-page product advertisement illustrating the magnetic peg-board activity scheduling/planning system of the present invention, and bearing a machine-readable (e.g. QR) code 8 printed on the magazine page. As shown, the machine-readable code 8 is programmed to direct a web-enabled smartphone or tablet computer 3, when scanning and reading the code, to automatically navigate to and display webpages of a website portal 6 operated by the product manufacturer, where the consumer can design, build, order and procure a customized magnetic peg-board activity scheduling/planning system 2 for a specific child, or children, as the case may be, for fulfillment and delivery to the customer anywhere around the world. The technical details on linking QR and other machine-readable codes to webpages on websites, and supporting various kinds of transactions is generally disclosed in U.S. Pat. No. 11,631,295, incorporated herein by reference in its entirety.

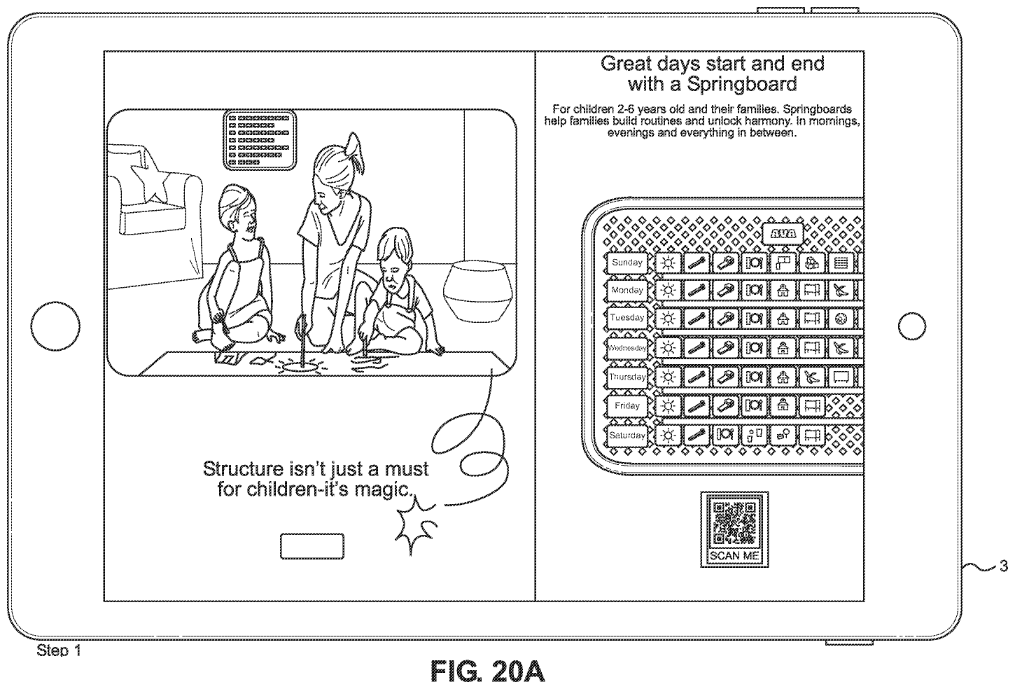

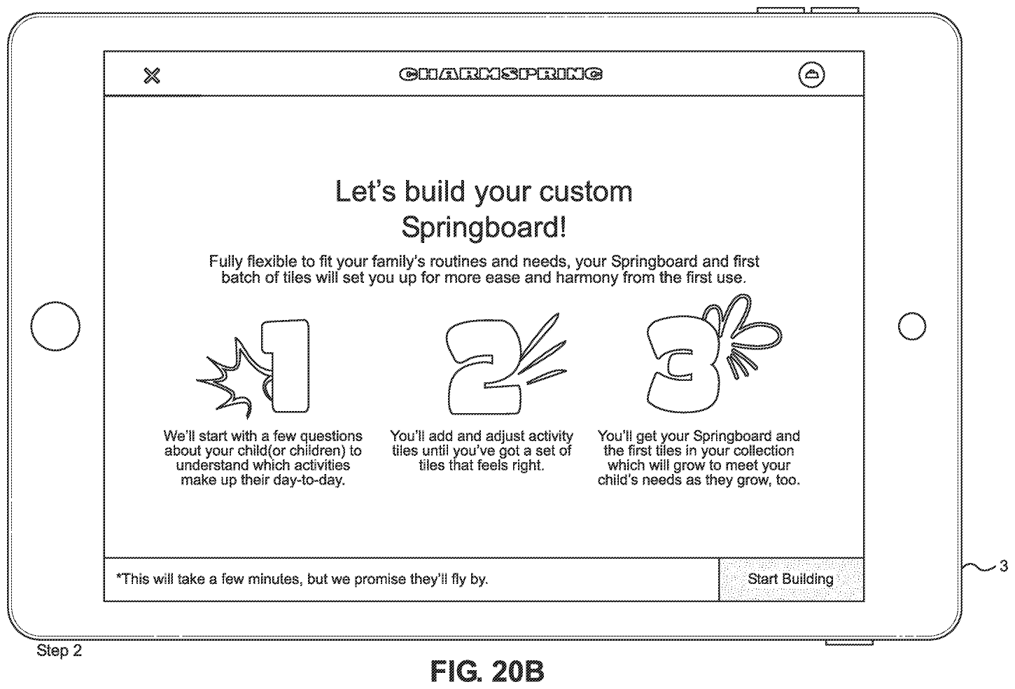

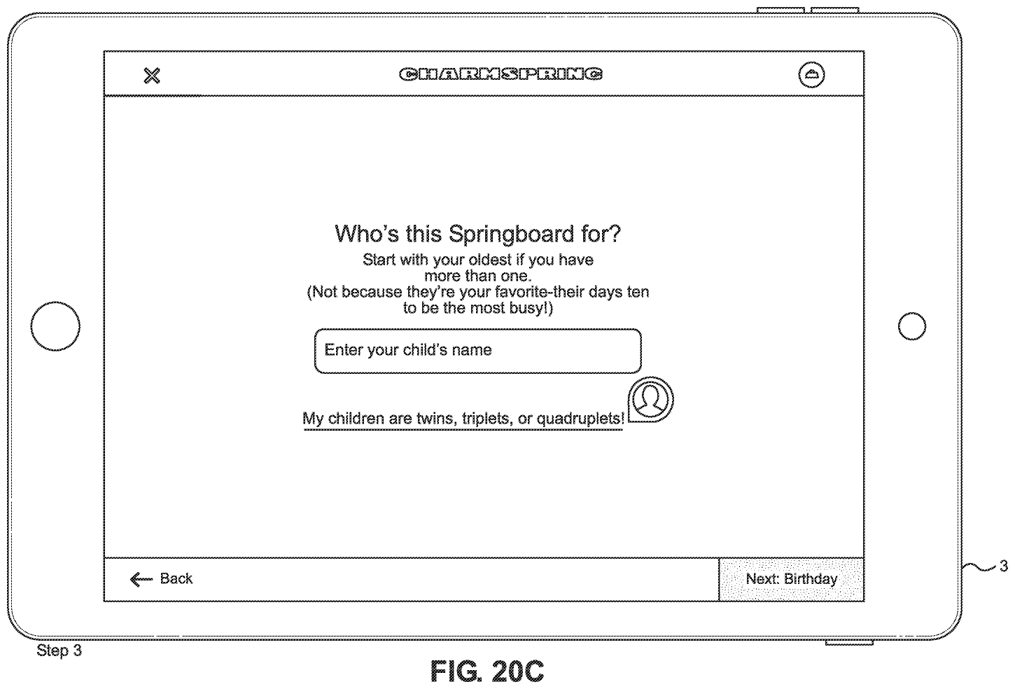

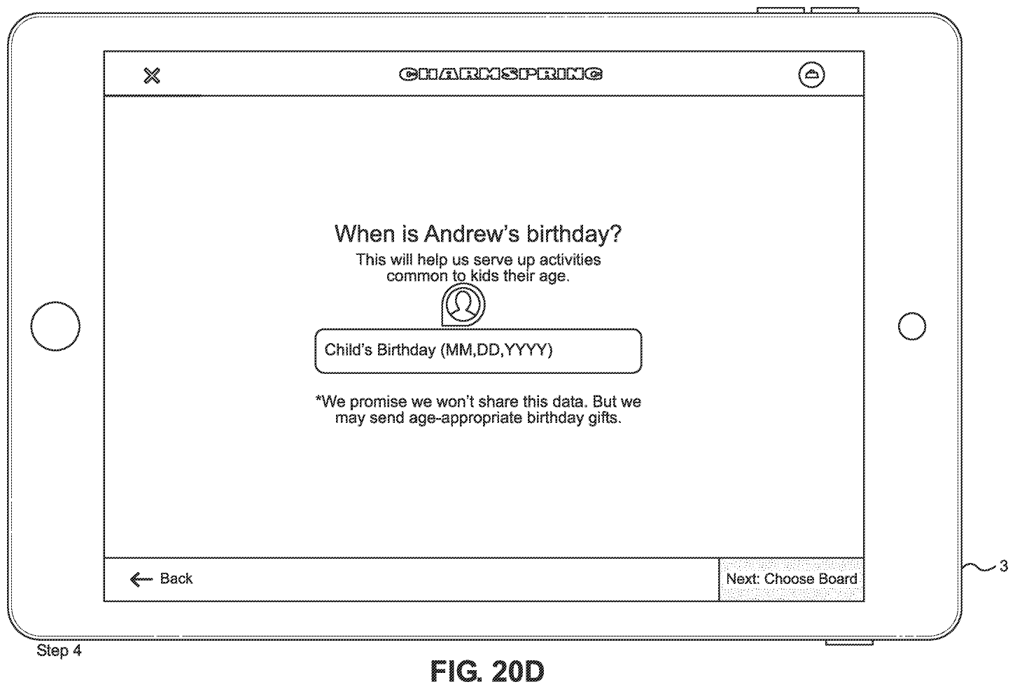

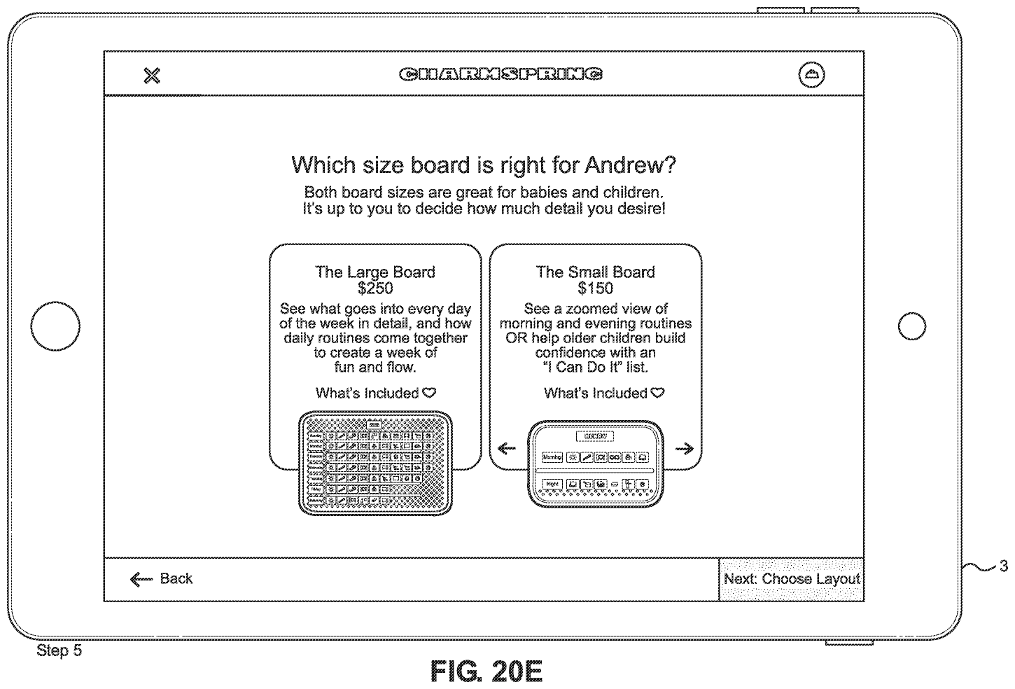

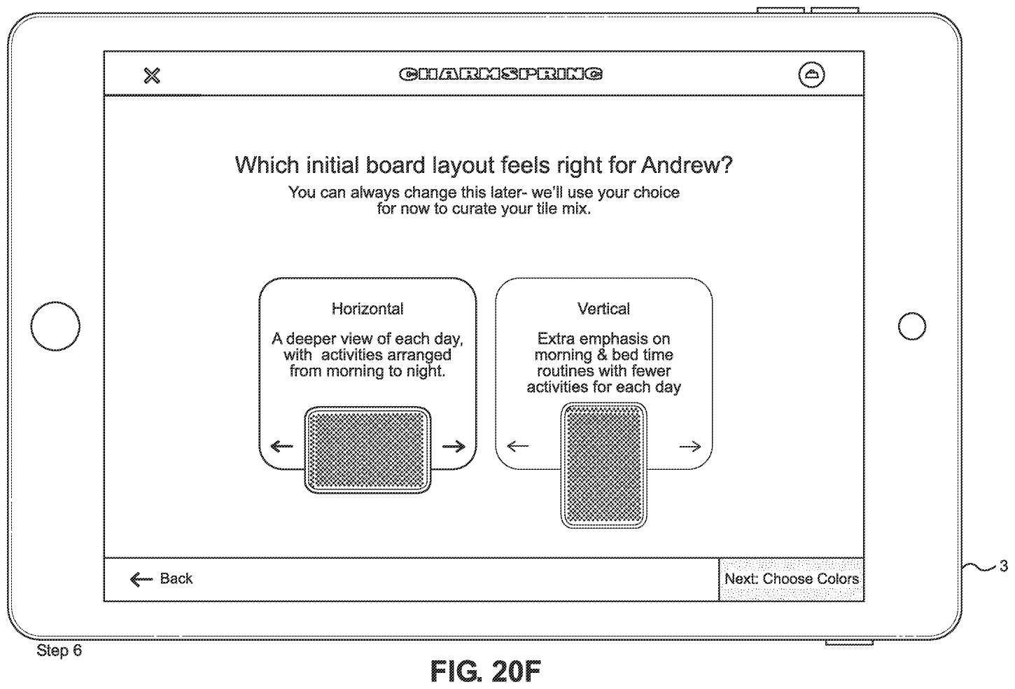

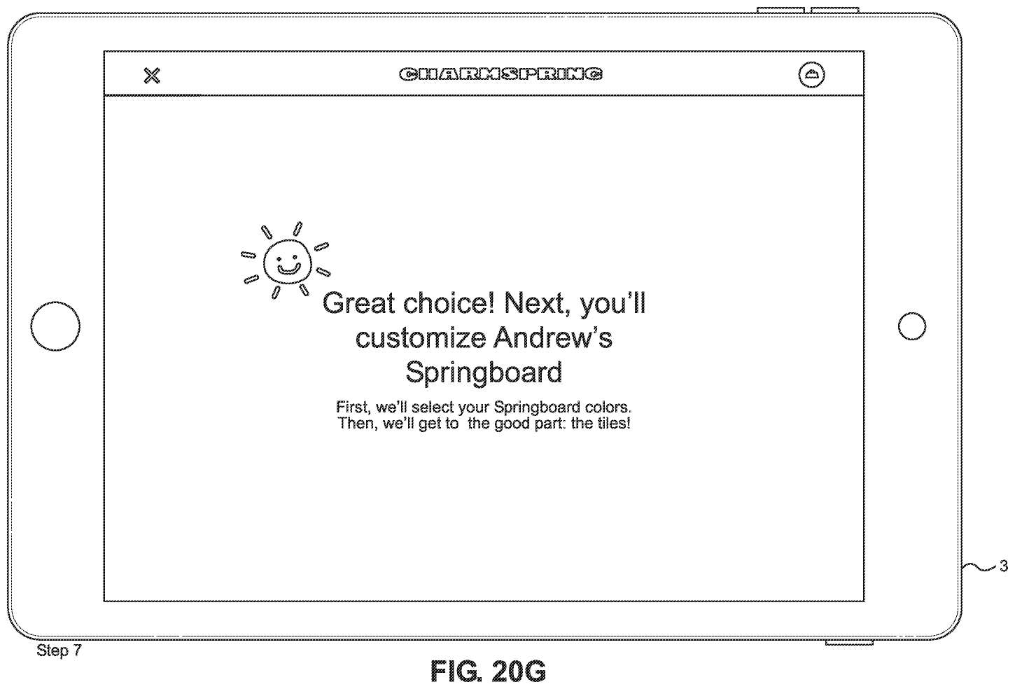

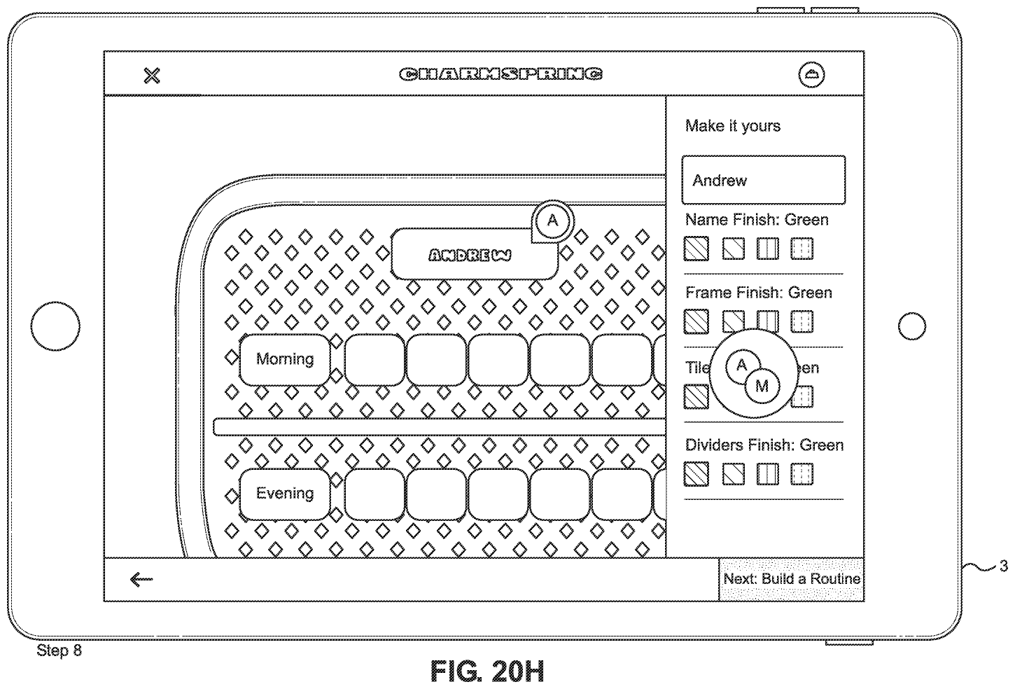

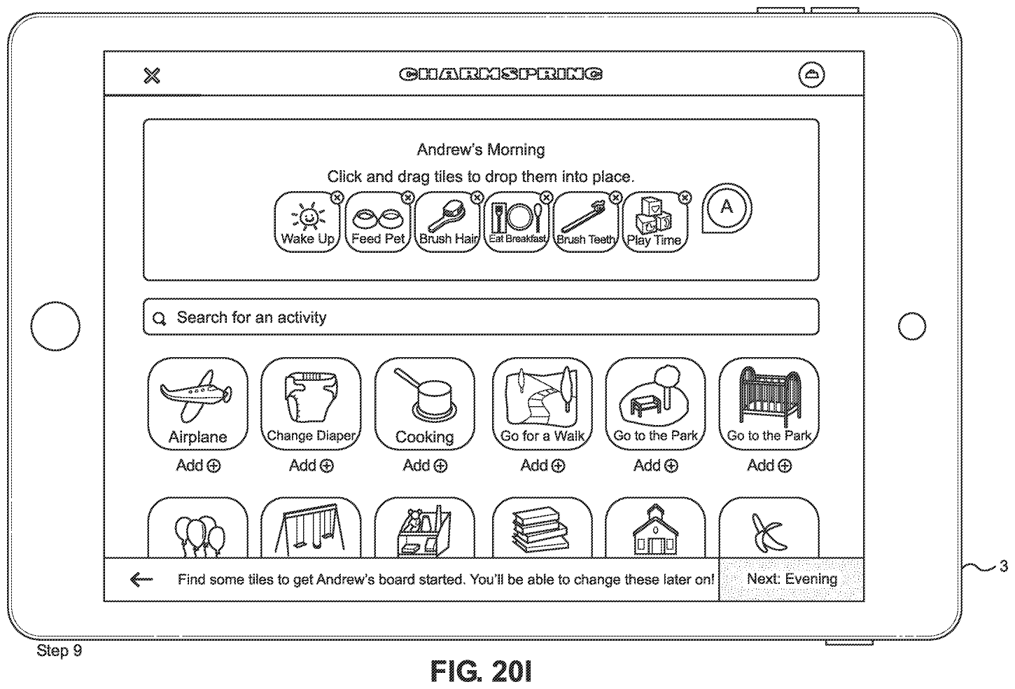

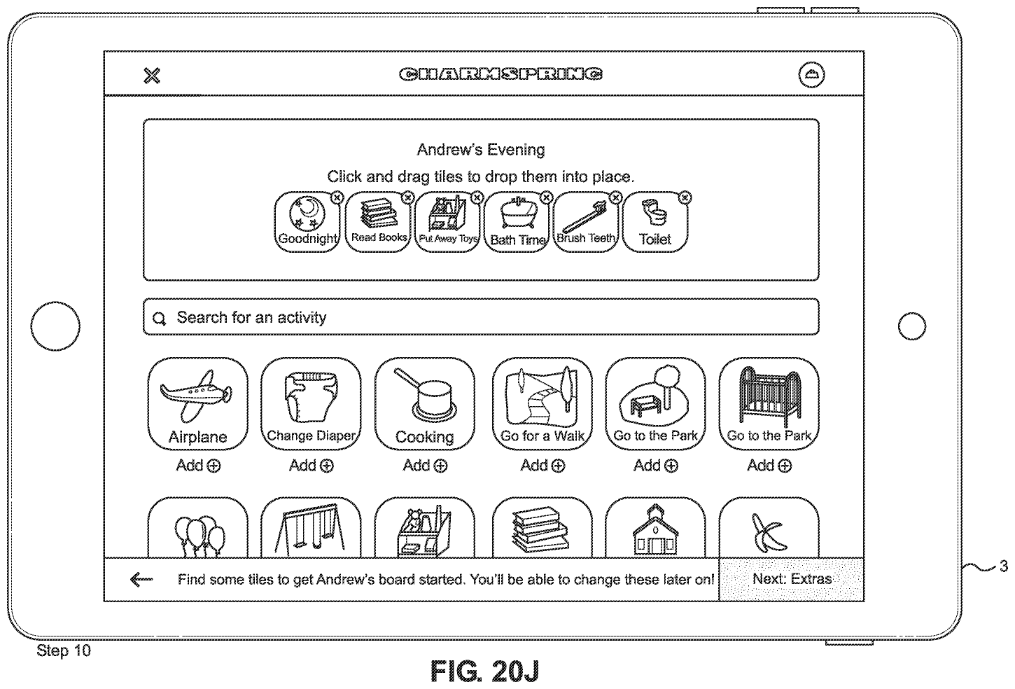

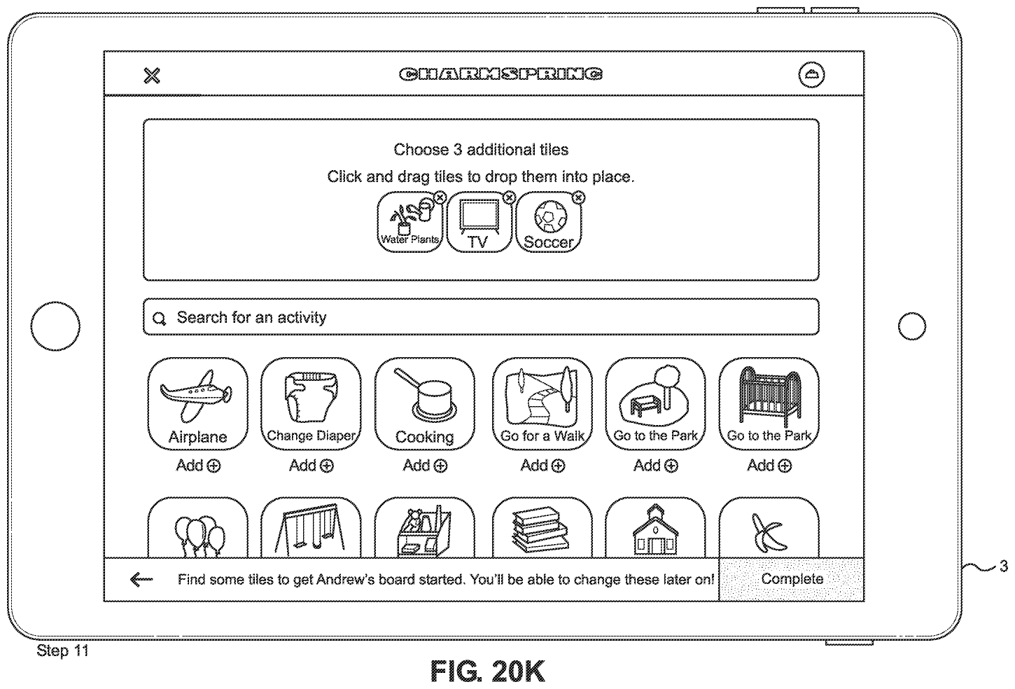

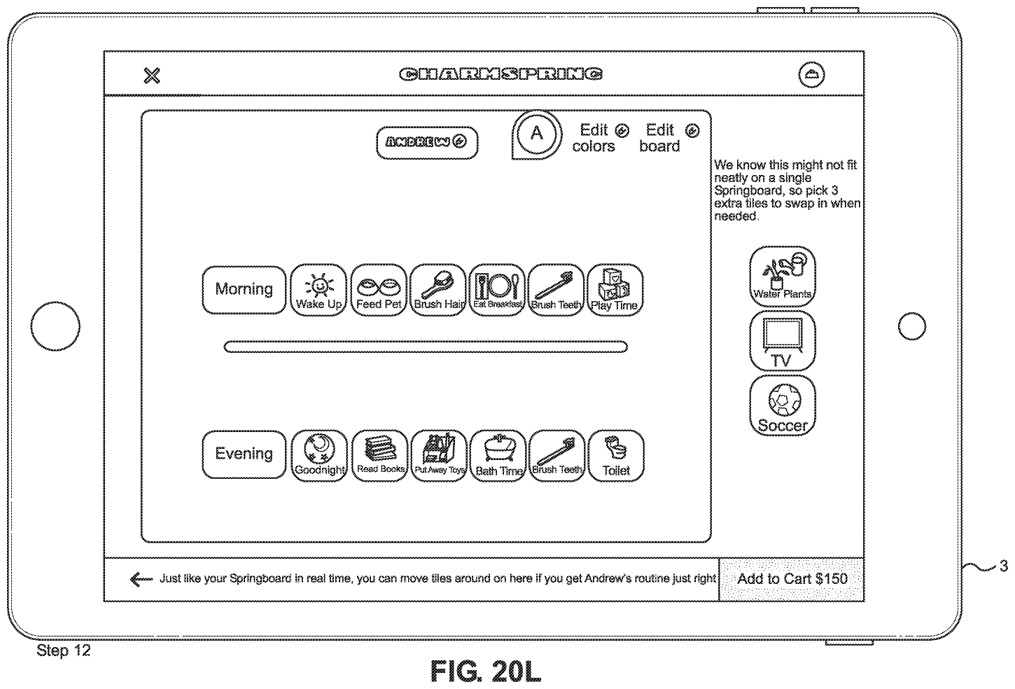

FIG. 20A shows a mobile tablet computing system 3 shown operated in its digital camera mode, wherein its digital camera system images and captures a machine-readable code 8 printed on the printed magazine of FIG. 19, and wherein its web-enabled browser application supports and enables the first step of the tablet computer method of designing, building, and ordering custom magnetic peg-board child activity planning/scheduling systems of the present invention. As shown, this step involves the automated reading of the machine-readable code on the magazine page, and navigating to the webpage(s) of the website portal operated by the product manufacturer and/or its partner(s).

FIG. 20B shows a graphical user interface (GUI) supported by the web browser of the mobile tablet computing system of FIG. 19, displaying the webpage at the manufacturer's website portal, and enabling the second step of tablet computer method of designing, building, and ordering custom magnetic peg-board child activity planning/scheduling systems of the present invention supported by the website portal and related order fulfillment infrastructure. As shown, this step involves providing a brief overview on the primary steps of the method of the present invention.

FIG. 20C shows a graphical user interface (GUI) supported by the web browser of the mobile tablet computing system of FIG. 19, displaying the webpage at the manufacturer's website portal, and enabling the third step of the tablet computer method of designing, building, and ordering custom magnetic peg-board child activity planning/scheduling systems of the present invention. As shown, this step involves the identification of the child by name, for whom the system is being custom design, built and deployed over the system network of the present invention.

FIG. 20D shows a graphical user interface (GUI) supported by the web browser of the mobile tablet computing system of FIG. 19, displaying the webpage at the manufacturer's website portal, and enabling the fourth step of the tablet computer method of designing, building, and ordering custom magnetic peg-board child activity planning/scheduling systems of the present invention. As shown, this step involves identifying the date of birth of each child for whom the custom magnetic peg-board child activity planning/scheduling system will be used.

FIG. 20E shows a graphical user interface (GUI) supported by the web browser of the mobile tablet computing system of FIG. 19, displaying the webpage at the manufacturer's website portal, and enabling the fifth step of the tablet computer method of designing, building, and ordering custom magnetic peg-board child activity planning/scheduling systems of the present invention. As shown, this step involves specification of the size of the custom magnetic peg-board child activity planning/scheduling system, and disclosure of the purchase price thereof.

FIG. 20F shows a graphical user interface (GUI) supported by the web browser of the mobile tablet computing system of FIG. 19, displaying the webpage at the manufacturer's website portal, and enabling the sixth step of the tablet computer method of designing, building, and ordering custom magnetic peg-board child activity planning/scheduling systems of the present invention. As shown, this step involves specification of layout and display orientation that feels right for the child and selected size and model, and which will influence how a child's activity tiles can be arranged in a routine.

FIG. 20G shows a graphical user interface (GUI) supported by the web browser of the mobile tablet computing system of FIG. 19, shown displaying the webpage at the manufacturer's website portal, and enabling the seventh step of the tablet computer method of designing, building, and ordering custom magnetic peg-board child activity planning/scheduling systems of the present invention. As shown, this step involves an overview description on the specification and selection of colors for the magnetic peg-board panel and its tile components.

FIG. 20H shows a graphical user interface (GUI) supported by the web browser of the mobile tablet computing system of FIG. 19, displaying the webpage at the manufacturer's website portal, and enabling the eighth step of the tablet computer method of designing, building, and ordering custom magnetic peg-board child activity planning/scheduling systems of the present invention. As shown, this step involves the specification of finishes for the child's Name Indicating Tile, the Layout (e.g. Morning/Evening) Indicating Tiles, Divider Tiles, and Peg-Board Framework to be built for use with the custom magnetic peg-board panel of the system.

FIG. 20I shows a graphical user interface (GUI) supported by the web browser of the mobile tablet computing system of FIG. 19, displaying the webpage at the manufacturer's website portal, and enabling the ninth step of the tablet computer method of designing, building, and ordering custom magnetic peg-board child activity planning/scheduling systems of the present invention. As shown, this step involves selecting the activity tiles for a first routine (e.g. Morning or Evening, or Daily Routine) of the child during the week.

FIG. 20J shows a graphical user interface (GUI) supported by the web browser of the mobile tablet computing system of FIG. 19, displaying the webpage at the manufacturer's website portal, and enabling the tenth step of the tablet computer method of designing, building, and ordering custom magnetic peg-board child activity planning/scheduling systems of the present invention. As shown, this step involves selecting the activity tiles for another routine (e.g Morning and Evening; or Daily Routine) of the child during the week.

FIG. 20K shows a graphical user interface (GUI) supported by the web browser of the mobile tablet computing system of FIG. 19, displaying the webpage at the manufacturer's website portal, and enabling the eleventh step of the tablet computer method of designing, building, and ordering custom magnetic peg-board child activity planning/scheduling systems of the present invention. As shown, this step involves selecting additional activity tiles for another routine (e.g. Morning and Evening; or Daily Routine) of the child during the week.

FIG. 20L shows a graphical user interface (GUI) supported by the web browser of the mobile tablet computing system of FIG. 19, displaying the webpage at the manufacturer's website portal, and enabling the twelfth step of the tablet computer method of designing, building, and ordering custom magnetic peg-board child activity planning/scheduling systems of the present invention. As shown, this step involves confirmation of the final design of the child's activity planning/scheduling routine, and layout(s), and completing the purchase of the custom magnetic peg-board child activity planning/scheduling system.

### Specification of Preferred Methods of Using the Child's Magnetic Peg-Board Activity Planning/Scheduling System of the Present Invention

FIG. 16 describes the primary steps involved in practicing the method of using the child's magnetic peg-board activity planning/scheduling system of the present invention 2.

As indicated at Block A in FIG. 16, the first step of the method involves procuring a magnetic pegboard system 2 according to the method illustrated in FIG. 1, designed to meet the needs, interests and activities of a specific child or group of children.

As indicated at Block B in FIG. 16, the second step of the method involves mounting the magnetic pegboard panel 2 on a surface in either a vertical or horizontal orientation.

As indicated at Block C in FIG. 16, the third step of the method involves inserting the components (i.e. magnetic activity tiles 16) within magnetic pegboard panel 10 of the system, to configure a desired routine for the child/children during the first week, and allow the child/children to start using the system according to the configured routine.

As indicated at Block D in FIG. 16, the fourth step of the method involves, after passage of the first week, reconfiguring the tiles 16 on the magnetic pegboard system 2, to reflect the desired routine of the child/children for the second week.

As indicated at Block E in FIG. 16, the fifth step of the method involves repeating Step D each subsequent week, and reconfiguring the activity tiles 16 on the magnetic pegboard system 2 to reflect the desired routines of the child/children for the future weeks.

As indicated at Block F in FIG. 16, the sixth step of the method involves, after passage of time and use of the magnetic pegboard system 2, and as the child/children grows older, develops new interests, and adopts new activities and modified routines, the customer returning to and logging into the e-commerce site 6, accessing the customer's user account and redesigning/updating the customized magnetic pegboard system design, based on new interests, activities and routines of the child/children.

As indicated at Block G in FIG. 16, the seventh step of the method involves, after receiving new activity tiles for the system 2, reconfiguring the tiles on the magnetic pegboard system 2, to reflect the desired routine of the child/children for subsequent weeks and months ahead.

The method of using the magnetic peg-board system of the present invention 2 described above is only an exemplary method. It is understood that there will be many possible methods of using the magnetic peg-board systems to achieve good results in planning and scheduling a child's or a group of children's activities, for the purposes discussed above.

Specification of a Method of Printing Child Activity Routine Schedules in Accordance with the Present Invention

As described above, a customer will a client computing system 3 and the web interfaces supported by the system network 1 to set up, model and maintain their child(ren)'s activity routines and schedules, and uses these cloud-based models to design, build and order new activity tiles and components to meet the needs and interests of their children as they grow and develop naturally with age. In addition to using the cloud-based system network 1 to manage and maintain their child(ren)'s activity routines and schedules, and magnetic peg-board panels 10 described herein, it will be convenient at times to print out these child activity routines on a sheet(s) of paper at home for immediate and portable use, as the situation may demand or require.

In the illustrative embodiment, the system network 1 will support different methods of generating a printable version of the child's activity/routine schedule to ensure that the child and caregiver always have quick access to a facsimile copy of the child's activity schedule, in its current state of configuration, even when the child and caregiver are physically located remotely from the physical site where the magnetic peg-board panel 10 is physically is actually mounted.

A first method of generating a copy of the child's activity schedule would be to use a web browser to select a “PRINT CHILD ACTIVITY SCHEDULE” Command from the website portal interface 6. One the print command is selected, the system responds by using the customer's current child activity routine model, stored within the system's application and database servers 5B, 5C in the data center 5, to generate a digital file (e.g. pdf or other forma) that can be printed on paper or plastic using a conventional printer with suitable drivers.

A second method may be to use the digital camera tool within one's mobile smartphone computing system 3 to (i) capture a digital image of the magnetic peg-board panel 10 configured in its current state with its layout and activity tiles mounted as they may be, and (ii) print out a copy of the digital image to take with the child on their remote trip or journey from the home or base environment.

A third method will be to provide, install and configure a mobile application on the parent's or caregiver's mobile smartphone system or tablet computing system 3 that communicates with the web, application and database servers 5A, 5B and 5C supported by the website portal 6, described above, and allows the parent and/or caregiver to manage the child's activity routines from the mobile application, while achieving correspondence with the child's magnetic ped-board child activity planning/scheduling system 2 of the present invention. This mobile application would also allow the caregiver to print out the child's current activity routine with simply and convenience, as the situation requires or otherwise might be helpful in providing care and guidance to the child in a remote environment. Ideally, printing operations would support color so the child can easily see the correspondence between the master activity routine planning/scheduling board, and a facsimile copy thereof that has been printed on a paper or plastic substrate.

In most situations, it will be useful to generate a print copy of a child's current activity routine when stepping away from the home or base environment for a predetermined period of time where the magnetic peg-board 10 is mounted or otherwise location, and the child's routine is otherwise expected not to deviate from the recorded/configured plan. The printed child activity/routine schedule can be used by the child during travel and other scenarios when relevant, by a customer using the web interfaces and illustrations supported by the system network and the customer's client computing system 3, to set up and model their child's activity schedule/routine, and then print it out on a sheet(s) of paper at home for immediate and portable use.

### Alternative Embodiments Which Readily Come to Mind

While the various embodiments of the magnetic peg-board activity planning/scheduling system and methods of use have been illustrated in the context of a family and home environment, it is understood that such methods and apparatus can also be used within daycare centers, kindergarten and other school and educational environments with great success.

In the present embodiments described above, small neodymium rare earth permanent magnetic cylinders (e.g. made using RE-Fe-B or iron-based rare earth permanent magnets, and/or Fe-based rare earth alloys represented by NdFeB alloy) have been disclosed for realizing each permanent magnetic cylinder 16D5 employed in the peg structures 18 of the tile and divider components of the peg-board system 2 of the present invention. However, it is understood that alternative permanent magnets (e.g. ferrite magnetics) may be used with good results to realize these magnetic components for safely generating magnetic forces of sufficient strength for releasably holding peg-based tile components to the steel-embodied pegboard panel 10, for the purposes of the present invention.

Also, it is also understood that parents and caregivers will be the first ones to recognize and/or take notice that their child or children are developing new interests and needs, and activities. The collection and recording of such kinds of information will be useful during system (re) design stages supported on the web-based platform at the web-based portal 6. The web-based portal 6 can support a web-based mobile application which facilities the collection of such information using a mobile smart phone, so that collected information is available at the parent's User Account when updating the activity tiles used in any given system.

Several modifications to the illustrative embodiments have been described above. It is understood, however, that various other modifications to the illustrative embodiment of the present invention will readily occur to persons with ordinary skill in the art. All such modifications and variations are deemed to be within the scope and spirit of the present invention as defined by the accompanying Claims to Invention.

1. A magnetic peg-board activity planning/scheduling system for arrangement in a horizontal or vertical display orientation, comprising:
a metallic-based pegboard panel assembly including a magnetic-steel sheet, and a peg apertured panel made of thin material through which a plurality of peg apertures is formed in a uniform manner, and being mounted and held together within a framework,
wherein a plurality of peg apertures is formed in a uniform manner through said peg apertured panel; and
a set of magnetic peg-based indicating tiles, each having a peg structure that is adapted for physically coupling to the peg apertures in said metallic-based pegboard panel and magnetically coupling to said magnetic-steel sheet in a releasable manner to selective changing the placement of said magnetic peg-based indicating tile on the surface of said metallic-based pegboard panel;
wherein each said magnetic peg-based indicating tile component includes an indicating graphic representative of an activity and/or indicating text representative of a child's name, the day of the week, activity, or status of a task to be performed; and
wherein each said magnetic peg-based title component is designed to enable a young child to simply and controllably insert the peg structure of said magnetic peg-based indication tile into any intended peg aperture formed in said metallic peg-board panel, and then securely but releasably held in place by the forces of magnetic attraction existing between (i) the magnetic element inside the peg structure of said magnetic peg-based indicating tile component, and (ii) the magnetic-steel sheet mounted within the framework of the magnetic peg-board panel assembly.

2. The magnetic peg-board activity planning/scheduling system of claim 1, wherein said magnetic-steel sheet is painted or powder-coated; and wherein said peg apertured panel is made of plastic material; and wherein said magnetic-steel sheet and said peg apertured panel are assembled using a set of spaced-apart standoff screws fastened though the corners and mid-sections of said metallic-based pegboard panel assembly.

3. The magnetic peg-board activity planning/scheduling system of claim 1, wherein said framework includes a pair of metal hanging plate inserts for mounting within the top and rear sides of said framework for vertical and horizontal mounting, respectively.

4. The magnetic peg-board activity planning/scheduling system of claim 1, wherein a set of a ribbon hangers are mounted to the top and rear sides of said framework for supporting vertical and horizontal mounting orientations of the peg-board panel.

5. The magnetic peg-board activity planning/scheduling system of claim 1, wherein said peg apertured panel made of thin plastic material, in which said plurality of peg apertures are formed in a uniform manner using a laser beam.

6. The magnetic peg-board activity planning/scheduling system of claim 1, wherein said peg apertured panel made of thin wood material, in which said plurality of peg apertures are formed in a uniform manner using a laser beam.

7. The magnetic peg-board activity planning/scheduling system of claim 1, wherein said magnetic element has a cylindrical geometry.

8. The magnetic peg-board activity planning/scheduling system of claim 1, wherein the cross-sectional geometry of each said peg aperture is matched to the cross-sectional geometry of said peg structure, so that said peg structure can be easily inserted into said peg aperture.

9. The magnetic peg-board activity planning/scheduling system of claim 7, wherein said peg structure has a cylindrical recess for receiving said magnetic element which has a cylindrical shape and dimensions sized to fit securely within said cylindrical recess formed in said peg structure.

10. The magnetic peg-board activity planning/scheduling system of claim 7, wherein magnetic peg-based indicating tile component further comprises:
graphical indicia to visually indicate a specific name, activity, or other legend on the magnetic peg-based indicating tile component.

11. The magnetic peg-board activity planning/scheduling system of claim 7, wherein magnetic peg-based indicating tile component further comprises:
a blank front surface without bearing any graphics, text, or other graphical indications, and free and available for a parent or caregiver to draw a graphic and/or write out a name for an activity on the blank surface, using an erasable, a semi-permanent or permanent ink-based mark indicating tile component, to visually indicate a specific name, activity, or other legend on said magnetic peg-based tile.

12. The magnetic peg-board activity planning/scheduling system of claim 1, wherein said set of magnetic peg-based indicating tile components include:
(i) at least one Name Indicating Magnetic Peg-Based Tile, each for indicating the name of a child who will use said magnetic peg-board activity planning/scheduling system;
(ii) a set of Week Day Indicating Magnetic Peg-Based Tiles, each for indicating a day of the week (namely S-M-T-W-TH-F-S);
(iii) at least six Magnetic Peg-Based Dividers, each having two of more magnetic peg-structures for mounting to said metallic-based pegboard panel; and
(iv) a plurality of Specific Activity/Event Indicating Magnetic Peg-Based Activity Tiles, each for mounting on said metallic-based pegboard panel between the Magnetic Peg-Based Dividers;
wherein each said magnetic peg-based indicating tile component includes an indicating graphic representative of an activity and/or indicating text representative of a child's name, the day of the week, activity, or status of a task to be performed.

13. The magnetic peg-board activity planning/scheduling system of claim 1, for arrangement in vertical display orientation, wherein said set of magnetic peg-based indicating tile components include:
(i) At least one Name Indicating Magnetic Peg-Based Tile, each for indicating the name of a child who will use said magnetic peg-board activity planning/scheduling system;
(ii) a pair of Magnetic Peg-Based Dividers, each having two of more magnetic peg-structures for mounting to said metallic-based pegboard panel assembly, and creating Morning Activity and Evening Activity Spaces and on the front surface of the pegboard board panel, between which a Daily Routine Planning Space is created;
(iii) Morning and Evening Indicating Magnetic Peg-Based Tiles for mounting in Morning and Evening Activity Spaces created on the metallic-based pegboard panel assembly;
(iv) a set of Week Day Indicating Magnetic Peg-Based Tiles, each for indicating a day of the week (namely S-M-T-W-TH-F-S) for mounting in the Daily Routine Planning Space;
(v) a plurality of Specific Activity/Event Indicating Magnetic Peg-Based Activity Tiles, each for mounting on said metallic-based pegboard panel assembly between the Magnetic Peg-Based Dividers, within the Daily Routine Planning Space;
wherein each said magnetic peg-based indicating tile component includes an indicating graphic representative of an activity and/or indicating text representative of a child's name, the day of the week, activity, or status of a task to be performed.

14. A The magnetic peg-board activity planning/scheduling system of claim 1, for arrangement in a vertical display orientation, wherein said set of magnetic peg-based indicating tile components include:
(i) at least one Name Indicating Magnetic Peg-Based Tile, each adapted for mounting on said metallic-based pegboard panel assembly and indicating the name of a child who will use said magnetic peg-board activity planning/scheduling system;
(ii) To Do and Done Indicating Magnetic Peg-Based Tiles adapted for mounting on said metallic-based pegboard panel assembly and forming a To Do Space and a Done Space;
(iii) a Magnetic Peg-Based Divider having two of more magnetic peg-structures for mounting to said metallic-based pegboard panel assembly to form a Do Space and a Done Space; and
(iv) a plurality of Specific Activity/Event Indicating Magnetic Peg-Based Activity Tiles, each adapted for mounting on said metallic-based pegboard panel assembly in either the Do Space or Done Space of said Magnetic Peg-Based Divider;
wherein each said magnetic peg-based indicating tile component includes an indicating graphic representative of an activity and/or indicating text representative of a child's name, the day of the week, activity, or status of a task to be performed.

15. The magnetic peg-board activity planning/scheduling system of claim 1, for arrangement in a horizontal display orientation, wherein said set of magnetic peg-based indicating tile components include:
(i) at least one Name Indicating Magnetic Peg-Based Tile, each for indicating the name of a child who will use said magnetic peg-board activity planning/scheduling system;
(ii) a Magnetic Peg-Based Divider, having two of more magnetic peg-structures for mounting to said metallic-based pegboard panel and creating a Morning Space and an Evening Space;
(iii) Morning and Evening Indicating Magnetic Peg-Based Indication Tiles, each having a magnetic peg-structure for mounting to said metallic-based pegboard panel assembly within the Morning Space or the Evening Space;
(iv) a plurality of Specific Activity/Event Indicating Magnetic Peg-Based Activity Tiles, each for mounting on said metallic-based pegboard panel assembly within the Morning Space or the Evening Space;
wherein each said magnetic peg-based indicating tile component includes an indicating graphic representative of an activity and/or indicating text representative of a child's name, the day of the week, activity, or status of a task to be performed.

16. The magnetic peg-board activity planning/scheduling system of claim 1, for arrangement in a vertical display orientation, wherein said set of magnetic peg-based indicating tile components include:
(i) at least one Name Indicating Magnetic Peg-Based Tile, each for indicating the name of a child who will use said magnetic peg-board activity planning/scheduling system;
(ii) a Magnetic Peg-Based Divider, having two of more magnetic peg-structures for mounting to said metallic-based pegboard panel and creating a To Do Space and a Done Space;
(iii) Morning and Evening Indicating Magnetic Peg-Based Indication Tiles, each having a magnetic peg-structure for mounting to said metallic-based pegboard panel assembly within the To Do Space or the Done Space;
(iv) a plurality of Specific Activity/Event Indicating Magnetic Peg-Based Activity Tiles, each for mounting on said metallic-based pegboard panel assembly within the To Do Space or the Done Space;
wherein each said magnetic peg-based indicating tile component includes an indicating graphic representative of an activity and/or indicating text representative of a child's name, the day of the week, activity, or status of a task to be performed.

17. A magnetic peg-board activity planning/scheduling system, comprising:
a metallic-based pegboard panel assembly including a magnetic-steel sheet, and a peg apertured panel made of thin material through which a plurality of peg apertures is formed in a uniform manner, and being mounted and held together within a framework made from wood or plastic material,
wherein a plurality of peg apertures is formed in a uniform manner through said peg apertured panel; and
a set of magnetic peg-based indicating tiles, each having a peg structure that is adapted for physically coupling to the peg apertures in said metallic-based pegboard panel and magnetically coupling to said magnetic-steel sheet in a releasable manner to selective changing the placement of said magnetic peg-based indicating tile on the surface of said metallic-based pegboard panel;
wherein each said magnetic peg-based indicating tile component includes an indicating graphic representative of an activity and/or indicating text representative of a child's name, the day of the week, activity, or status of a task to be performed; and
wherein each said magnetic peg-based title component is designed to enable a young child to simply and controllably insert the peg structure of said magnetic peg-based indication tile into any intended peg aperture formed in said metallic peg-board panel, and then securely but releasably held in place by the forces of magnetic attraction existing between (i) the magnetic element inside the peg structure of said magnetic peg-based indicating tile component, and (ii) the magnetic-steel sheet mounted within the framework of the magnetic peg-board panel assembly.

18. The magnetic peg-board activity planning/scheduling system of claim 17, wherein said magnetic-steel sheet is painted or powder-coated; and wherein said peg apertured panel is made of plastic material; and wherein said magnetic-steel sheet and said peg apertured panel are assembled using a set of spaced-apart standoff screws fastened though the corners and mid-sections of said metallic-based pegboard panel assembly.

19. The magnetic peg-board activity planning/scheduling system of claim 17, wherein said framework includes a pair of metal hanging plate inserts for mounting within the top and rear sides of said framework for vertical and horizontal mounting, respectively.

20. The magnetic peg-board activity planning/scheduling system of claim 17, wherein a set of a ribbon hangers are mounted to the top and rear sides of said framework for supporting vertical and horizontal mounting orientations of the peg-board panel.

21. The magnetic peg-board activity planning/scheduling system of claim 17, wherein said peg apertured panel made of thin plastic material, in which said plurality of peg apertures are formed in a uniform manner using a laser beam.

22. The magnetic peg-board activity planning/scheduling system of claim 17, wherein said peg apertured panel made of thin wood material, in which said plurality of peg apertures are formed in a uniform manner using a laser beam.

23. The magnetic peg-board activity planning/scheduling system of claim 17, wherein said magnetic element has a cylindrical geometry.

24. The magnetic peg-board activity planning/scheduling system of claim 17, wherein the cross-sectional geometry of each said peg aperture is matched to the cross-sectional geometry of said peg structure, so that said peg structure can be easily inserted into said peg aperture.

25. The magnetic peg-board activity planning/scheduling system of claim 23, wherein said peg structure has a cylindrical recess for receiving said magnetic element which has a cylindrical shape and dimensions sized to fit securely within said cylindrical recess formed in said peg structure.

26. The magnetic peg-board activity planning/scheduling system of claim 23, wherein magnetic peg-based indicating tile component further comprises:
graphical indicia to visually indicate a specific name, activity, or other legend on the magnetic peg-based indicating tile component.

27. The magnetic peg-board activity planning/scheduling system of claim 17, wherein magnetic peg-based indicating tile component further comprises:
a blank front surface without bearing any graphics, text, or other graphical indications, and free and available for a parent or caregiver to draw a graphic and/or write out a name for an activity on the blank surface, using an erasable, a semi-permanent or permanent ink-based mark indicating tile component to visually indicate a specific name, activity, or other legend on said magnetic peg-based tile.

28. A magnetic peg-based indicating tile component for use with and mounting to a metallic-based pegboard panel assembly including a magnetic-steel sheet, and a peg apertured panel made of thin material through which a plurality of peg apertures is formed in a uniform manner, and being mounted together within a framework, said magnetic peg-based indicating tile component comprising:
a planar base plate provided with a square aperture;
a planar indication plate of the same geometrical dimensions as the planar base plate, and mounted to the planar base plate with adhesive or other fastening means;
a small cubic structure provided with a hollow cylindrical recess for mounting a permanent magnetic cylinder with its magnetic field aligned with the axis of the cubic structure and having cross sectional dimensions that permit permanent mounting within the square aperture of said planar base plate; and
an indication surface provided on said planar indication plate for carrying and/or supporting an exemplary graphic representative of an activity or event, along with a typographical name for the activity, as the case may be;
wherein each magnetic peg-based indicating tile component is designed to enable a young child to simply and controllably insert the magnetic peg-based indication tile into any intended peg aperture formed in a magnetic peg-board panel, and then securely but releasably held in place by the forces of magnetic attraction existing between (i) the permanent magnetic cylinder mounted inside the hollow cylindrical recess formed in the small cubic structure of the magnetic peg-based indicating tile structure, and (ii) the magnetic steel sheet mounted inside said magnetic peg-board panel assembly.

29. The magnetic peg-based indicating tile of claim 28, wherein said planar base plate, said planar indication plate and said small cubic structure are made from wood material.

30. A magnetic peg-based indicating tile component for use with and mounting to a metallic-based pegboard panel assembly including a magnetic-steel sheet, and a peg apertured panel made of thin material through which a plurality of peg apertures is formed in a uniform manner, and being mounted together within a framework, said magnetic peg-based indicating tile component comprising:
a plastic back plate component having an integrated plastic peg structure with a cylindrical recess for installation and embodying of a permanent magnet of similar cylindrical geometry; and
an indication surface provided on said plastic back plate for carrying and/or supporting an exemplary graphic representative of an activity or event, along with a typographical name for the activity,
wherein each magnetic peg-based indicating tile component is designed to enable a young child to simply and controllably insert the magnetic peg-based indication tile into any intended peg aperture formed in a magnetic peg-board panel, and then securely but releasably held in place by the forces of magnetic attraction existing between (i) the permanent magnetic mounted inside the cylindrical recess formed in the integrated plastic peg structure of the plastic back plate component, and (ii) the magnetic steel sheet mounted inside said magnetic peg-board panel assembly.

31-45. (canceled)
